(19) United States
(12) Patent Application Publication
(10) Pub. No.: US 2004/0128555 A1
(43) Pub. Date: Jul. 1, 2004

(54) Image forming device controlling operation according to document security policy

(76) Inventors: Atsuhisa Saitoh, Kanagawa (JP); Yoichi Kanai, Kanagawa (JP); Masuyoshi Yachida, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/665,484

(22) Filed: Sep. 22, 2003

(30) Foreign Application Priority Data
Sep. 19, 2002 (JP) 2002-273985
Sep. 20, 2002 (JP) 2002-275973
Oct. 10, 2002 (JP) 2002-297888
Nov. 25, 2002 (JP) 2002-341222
Sep. 5, 2003 (JP) 2003-314463
Sep. 5, 2003 (JP) 2003-314464
Sep. 5, 2003 (JP) 2003-314465

(51) Int. Cl. H04L 9/00

(52) U.S. Cl. 713/201

(57) ABSTRACT

Identification information of a document is read from the document. At least one operation requirement is specified and selected according to a document profile related to the identification information by referring to a security policy describing a handling rule concerning the document. An operation with respect to the document is controlled according to the operation requirement.

### BACKGROUND OF THE INVENTION

1. Field of the Invention

The present invention generally relates to a system ensuring security of an information system, and more particularly, to an image forming device and an image forming method for performing a process control, such as a reading and a network delivery of a document, according to a security policy describing a handling rule concerning the document, by acquiring a document profile of the document.

Additionally, the present invention relates to a document profile management server providing a document profile or information concerning a document profile according to a request from an image forming device connected via a network.

Additionally, the present invention relates to a policy distribution server distributing a security policy to a device performing a process control according to the security policy describing a handling rule concerning a document.

Further, the present invention relates to a policy interpretation server providing an operation requirement for allowing an operation with respect to a document to a device connected via a network according to a security policy describing a handling rule concerning a document.

2. Description of the Related Art

In a field, such as an office, dealing with a document, there is always a request for controlling a security of the document. Especially, importance is placed on a control of a policy concerning the document which is a container of information, above all, a policy concerning security of confidentiality, such as a requirement of obtaining an authorization of an administrator/manager upon copying a confidential document. In general, ensuring of security of an information system is classified broadly into ensuring of confidentiality, integrity and availability; in many cases, the integrity and the availability can be ensured to a practically acceptable level if an administrator of the system administrates and manages appropriately. On the other hand, in order to ensure the confidentiality, it is supposed that such a policy has to be shared and observed thoroughly among members belonging to a user organization.

In reality, many companies establish document management rules and so forth so as to control security of documents. However, ensuring of security in an actual office system necessitates, not the security concerning documents, but security settings individually performed to various apparatuses composing the office system.

Conventional technologies regarding methods of performing an access control according to a security policy include various examples (patent documents: Japanese Laid-Open Patent Applications (1) No. 2001-184264, (2) No. 2001-273388, (3) No. 2001-337864, (4) No. 9-293036, (5) No. 7-141296, (6) Japanese Patent No. 2735966 (Japanese Laid-Open Patent Application No. 4-331175), (7) Japanese Patent No. 3203103 (Japanese Laid-Open Patent Application No. 7-49645), Japanese Laid-Open Patent Applications (8) No. 7-58950, (9) No. 7-152520, (10) No. 10-191072, (11) No. 2000-15898, (12) No. 2000-357064, (13) No. 2001-125759 and (14) No. 2001-325249).

For example, (1) Japanese Laid-Open Patent Application No. 2001-184264 describes an evaluation of conditional access permission in an access control.

Besides, for example, (2) Japanese Laid-Open Patent Application No. 2001-273388 describes a security management of a business information system and a simplification of an audit thereof according to an information security policy.

However, especially (1) Japanese Laid-Open Patent Application No. 2001-184264 does not mention processing of accessed data, especially reading, in an access control system for data files.

Additionally, in (2) Japanese Laid-Open Patent Application No. 2001-273388, a DB (database) is composed of items of security policies, systems, and control means, in which combinations of the three items are registered, and a control means is extracted from the DB (database) so as to control a system according to a policy. However, means to audit a state thereof performs a control only with control means registered in association with systems, which allows few variations in realizing the technology.

Besides, (7) Japanese Patent No. 3203103 (Japanese Laid-Open Patent Application No. 7-49645) describes a method of causing an operator ID to be input, extracting the ID from a document, and controlling a copy. However, this method allows only a control according to fixed rules, such as refusing a copy, or authorizing a copy and recording a log.

Besides, (8) Japanese Laid-Open Patent Application No. 7-58950 describes a method of extracting a mark indicating a confidential document from an image and checking the mark. However, this method lacks flexibility in rules, since it is predetermined what kind of operation is to be performed from obtained information.

Besides, (9) Japanese Laid-Open Patent Application No. 7-152520 describes a method of controlling an output destination according to output restriction data contained in printed information. However, this method necessitates a rule to be included in the printed information.

Besides, (10) Japanese Laid-Open Patent Application No. 10-191072 describes a method of reading an image and storing the image together with a password, and authorizing an output of the image when the password matches. However, in this method, a criterion of judgment is only the password, and an operation controlled thereby is only granting or not granting an authorization (allowance or denial).

Besides, (11) Japanese Laid-Open Patent Application No. 2000-15898 describes a method in which one MFP among a plurality of MFPs on a network performs a user management, and controlling granting or not granting an authorization for operations of all of the MFPs on the network. However, only granting or not granting an authorization (allowance or denial) is controlled by this method.

Besides, (12) Japanese Laid-Open Patent Application No. 2000-357064 describes a method of judging authorization for use or operation of a plurality of apparatuses on an individual user basis. However, in this method, only granting or not granting an authorization (allowance or denial) is controlled, and the control is performed only according to user information.

As described above, the conventional technologies have problems of limited and inflexible rules that are determined beforehand. That is, in conventional input-output devices, “authorization” or “prohibition” of operations with respect to IDs of a “user” and a “document” is determined beforehand.

According to such methods for implementing security as described above, when implementing security for printing of a document, firstly, an implementer of the security needs to have knowledge concerning security of various apparatuses. Secondly, the security needs to be implemented one by one for all of the apparatuses. Thirdly, security conditions of a system as a whole need to be easily grasped, but are difficult to grasp. Fourthly, even though the security is implemented for each of the apparatuses, it cannot be realized substantially that the security of documents is actually protected. Thus, the ensuring of security in an actual office system involves problems as described above.

### SUMMARY OF THE INVENTION

It is a general object of the present invention to provide an improved and useful image forming device, an image forming method, a program and a storage medium in which the above-mentioned problems are eliminated.

A more specific object of the present invention is to provide an image forming device and an image forming method for performing a process control, such as a reading of a document and a delivery thereof to a network according to a security policy distributed from an external server via the network which describes a handling rule concerning the document, by acquiring a document profile of the document from an external server, a program for performing processes in the image forming device, and a storage medium storing the program.

Another specific object of the present invention is to provide a policy distribution server distributing a security policy to a device performing a process control according to the security policy describing a handling rule concerning a document.

Still another specific object of the present invention is to provide a policy interpretation server providing an operation requirement for allowing an operation with respect to a document to a device connected via a network according to a security policy describing a handling rule concerning a document.

In order to achieve the above-mentioned objects, there is provided according to one aspect of the present invention an image forming device including an identification information reading part reading identification information of a document, an operation requirement selection part selecting at least one operation requirement specified according to the identification information, and an operation control part controlling an execution of a predetermined operation according to the operation requirement selected by the operation requirement selection part.

According to the present invention, the operation requirement (operation condition) can be selected according to the read identification information. Accordingly, operations, such as printing, copying and facsimile, can be controlled with respect to a paper document so that the operation requirement according to a security policy of an organization is satisfied.

In order to achieve the above-mentioned objects, there is also provided according to another aspect of the present invention an image forming device including a policy hold part holding a security policy describing a handling rule concerning a document, a policy rewriting part rewriting the security policy held by the policy hold part with a security policy from outside, and an operation control part controlling an operation with respect to the document according to the security policy held by the policy hold part.

According to the present invention, the existing security policy can be rewritten with a security policy provided from outside.

In order to achieve the above-mentioned objects, there is also provided according to another aspect of the present invention an image forming device including a rule acquisition part transmitting a document profile regarding a document to an external server providing a handling rule concerning the document according to the document profile, and thereby acquiring the handling rule from the external server, and an operation control part controlling an operation with respect to the document according to the handling rule acquired by the rule acquisition part.

According to the present invention, it is neither necessary to manage handling rules concerning documents for each document and each operation, nor to judge which rule should be applied.

Thus, the image forming device according to the present invention can perform a process control, such as a reading and a network delivery of a document, according to a security policy describing a handling rule concerning the document, by acquiring a document profile of the document.

In order to achieve the above-mentioned objects, there is also provided according to another aspect of the present invention a policy distribution server including a communication part performing a communication control via a network, and a policy management part managing a security policy describing a handling rule concerning a document, wherein the communication part distributes the security policy managed by the policy management part to a device connected via the network.

According to the present invention, an identical security policy can be distributed to a plurality of devices connected via the network.

Thus, the policy distribution server according to the present invention can distribute a security policy to a device performing a process control according to the security policy describing a handling rule concerning a document.

In order to achieve the above-mentioned objects, there is also provided according to another aspect of the present invention a policy interpretation server including a communication part performing a communication control via a network, a policy hold part holding a security policy describing a handling rule concerning a document, and a policy acquisition part acquiring the handling rule concerning an operation performed with respect to the document by referring to the security policy held by the policy hold part according to a document profile regarding the document and the operation performed with respect to the document, wherein the communication part imparts the document profile and the operation received via the network to the policy acquisition part, and transmits the handling rule acquired by the policy acquisition part.

According to the present invention, handling rules concerning documents do not need to be managed for each document and each operation.

Thus, the policy interpretation server according to the present invention can provide an operation requirement for allowing an operation with respect to a document to a device connected via a network according to a security policy describing a handling rule concerning a document.

Other objects, features and advantages of the present invention will become more apparent from the following detailed description when read in conjunction with the accompanying drawings.

### BRIEF DESCRIPTION OF THE DRAWINGS

FIG. 1 shows an example of a security policy;

FIG. 2 shows an example of a document label terminology file;

FIG. 3 is a first illustration showing an example of a policy terminology file;

FIG. 4 is a second illustration showing the example of the policy terminology file;

FIG. 5 is a third illustration showing the example of the policy terminology file;

FIG. 6 is a fourth illustration showing the example of the policy terminology file;

FIG. 7 is a fifth illustration showing the example of the policy terminology file;

FIG. 8 is a sixth illustration showing the example of the policy terminology file;

FIG. 9 is a seventh illustration showing the example of the policy terminology file;

FIG. 10 is an eighth illustration showing the example of the policy terminology file;

FIG. 11 is a ninth illustration showing the example of the policy terminology file;

FIG. 12 is a tenth illustration showing the example of the policy terminology file;

FIG. 13 is an eleventh illustration showing the example of the policy terminology file;

FIG. 14 is a first illustration showing an example of a policy file;

FIG. 15 is a second illustration showing the example of the policy file;

FIG. 16 is a third illustration showing the example of the policy file;

FIG. 17 is a fourth illustration showing the example of the policy file;

FIG. 18 is a fifth illustration showing the example of the policy file;

FIG. 19 is a sixth illustration showing the example of the policy file;

FIG. 20 is a seventh illustration showing the example of the policy file;

FIG. 21 is an eighth illustration showing the example of the policy file;

FIG. 22 is a ninth illustration showing the example of the policy file;

FIG. 23 shows an example of identification information of a DSP (Document Security Policy);

FIG. 24 shows an explanatory example of describing a structure of the DSP;

FIG. 25 shows another example of describing the DSP;

FIG. 26 shows various media used for storing and delivering the OSP;

FIG. 27 is a block diagram showing a hardware configuration of an image forming device according to an embodiment of the present invention;

FIG. 28 is a diagram showing a functional structure of the image forming device as a reading device operating according to the security policy;

FIG. 29 shows a simplified example of the DSP;

FIG. 30 is a diagram showing a functional structure of the image forming device as a copying device operating according to the security policy;

FIG. 31 shows a case where identification information of a document is printed as a bar code;

FIG. 32 is a diagram showing a first functional structure of a document profile acquisition part shown in FIG. 28 and FIG. 30;

FIG. 33 shows a case where identification information of a document is printed as a number;

FIG. 34 is a diagram showing a second functional structure of the document profile acquisition part;

FIG. 35 shows a case where identification information of a document is printed all over a surface of the document;

FIG. 36 shows a case where a document profile of a document is printed as a text;

FIG. 37 is a diagram showing a third functional structure of the document profile acquisition part;

FIG. 38 is a diagram showing a functional structure of a user profile acquisition part shown in FIG. 28 and FIG. 30;

FIG. 39 is a diagram showing a functional structure when user profiles are acquired from an external server;

FIG. 40 is a diagram showing a first functional structure for acquiring document profiles from an external server;

FIG. 41 is a diagram showing a second functional structure for acquiring document profiles from an external server;

FIG. 42 is a diagram showing a third functional structure for acquiring document profiles from an external server;

FIG. 43 is a diagram showing a fourth functional structure for acquiring identification information from an external server;

FIG. 44 is a diagram showing a fifth functional structure for acquiring identification information from an external server;

FIG. 45 is a diagram showing a sixth functional structure for acquiring document profiles or identification information from an external server;

FIG. 46 shows an example of XML data representing a document profile request using identification information of a document which is transmitted according to SOAP (Simple Object Access Protocol);

FIG. 47 shows an example of XML data representing a document profile request using electronic image data which is transmitted according to the SOAP;

FIG. 48 shows an example of XML data representing a document profile response transmitted according to the SOAP;

FIG. 49 is a diagram showing a first policy setting method in which a policy is distributed from an external server;

FIG. 50 is a diagram showing a second policy setting method in which a policy is acquired from an external server;

FIG. 51 is a diagram showing a third policy setting method in which a policy is acquired upon application of power;

FIG. 52 is a diagram showing a fourth policy setting method as a second variation in which a policy is acquired upon application of power;

FIG. 53 is a diagram showing a fifth policy setting method as a third variation in which a policy is acquired upon application of power;

FIG. 54 is a diagram showing an example of a functional structure for realizing the first to fifth policy setting methods;

FIG. 55 is a diagram showing a sixth policy setting method in which a policy is acquired according to a timer;

FIG. 56 is a diagram showing an example of a functional structure for realizing the sixth policy setting method;

FIG. 57 is a diagram showing a seventh policy setting method for setting a policy off-line;

FIG. 58 is a diagram showing an example of a functional structure for realizing the seventh policy setting method;

FIG. 59 is a diagram showing an eighth policy setting method in which a policy is set off-line and selected on-line;

FIG. 60 is a diagram showing an example of a functional structure for realizing the eighth policy setting method;

FIG. 61 is a diagram showing an example of a functional structure in which an external server interprets a policy;

FIG. 62 is a diagram showing an example of a functional structure in which an external server interprets a policy, and verifies a selected requirement;

FIG. 63 shows an example of a system attribute included in the image forming device;

FIG. 64 shows an example of a system attribute included in an external server;

FIG. 65 shows an example of XML data representing distribution of a policy transmitted according to the SOAP;

FIG. 66 shows an example of XML data representing a result of reception for the distribution of the policy transmitted according to the SOAP;

FIG. 67 shows an example of XML data representing a report of distribution of a policy transmitted according to the SOAP;

FIG. 68 shows an example of XML data representing a policy acquisition request transmitted according to the SOAP;

FIG. 69 shows an example of XML data representing a result of reception for the policy acquisition request transmitted according to the SOAP;

FIG. 70 shows an example of XML data representing a policy distribution request transmitted according to the SOAP;

FIG. 71 shows an example of XML data representing an impartation of a selection of a policy transmitted according to the SOAP;

FIG. 72 is a first illustration showing an example of XML data representing an operation requirement acquisition request transmitted according to the SOAP;

FIG. 73 is a second illustration showing the example of the XML data representing the operation requirement acquisition request transmitted according to the SOAP;

FIG. 74 shows an example of XML data representing a result of a policy interpretation transmitted according to the SOAP;

FIG. 75 is a diagram showing an example of a functional structure of an operation control part of the image forming device as the reading device; and

FIG. 76 is a diagram showing an example of a functional structure of the operation control part of the image forming device as the copying device.

### DETAILED DESCRIPTION OF THE PREFERRED EMBODIMENTS

A description will now be given, with reference to the drawings, of embodiments according to the present invention.

First, a description will be given of a security policy according to an embodiment of the present invention.

In the present embodiment, in order that a security policy regarding documents is shared among different types of systems, the security policy is described by using a structure as follows. Besides, the described security policy is referred to as a document security policy (DSP).

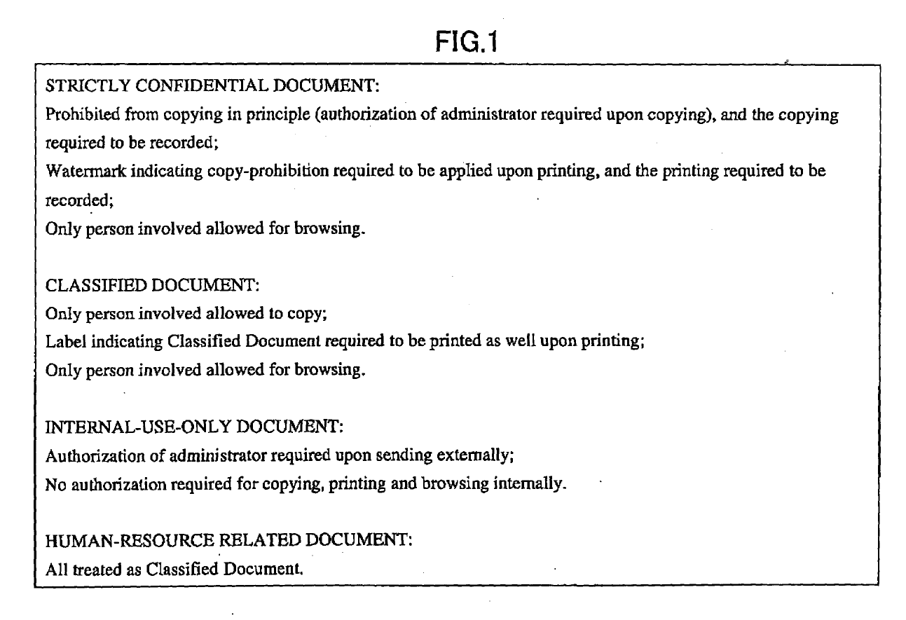

FIG. 1 shows an example of the security policy. Supposedly, an organization to which a user belongs sets a security policy regarding documents, for example, as shown in FIG. 1, for each of confidentiality levels of the documents, such as a confidential document, a classified document, and an internal-use-only document.

The following method is used so as to describe such a policy as a DSP.

First, documents are classified according to confidentiality levels (such as a confidential level, a classified level, and an internal-use-only level) and categories (such as a human-resource document and a technical document). A combination of the confidentiality level and the category is referred to as a security label of the document. Actually, the security label is provided for each of the documents as profile information.

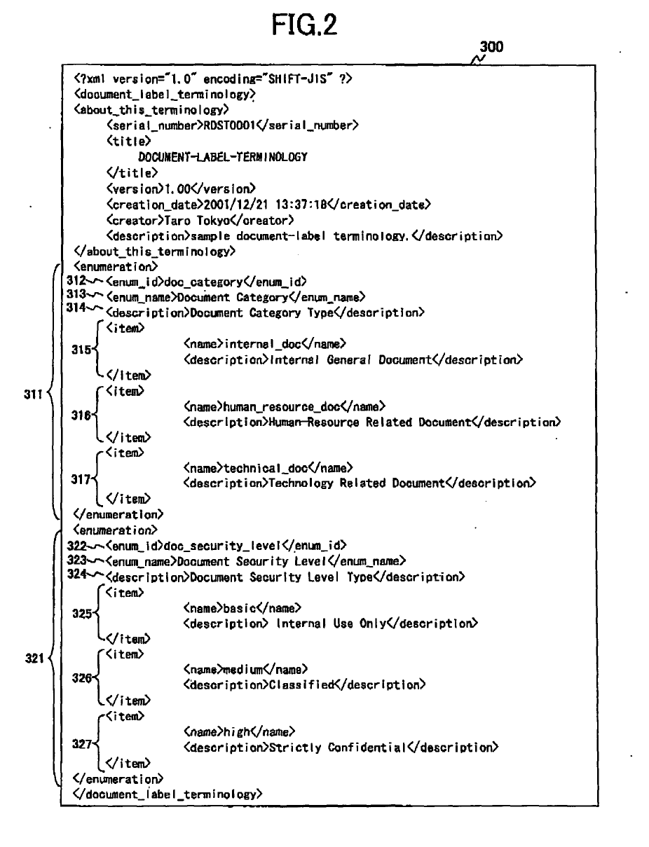

FIG. 2 exemplifies the above-described classification by showing an example of a document label terminology file. A document label terminology file 300 as shown in FIG. 2 is a file managing a list of the labels provided for each of the documents as profile information, and is described by XML, for example.

According to the confidentiality levels and the categories of documents, a DSP needs to prescribe operations authorized for the documents, and specifies requirements (such as obtaining an authorization of an administrator/manager, and printing the label) to be performed upon allowing the operations. The document label terminology file 300 shown in FIG. 2 describes such confidentiality levels and categories of documents.

In FIG. 2, two types of categories are indicated by a description 311 and a description 321 each starting at <enumeration> and ending at </enumeration>.

In the description 311, a description 312 reading <enum_id>doc_category</enum_id> indicates that identification information of the category is “doc_category”. A description 313 reading <enum_name>Document Category</enum_name> indicates that a name of the category is “Document Category”. A description 314 reading <description>Document Category Type</description> contains an explanation “Document Category Type” indicating what the present category classifies.

Three items in the category are indicated by a description 315, a description 316, and a description 317 each starting at <item> and ending at </item>. The description 315 includes a description reading <name>internal_doc</name> which indicates that a name of the item is “internal_doc”, and includes a description reading <description>Internal General Document</description> which contains an explanation of the item “Internal General Document”.

The description 316 includes a description reading <name>human_resource_doc</name> which indicates that a name of the item is “human_resource_doc”, and includes a description reading <description>Human-Resource Related Document</description> which contains an explanation of the item “Human-Resource Related Document”.

The description 317 includes a description reading <name>technical_doc</name> which indicates that a name of the item is “technical_doc”, and includes a description reading <description>Technology Related Document</description> which contains an explanation of the item “Technology Related Document”.

Similarly, in the description 321, a description 322 reading <enum_id>doc_security_level</enum_id> indicates that identification information of the category is “doc_security level”. A description 323 reading <enum_name>Document Security Level</enum_name> indicates that a name of the category is “Document Security Level”. A description 324 reading <description>Document Security Level Type</description> contains an explanation “Document Security Level Type” indicating what the present category classifies.

Three items in the category are indicated by a description 325, a description 326, and a description 327 each starting at <item> and ending at </item>. The description 325 includes a description reading <name>basic</name> which indicates that a name of the item is “basic”, and includes a description reading <description>Internal Use Only</description> which contains an explanation of the item “Internal Use Only”.

The description 326 includes a description reading <name>medium</name> which indicates that a name of the item is “medium”, and includes a description reading <description>Classified</description> which contains an explanation of the item “Classified”.

The description 327 includes a description reading <name>high</name> which indicates that a name of the item is “high”, and includes a description reading <description>Strictly Confidential</description> which contains an explanation of the item “Strictly Confidential”.

Thus, the document label terminology file 300 prescribes types of document categories, such as the internal general document, the human-resource related document, and the technology related document, and prescribes types of document security levels, such as the internal-use-only level, the classified level, and the strictly confidential level.

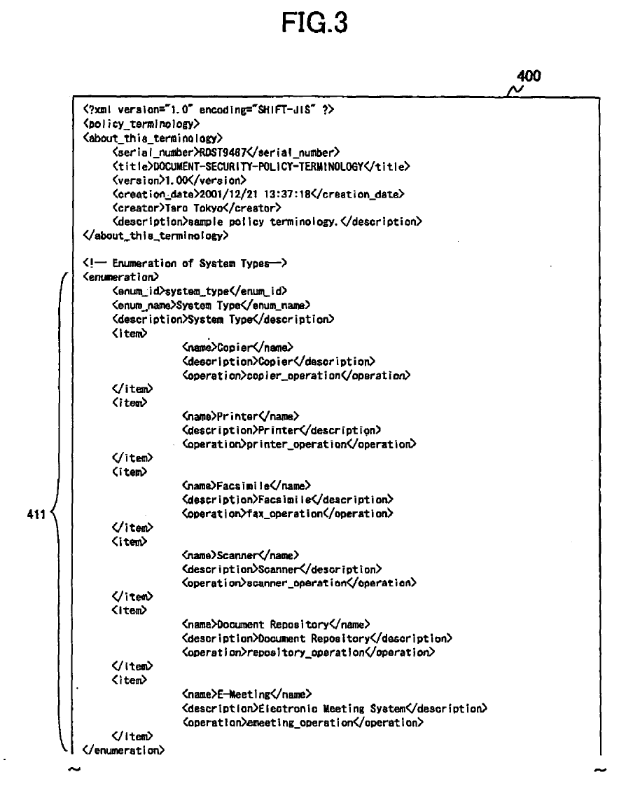

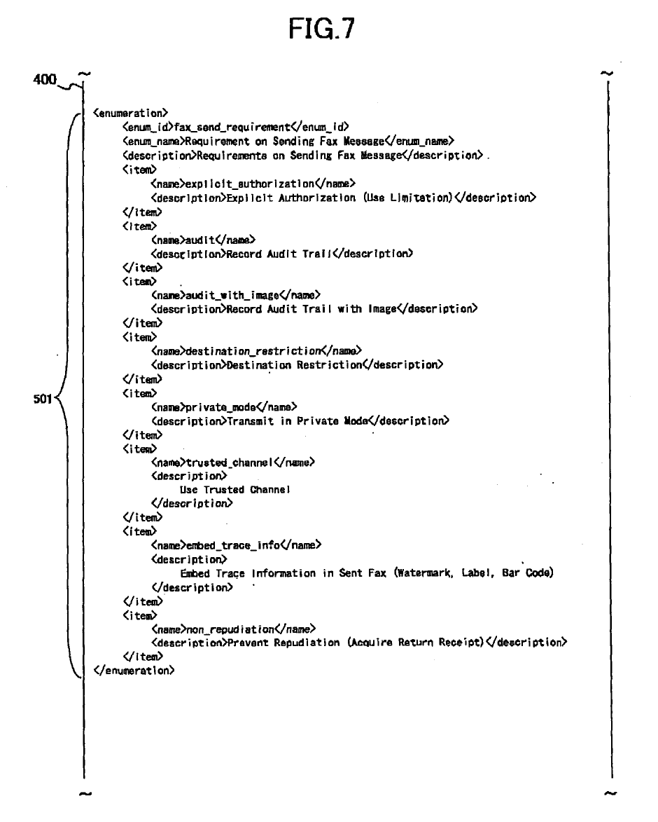

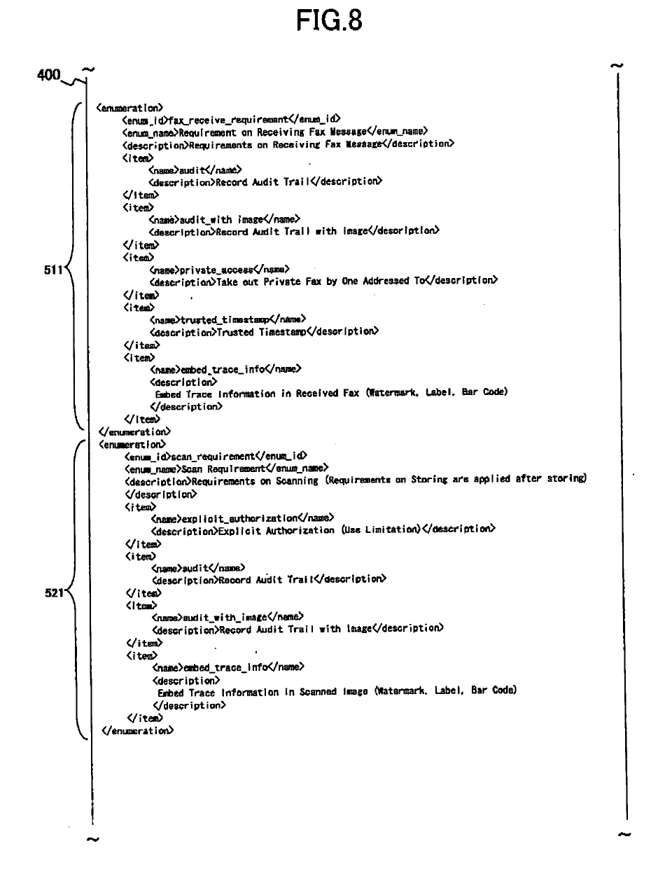

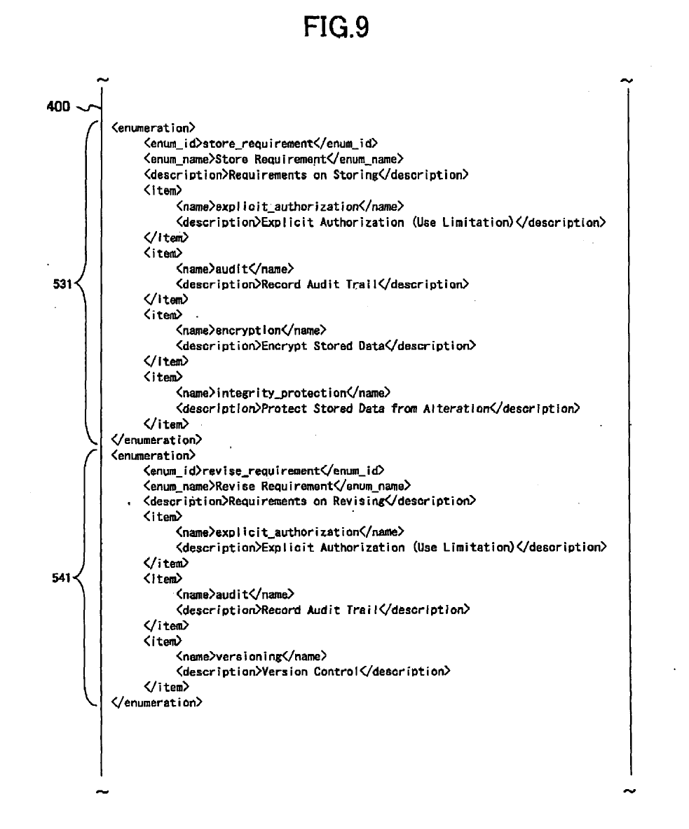

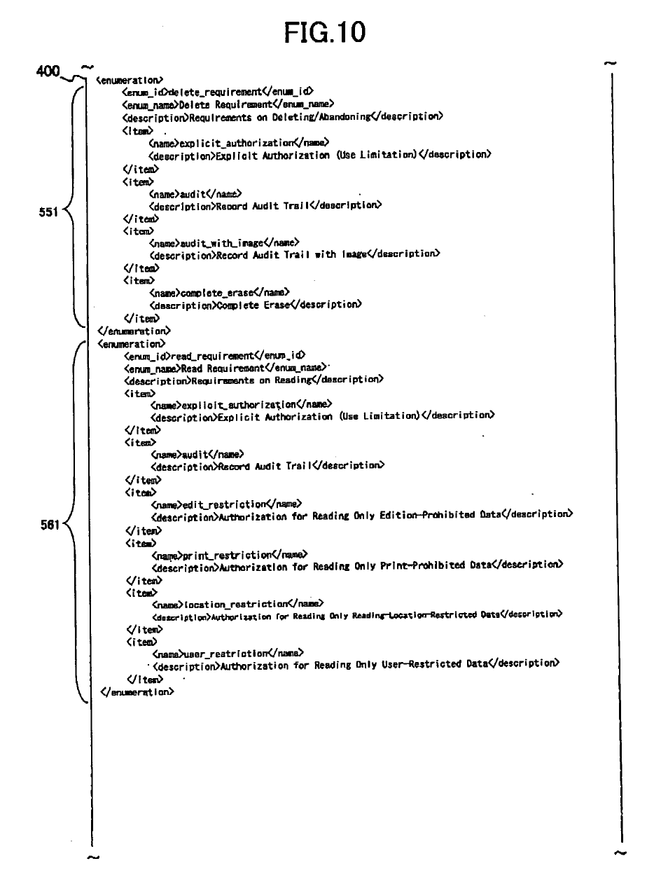

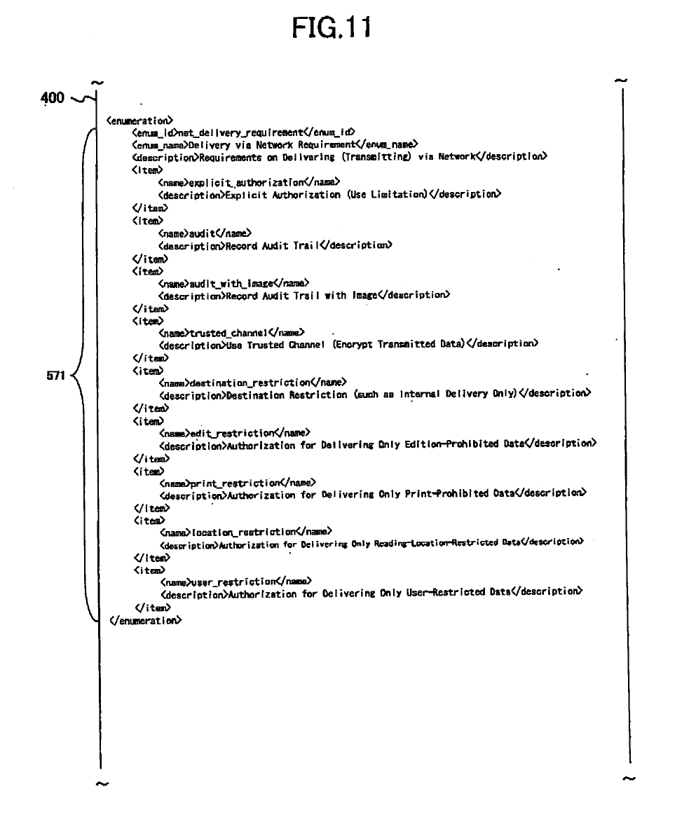

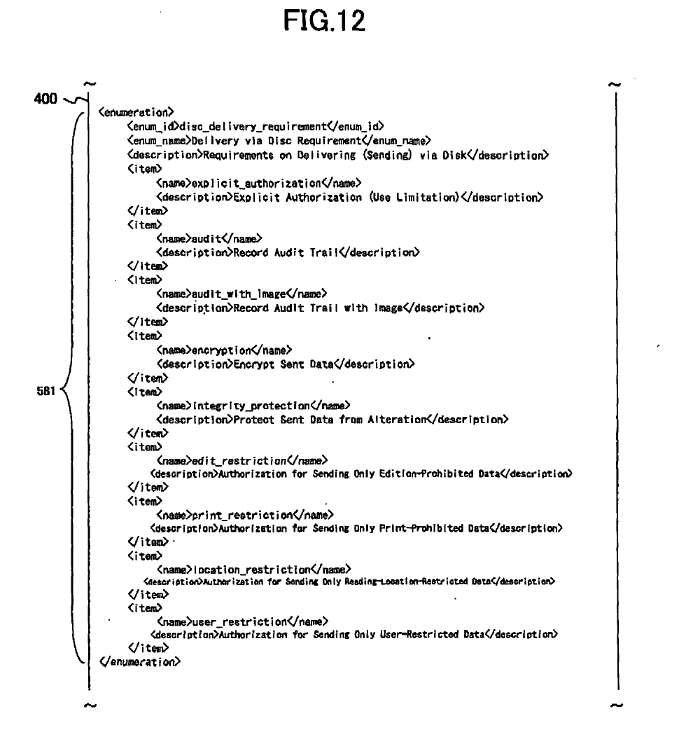

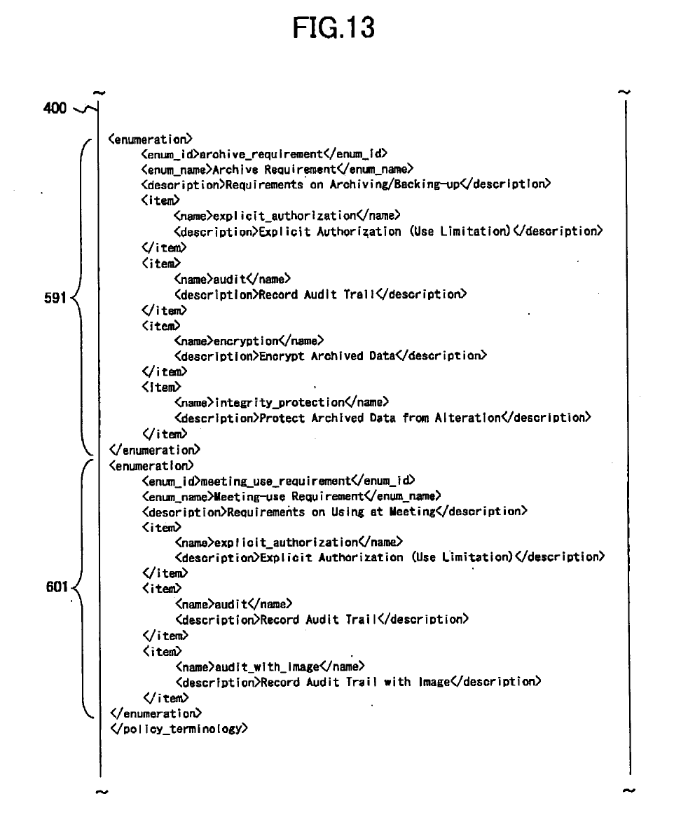

FIG. 3 to FIG. 13 show an example of a policy terminology file. FIG. 3 to FIG. 13 together compose one policy terminology file 400.

The policy terminology file 400 as shown in FIG. 3 to FIG. 13 describes a classification of system types, enumerates operations for each of the system types, and enumerates requirements supportable for each of the operations upon performing the operation. The policy terminology file 400 is described by XML, for example.

In FIG. 3, the enumeration is performed by repeating descriptions each starting at <enumeration> and ending at </enumeration>, as in the document label terminology file 300 shown in FIG. 2. Since details of the descriptions each starting at <enumeration> and ending at </enumeration> are similarly described as in the descriptions 311 and 321 of the document label terminology file 300, the descriptions in FIG. 3 will be explained briefly hereinbelow.

For example, in FIG. 3, a description 411 enumerates the system types. In the description 411, “Copier”, “Printer”, “Facsimile”, “Scanner”, “Document Repository” and “Electronic Meeting System” are described as “System Type”.

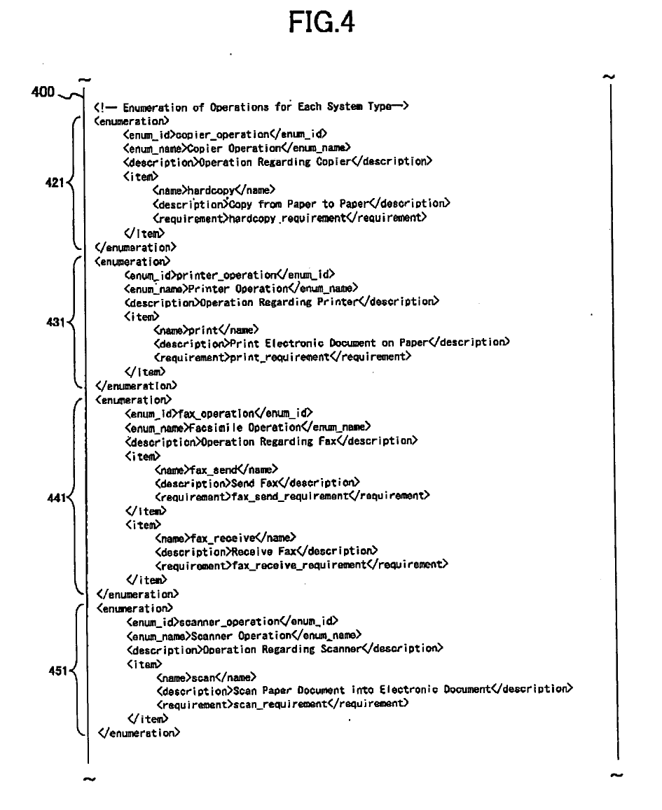

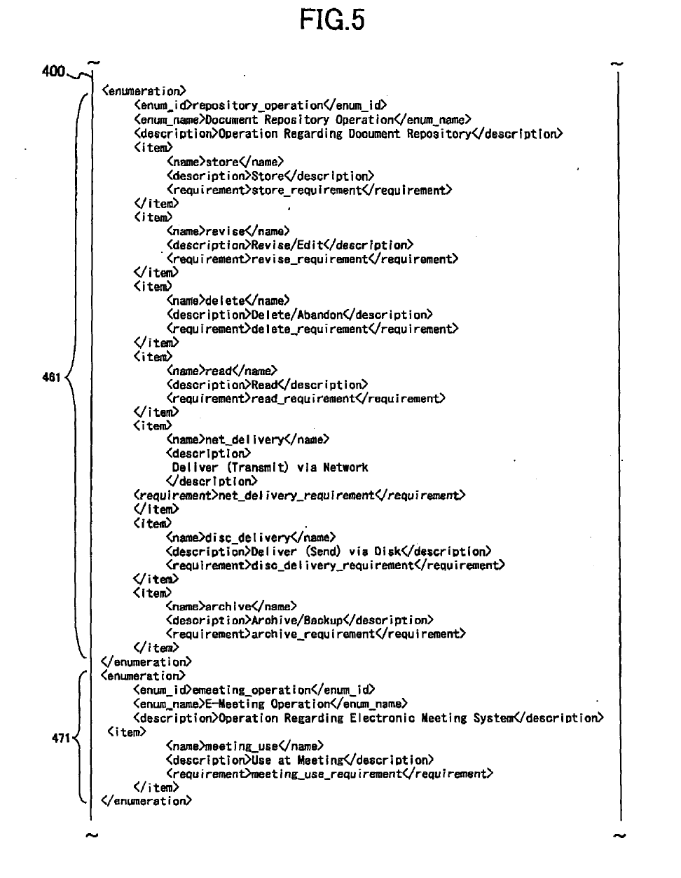

Then, for example, as shown in FIG. 4 and FIG. 5, operations for each of the system types are enumerated from a description 421 to a description 471.

In the description 421, “Copy from Paper to Paper” is described as “Operation Regarding Copier”. In a description 431, “Print Electronic Document on Paper” is described as “Operation Regarding Printer”. In a description 441, “Send Fax” and “Receive Fax” are described as “Operation Regarding Fax”. In a description 451, “Scan Paper Document into Electronic Document” is described as “Operation Regarding Scanner”.

In a description 461, “Store”, “Revise/Edit”, “Delete/Abandon”, “Read”, “Deliver (Transmit) via Network”, “Deliver (Send) via Disk” and “Archive/Backup” are described as “Operation Regarding Document Repository”. In the description 411, “Use at Meeting” is described as “Operation Regarding Electronic Meeting System”.

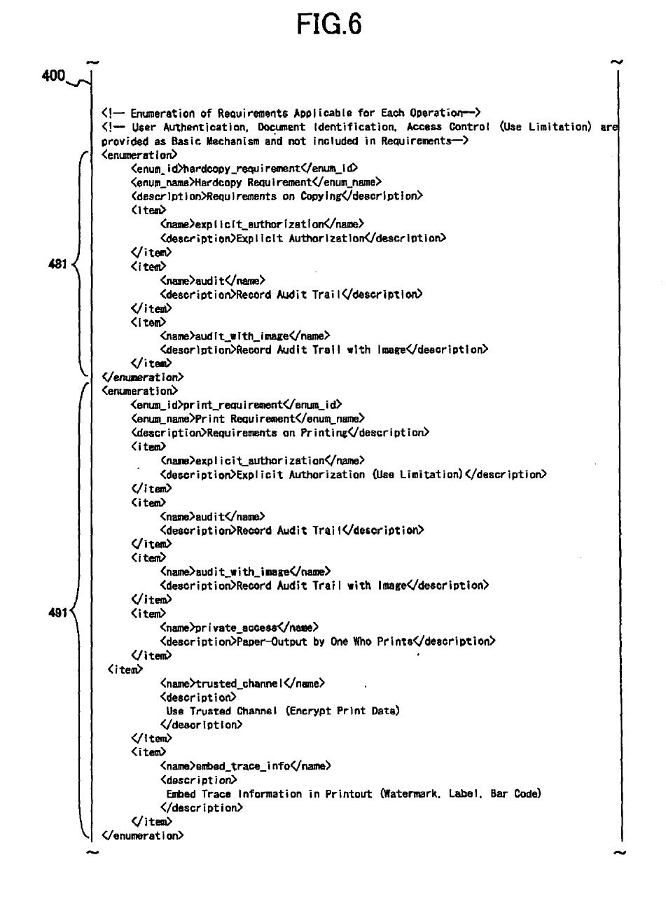

Further, for example, as shown in FIG. 6 to FIG. 13, requirements applicable for each of the operations are enumerated from a description 481 to a description 601.

In the description 481, “Explicit Authorization”, “Record Audit Trail” and “Record Audit Trail with Image” are described as “Requirements on Copying”.

In a description 491, “Explicit Authorization (Use Limitation)”, “Record Audit Trail”, “Record Audit Trail with Image”, “Paper-Output by One Who Prints”, “Use Trusted Channel (Encrypt Print Data)” and “Embed Trace Information in Printout (Watermark, Label, Bar Code)” are described as “Requirements on Printing”.

In a description 501, “Explicit Authorization (Use Limitation)”, “Record Audit Trail”, “Record Audit Trail with Image”, “Destination Restriction”, “Transmit in Private Mode”, “Use Trusted Channel”, “Embed Trace Information in Sent Fax (Watermark, Label, Bar Code)” and “Prevent Repudiation (Acquire Return Receipt)” are described as “Requirements on Sending Fax Message”.

In a description 511, “Record Audit Trail”, “Record Audit Trail with Image”, “Take out Private Fax by One Addressed To”, “Trusted Timestamp” and “Embed Trace Information in Received Fax (Watermark, Label, Bar Code)” are described as “Requirements on Receiving Fax Message”.

In a description 521, “Explicit Authorization (Use Limitation)”, “Record Audit Trail”, “Record Audit Trail with Image” and “Embed Trace Information in Scanned Image (Watermark, Label, Bar Code)” are described as “Requirements on Scanning (Requirements on Storing are applied after storing)”.

In a description 531, “Explicit Authorization (Use Limitation)”, “Record Audit Trail”, “Encrypt Stored Data”, and “Protect Stored Data from Alteration” are described as “Requirements on Storing”.

In a description 541, “Explicit Authorization (Use Limitation)”, “Record Audit Trail” and “Version Control” are described as “Requirements on Revising”.

In a description 551, “Explicit Authorization (Use Limitation)”, “Record Audit Trail.”, “Record Audit Trail with Image” and “Complete Erase” are described as “Requirements on Deleting/Abandoning”.

In a description 561, “Explicit Authorization (Use Limitation)”, “Record Audit Trail”, “Authorization for Reading Only Edition-Prohibited Data”, “Authorization for Reading Only Print-Prohibited Data”, “Authorization for Reading Only Reading-Location-Restricted Data” and “Authorization for Reading Only User-Restricted Data” are described as “Requirements on Reading”.

In a description 571, “Explicit Authorization (Use Limitation)”, “Record Audit Trail”, “Record Audit Trail with Image”, “Use Trusted Channel (Encrypt Transmitted Data)”, “Destination Restriction (such as Internal Delivery Only)”, “Authorization for Delivering only Edition-Prohibited Data”, “Authorization for Delivering Only Print-Prohibited Data”, “Authorization for Delivering Only Reading-Location-Restricted Data” and “Authorization for Delivering Only User-Restricted Data” are described as “Requirements on Delivering (Transmitting) via Network”.

In a description 581, “Explicit Authorization (Use Limitation)”, “Record Audit Trail”, “Record Audit Trail with Image”, “Encrypt Sent Data”, “Protect Sent Data from Alteration”, “Authorization for Sending Only Edition-Prohibited Data”, “Authorization for Sending Only Print-Prohibited Data”, “Authorization for Sending Only Reading-Location-Restricted Data” and “Authorization for Sending Only User-Restricted Data” are described as “Requirements on Delivering (Sending) via Disk”.

In a description 591, “Explicit Authorization (Use Limitation)”, “Record Audit Trail”, “Encrypt Archived Data” and “Protect Archived Data from Alteration” are described as “Requirements on Archiving/Backing-up”.

In the description 601, “Explicit Authorization (Use Limitation)”, “Record Audit Trail” and “Record Audit Trail with Image” are described as “Requirements on Using at Meeting”.

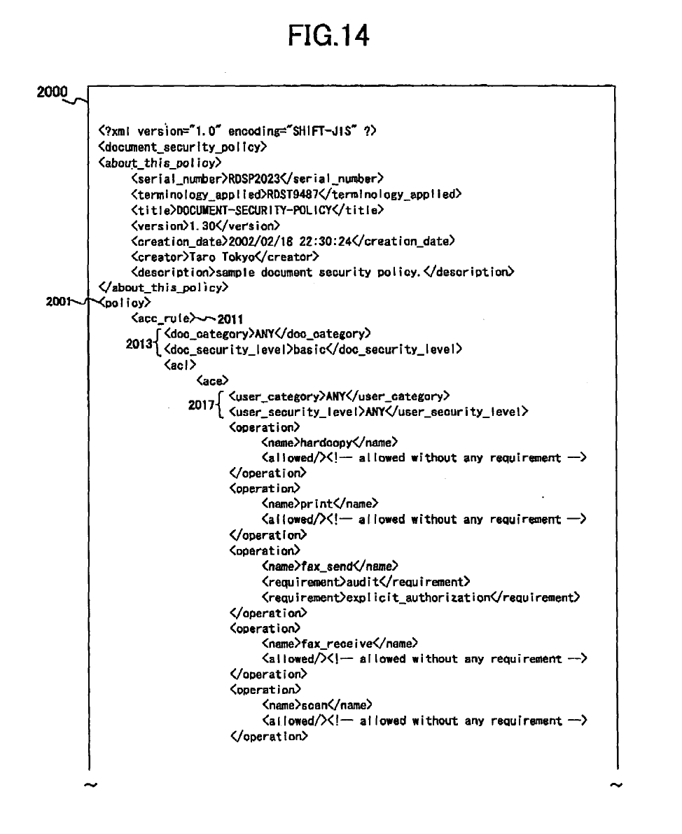

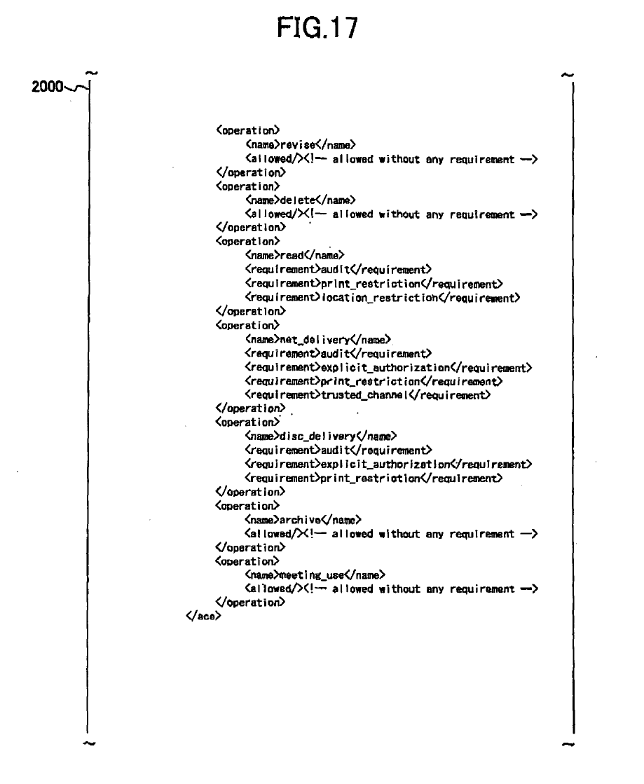

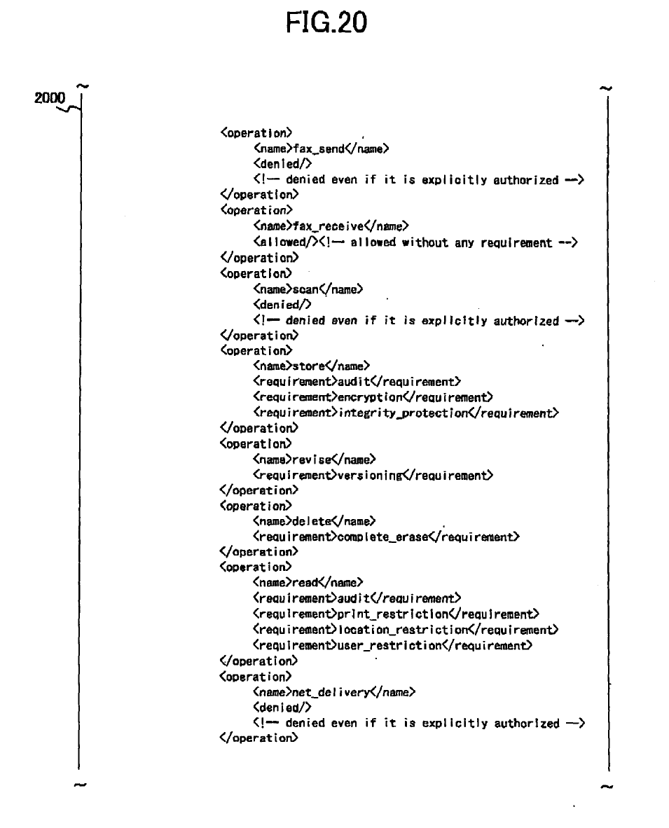

Next, a description will be given, with reference to FIG. 14 to FIG. 22, of a DSP based on the document label terminology file 300 shown in FIG. 2 and the policy terminology file 400 shown in FIG. 3 to FIG. 13. FIG. 14 to FIG. 22 show an example of a policy file. According to the document label terminology file 300 shown in FIG. 2 and the policy terminology file 400 shown in FIG. 3 to FIG. 13, a policy regarding security in a user organization is described by XML, for example, as a DSP 2000 shown in FIG. 14 to FIG. 22, composing one policy file.

The DSP 2000 as shown in FIG. 14 to FIG. 22 describes a policy from a description 2001 reading <policy> to a description 2002 reading </policy>.

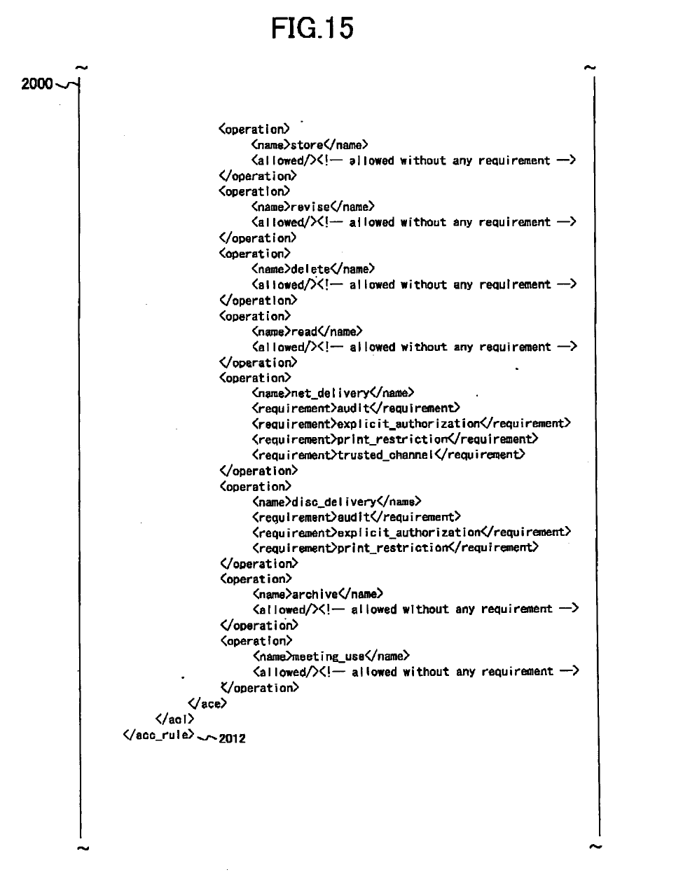

A description 2011 reading <acc_rule> shown in FIG. 14 to a description 2012 reading </acc_rule> shown in FIG. 15 describe a policy for each of the operations performed with respect to a document having document profiles of Document Category “ANY (Unrestricted)” and Document Security Level “basic (basic level)” indicated by a description 2013 reading <doc-category>ANY</doc-category> and <doc_security_level>basic</doc_security_level> by a user having user profiles of User Category “ANY (Unrestricted)” and User Security Level “ANY (Unrestricted)” indicated by a description 2017 reading <user_category>ANY</user_category> and <user_security_level>ANY</user_security_level>. Each of descriptions from <operation> to </operation> prescribes allowance (<allowed/>) or denial (<denied/>) of the operation, and further prescribes requirements (<requirement>) for the allowance, when the operation is allowed.

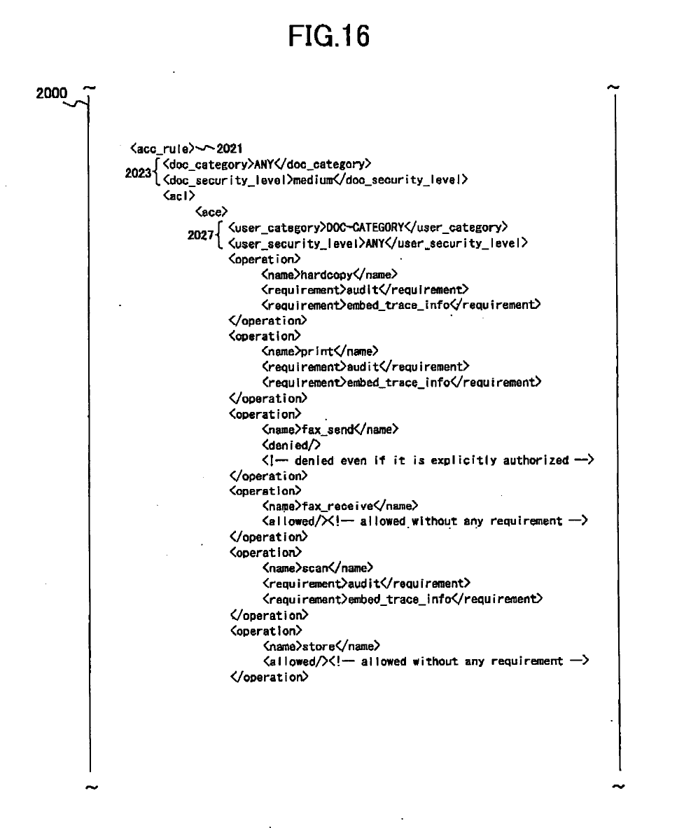

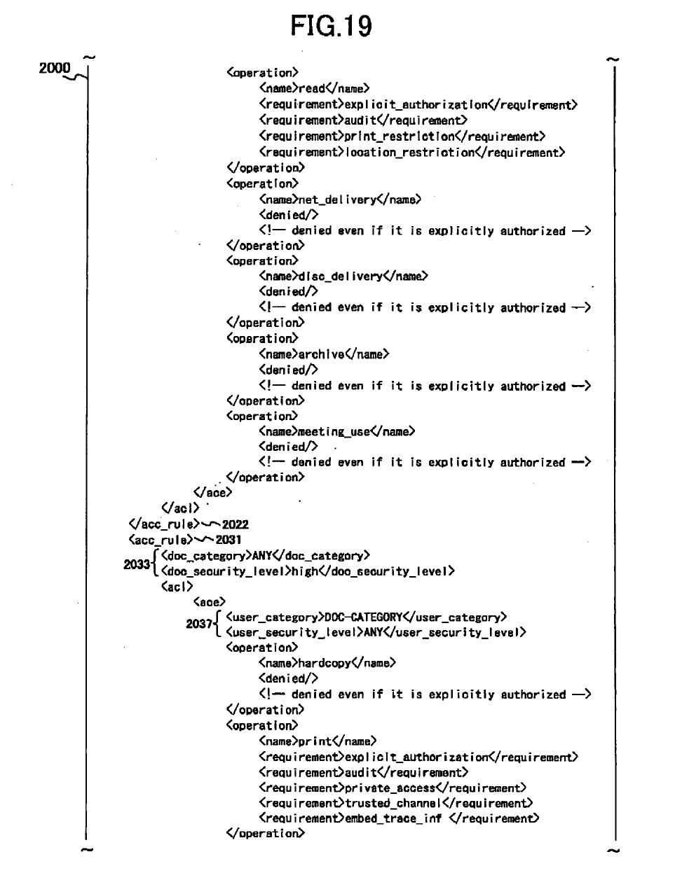

A description 2021 reading <acc_rule> shown in FIG. 16 to a description 2022 reading </acc_rule> shown in FIG. 19 describe a policy for each of the operations performed with respect to a document having document profiles of Document Category “ANY (Unrestricted)” and Document Security Level “medium (medium level)” indicated by a description 2023 reading <doc_category>ANY</doc_category> and <doc_security_level>medium</doc_security_level> by a user having user profiles of User Category “DOC-CATEGORY (Document Category Type)” (see the descriptions 312, 313 and 314 shown in FIG. 2) and User Security Level “ANY (Unrestricted)” indicated by a description 2027 reading <user_category>DOC-CATEGORY</user_category> and <user_security_level>ANY</user_security_level>. Each of descriptions from <operation> to </operation> prescribes allowance (<allowed/>) or denial (<denied/>) of the operation, and further prescribes requirements (<requirement>) for the allowance, when the operation is allowed.

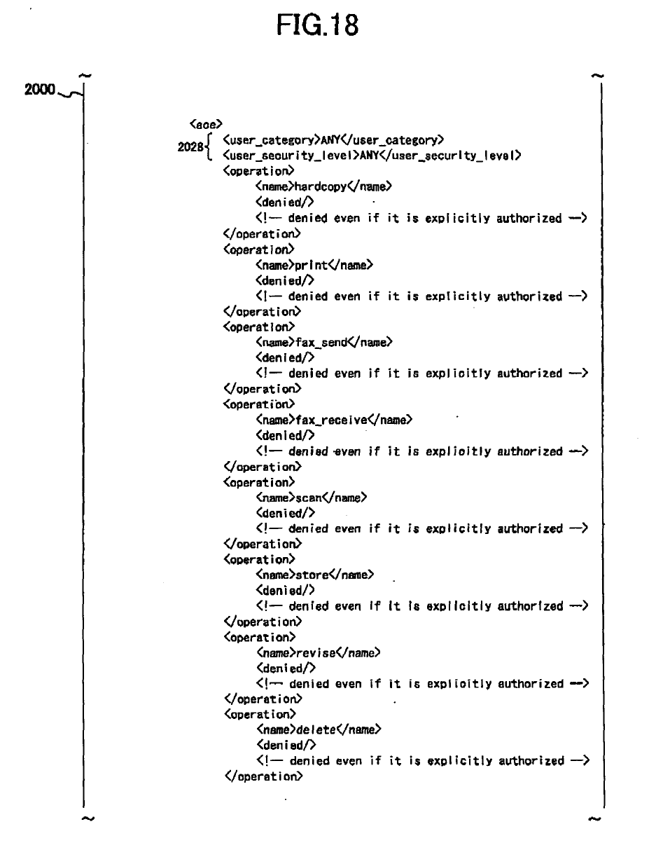

Besides, the description 2021 to the description 2022 also describe a policy for each of the operations performed with respect to a document having the same document profiles indicated by the description 2023 by a user having user profiles of User Category “ANY (Unrestricted)” and User Security Level “ANY (Unrestricted)” indicated by a description 2028 reading <user_category>ANY</user_category> and <user_security_level>ANY</user_security_level> shown in FIG. 18. Each of descriptions from <operation> to </operation> prescribes allowance (<allowed/>) or denial (<denied/>) of the operation, and further prescribes requirements (<requirement>) for the allowance, when the operation is allowed.

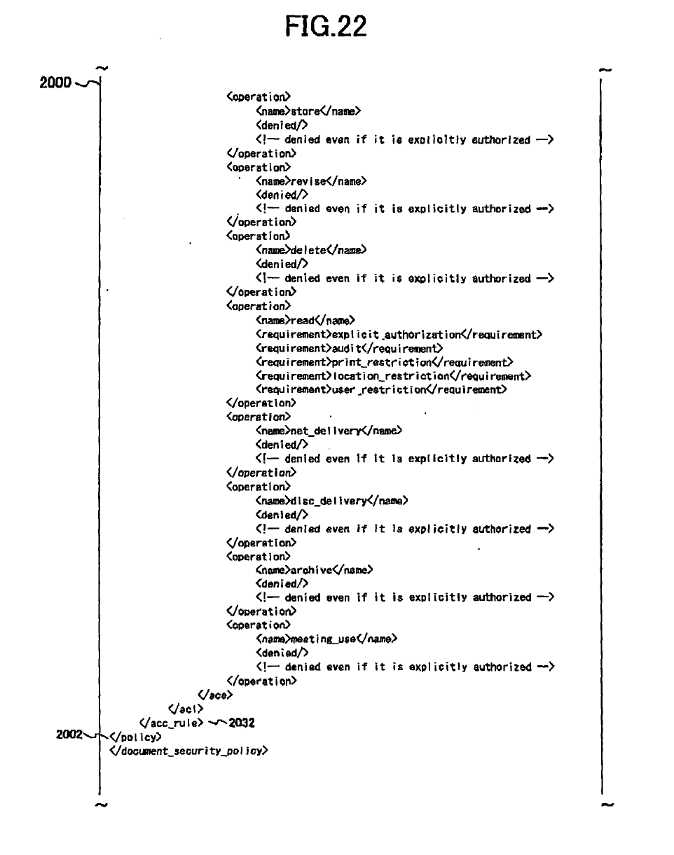

A description 2031 reading <acc_rule> shown in FIG. 19 to a description 2032 reading </acc_rule> shown in FIG. 22 describe a policy for each of the operations performed with respect to a document having document profiles of Document Category “ANY (Unrestricted)” and Document Security Level “high (high level)” indicated by a description 2033 reading <doc_category>ANY</doc_category> and <doc_security_level>high</doc_security_level> by a user having user profiles of User Category “DOC-CATEGORY (Document Category Type)” (see the descriptions 312, 313 and 314 shown in FIG. 2) and User Security Level “ANY (Unrestricted)” indicated by a description 2037 reading <user_category>DOC-CATEGORY</user_category> and <user_security_level>ANY</user_security_level>. Each of descriptions from <operation> to </operation> prescribes allowance (<allowed/>) or denial (<denied/>) of the operation, and further prescribes requirements (<requirement>) for the allowance, when the operation is allowed.

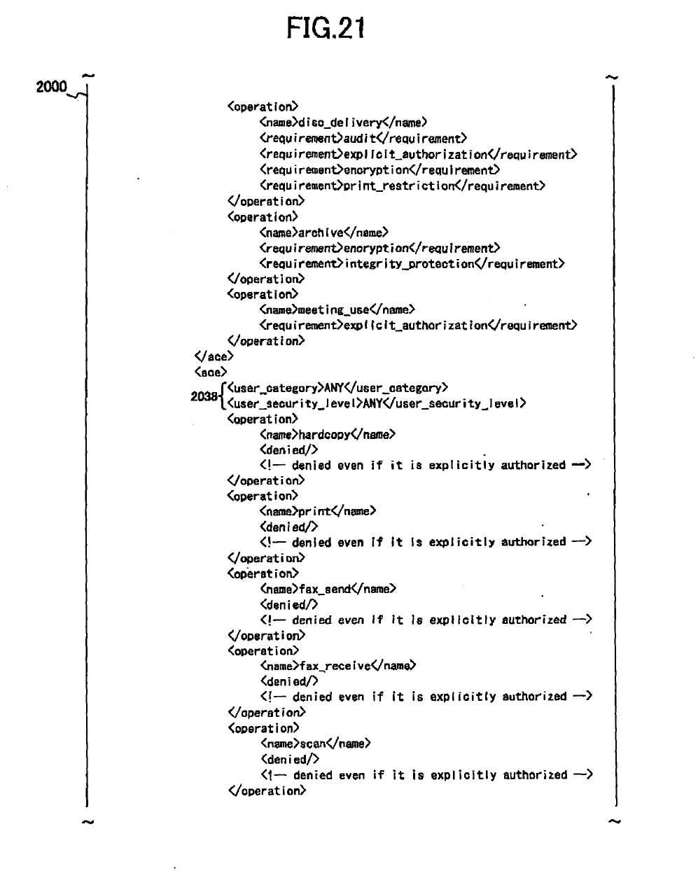

Besides, the description 2031 to the description 2032 also describe a policy for each of the operations performed with respect to a document having the same document profiles indicated by the description 2033 by a user having user profiles of User Category “ANY (Unrestricted)” and User Security Level “ANY (Unrestricted)” indicated by a description 2038 reading <user_category>ANY</user_category> and <user_security_level>ANY</user_security_level> shown in FIG. 21. Each of descriptions from <operation> to </operation> prescribes allowance (<allowed/>) or denial (<denied/>) of the operation, and further prescribes requirements (<requirement>) for the allowance, when the operation is allowed.

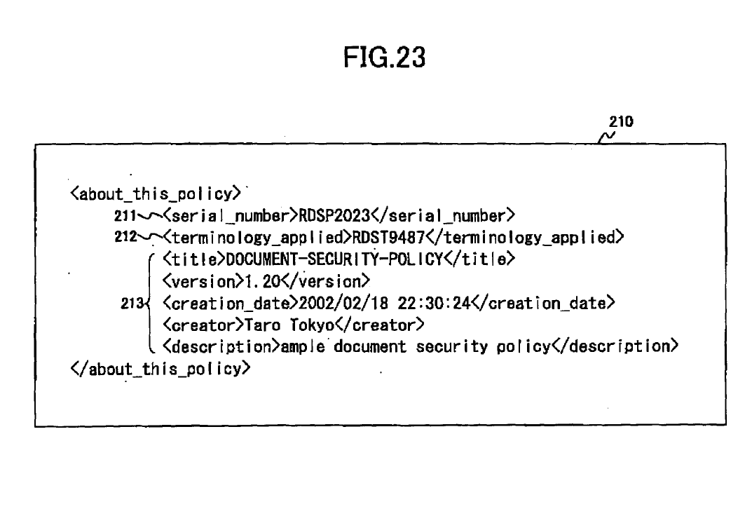

Next, a detailed description will be given, with reference to FIG. 23 to FIG. 25, of a structure of the DSP 2000 shown in FIG. 14 to FIG. 22.

FIG. 23 shows an example of identification information of the DSP. In identification information 210 of the DSP 2000, descriptions 211 to 213 between <about_this policy> and </about_this_policy> describe identification information for identifying the DSP 2000.

The description 211 reading <serial_number>RDSP2023</serial_number> describes a serial_number for identifying the DSP 2000 from other DSPS.

The description 212 reading <terminology_applied>RDST948 7</terminology_applied> describes a serial number of the policy terminology file 400 corresponding to the DSP 2000. Besides, the serial number of the policy terminology file 400 corresponding to the DSP 2000 is recorded so as to clarify on which policy terminology file the DSP 2000 is based, since this definition file may possibly be updated. The description 213 describes general bibliographic information of the DSP 2000, such as a title described by a description reading <title>DOCUMENT-SECURITYPOLICY</title>, a version number described by a description reading <version>1.20</version>, a creation date described by a description reading <creation_date>2002/02/18 22:30:24</creation_date>, a creator described by a description reading <creator>Taro Tokyo</creator>, and an explanation described by a description reading <description>sample document security policy</description>.

The identification information of the DSP 2000 ends at </about_this_policy>.

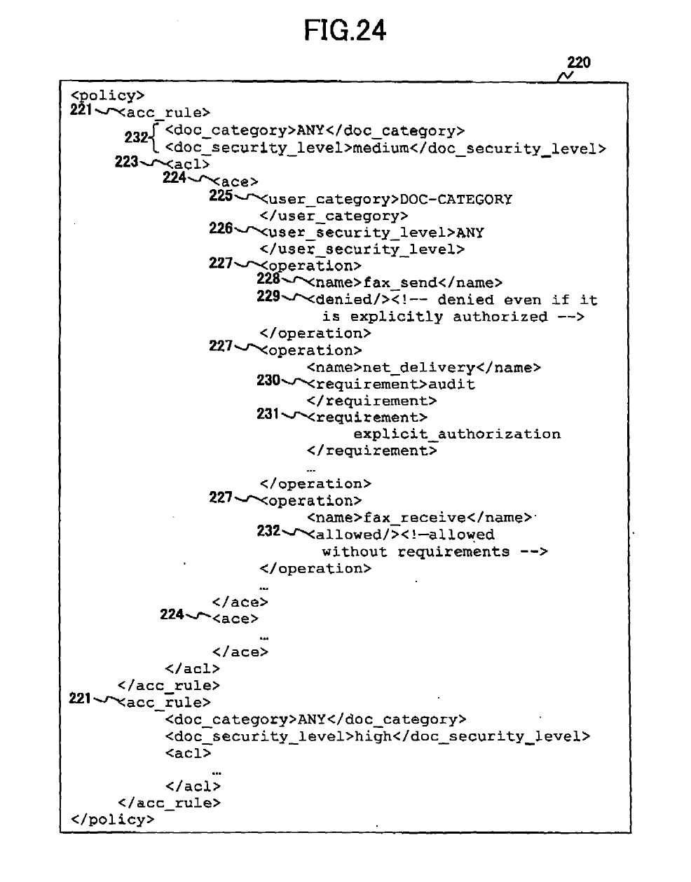

Next, following the above-described identification information of the DSP 2000, contents of the policy are described between <policy> and </policy>. FIG. 24 shows an explanatory example of describing the structure of the DSP.

A policy content 220 shown in FIG. 24 is recorded by using a hierarchical structure as explained below.

A policy <policy> comprises a plurality of access control rules <acc_rule> (descriptions 221). One access control rule <acc_rule> (description 221) uniquely specifies a category <doc_category> and a level <doc_security_level> of a subject document (description 232), and further includes one access control list <acl> (description 223).

The access control list <acl> (description 223) comprises a plurality of access control elements <ace> (descriptions 224).

Each of the access control elements <ace> (descriptions 224) uniquely specifies a category <user_category> (description 225) and a level <user_security_level> (description 226) of a subject user, and further comprises a plurality of operations <operation> (descriptions 227).

Each of the operations <operation> (descriptions 227) comprises one operation name <name> (description 228), and one denial <denied/> (description 229), one allowance <allowed/> (description 232), or a plurality of requirements <requirement> (descriptions 230 and 231).

In the descriptions 232 and 226, “ANY” described in the category <doc_category> of the document and in the level <user_security_level> of the user means that the policy is applicable to any category and level. Besides, “DOC-CATEGORY” of the category <user_category> of the user contained in the description 225 means that the policy is applicable when the category of the user is identical to the category of the document.

In the present embodiment, the denial <denied/> (description 229) is specified for a denied operation; however, it may be arranged that no description of an operation in the DSP 2000 means that an access thereof is not allowed.

Thus, the DSP can describe what type (the category and the level) of the user can perform what operation with respect to a document according to the type (the category and the level) of the document. Further, when the user can perform the operation with respect to the document, the DSP can clearly describe what requirements have to be satisfied.

Besides, as mentioned above, the DSP is described by XML not depending on a platform so that the DSP can be used in common among different types of systems. Especially, Since a security policy needs to be applicable not only to an electronic document but also to a paper document, the DSP can prescribe operations (hardcopy, scan, etc.) with respect to a paper document, as described in the policy terminology file 400 shown in FIG. 3 to FIG. 13 and the DSP 2000 shown in FIG. 14 to FIG. 22.

The requirements shown in the FIG. 24 include the description 231 reading <requirement>explicit_authorization</requirement>. This requirement means that “the operation is allowed when an explicit authorization is obtained from an administrator/manager of the document”. Controlling all of the operations according to this DSP may possibly eliminate flexibility in operation control. However, including this requirement for the explicit authorization enables a flexible operation control.

Besides, one of features of the present embodiment is that, by enabling the requirement for the “explicit authorization” to be specified, an operation allowable when an explicit authorization is obtained can be distinguished from an operation denied even when an explicit authorization is obtained.

That is, an operation not described in the DSP 2000 or specified by <denied/> is an operation that has to be denied even though an explicit authorization is obtained. Accordingly, an intention with which to describe the policy can be prescribed appropriately so as to prevent a situation where an operation is performed upon erroneously providing an authorization.

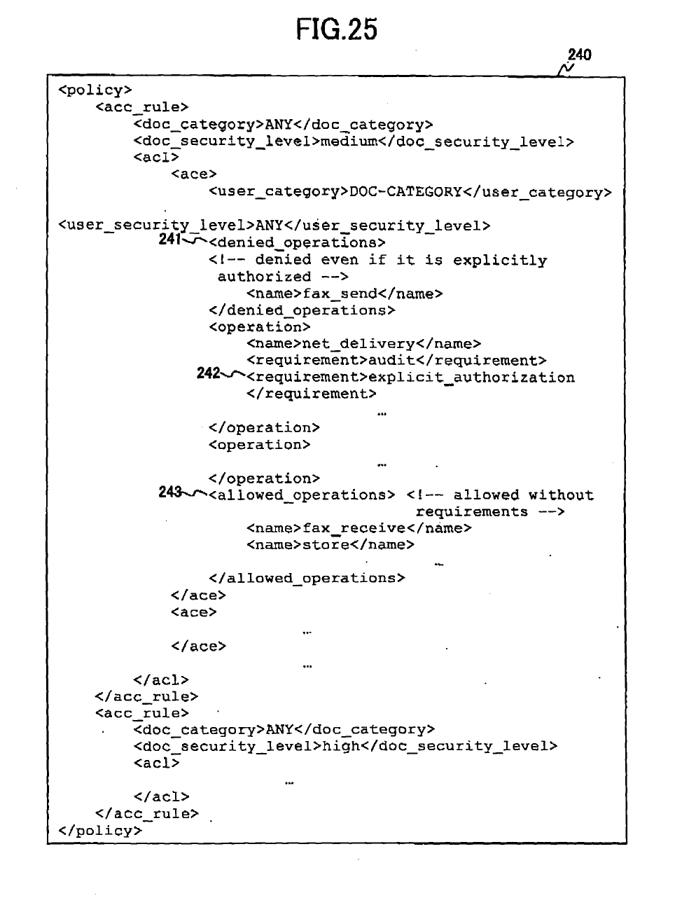

Next, a detailed description will be given, with reference to FIG. 25, of another example of describing the DSP according to the present invention. FIG. 25 shows the example of describing the DSP.

When there are lots of operations allowed unconditionally or denied, it is inefficient to describe a nested structure, such as <operation><allowed/></operation>, for each of the operations. Therefore, as in a policy content 240 shown in FIG. 25, a description 243 reading <allowed_operations> which enumerates unconditionally allowed operations, and a description 241 reading <denied_operations> which enumerates denied operations may be used.

Besides, a description 242 reading <requirement>explicit_authorization</requirement> has a similar meaning as the description 231 shown in the FIG. 24.

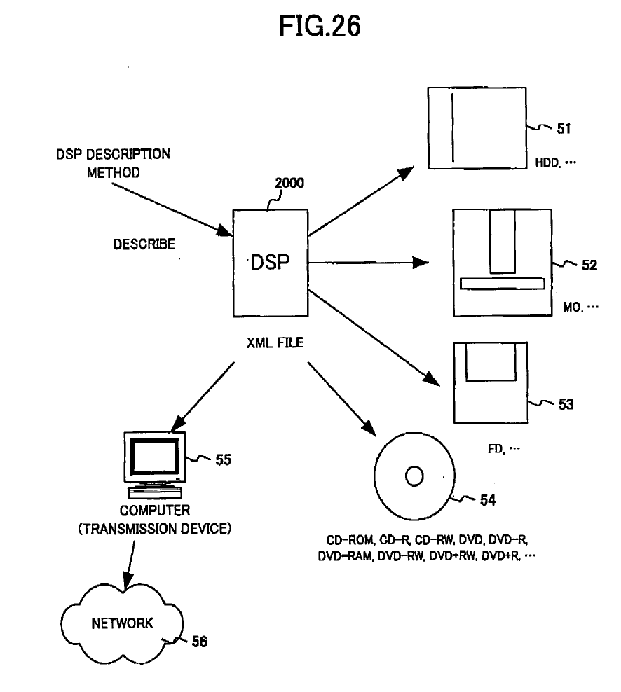

FIG. 26 shows various media used for storing and delivering the above-described DSP.

As mentioned above, the DSP 2000 shown in FIG. 26 is described by XML (Extensible Markup Language), and is recordable as an electronic file. Besides, the electronic file can be stored in a storage medium, such as a hard disk (HDD) 51, a magneto-optical disc (MO) 52, a flexible disk (FD) 53, or an optical disc 54, such as a CD-ROM, a CD-R, a CD-RW, a DVD, a DVD-R, a DVD-RAM, a DVD-RW, a DVD+RW or a DVD+R. Besides, the DSP 2000 in the electronic form can be transmitted via a network 56 by using a computer 55.

The DSP 2000 is not a description of a security policy oriented to a specific system, but is a description of a security policy usable in common by a plurality of different systems. Therefore, storing this security policy description in a storage medium, and delivering or transmitting the security policy description via a network facilitates the common use of the security policy description by a plurality of systems.

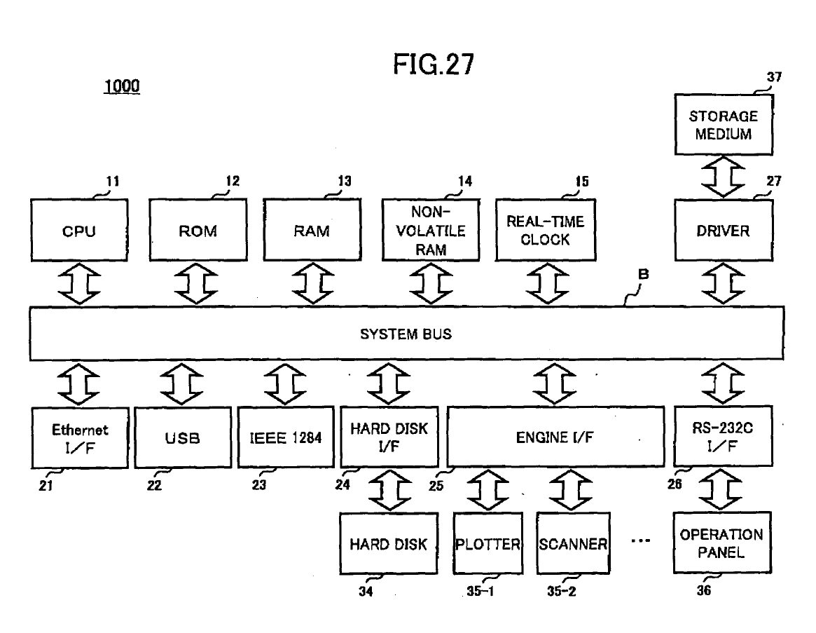

FIG. 27 is a block diagram showing a hardware configuration of an image forming device according to the embodiment of the present invention. In FIG. 27, an image forming device 1000 is a device controlled by a computer, and comprises a CPU (central processing unit) 11, a ROM (Read-Only Memory) 12, a RAM (Random Access Memory) 13, a non-volatile RAM (non-volatile Random Access Memory) 14, a real-time clock 15, an Ethernet (registered trademark) I/F (Interface) 21, a USB (Universal Serial Bus) 22, an IEEE (Institute of Electrical and Electronics Engineers) 1284 23, a hard disk I/F 24, an engine I/F 25, an RS-232C I/F 26, and a driver 27, and is connected with a system bus B.

The CPU 11 controls the image forming device 1000 according to programs stored in the ROM 12. In the RAM 13, domains are assigned to resources connected to the interfaces 21 to 26. Information necessary for the CPU 11 to control the image forming device 1000 is stored in the non-volatile RAM 14. The real-time clock 15 measures a current time, and is used by the CPU 11 when synchronizing processes.

An interface cable for Ethernet (registered trademark), such as 10BASE-T or 100BASE-TX, is connected to the Ethernet (registered trademark) I/F 21. An interface cable for USB is connected to the USB 22. An interface cable for IEEE1284 is connected to the IEEE1284 23.

A hard disk 34 is connected to the hard disk I/F 24, and document data of a document to be printed which is transmitted via a network, or image data after printing is stored in the hard disk 34 via the hard disk I/F 24. A plotter 35-1 printing on a predetermined medium according to document data, a scanner 35-2 importing image data, and so forth are connected to the engine I/F 25. An operation panel 36 is connected to the RS-232C I/F 26 so as to display information to a user, and to obtain input information or setting information from a user.

Programs realizing processes performed by the image forming device 1000 are provided for the image forming device 1000 via a storage medium 37, such as a CD-ROM. Specifically, when the storage medium 37 in which the programs are stored is set to the driver 27, the driver 27 reads the programs from the storage medium 37, and the read programs are installed in the hard disk 34 via the system bus B. When the programs are started, the CPU 11 commences the processes according to the programs installed in the hard disk 34. Besides, the storage medium 37 for storing the programs is not limited to the CD-ROM, but to any computer-readable storage medium. The programs may be downloaded via a network, and be installed in the hard disk 34.

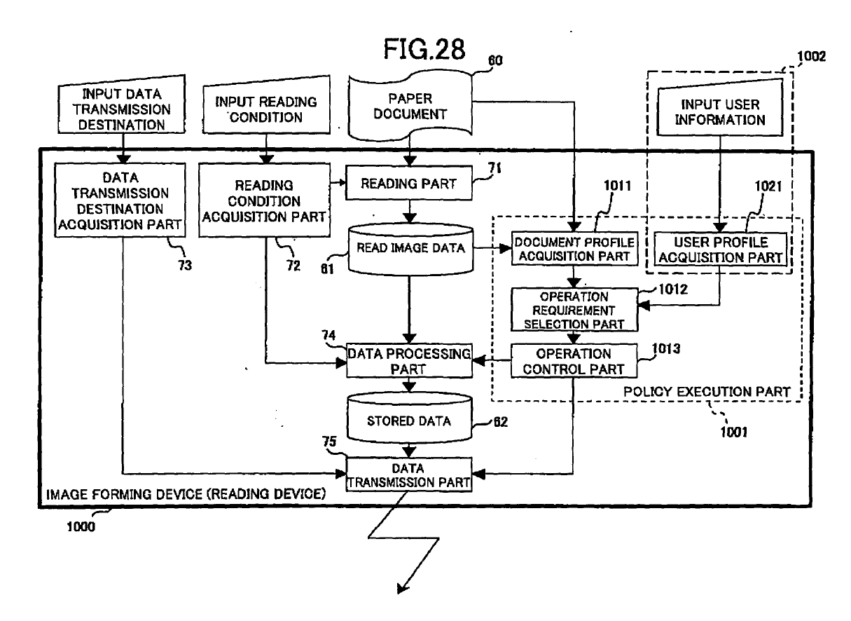

Next, a detailed description will be given, with reference to FIG. 28 to FIG. 30, of the image forming device operating according to the security policy.

FIG. 28 is a diagram showing a functional structure of the image forming device as a reading device operating according to the security policy.

The image forming device 1000 as the reading device shown in FIG. 28 mainly includes a reading part 71, a reading condition acquisition part 72, a data transmission destination acquisition part 73, a data processing part 74, a data transmission part 75, a policy execution part 1001, read image data 61, and stored data 62.

The policy execution part 1001 includes a document profile acquisition part 1011, an operation requirement selection part 1012, an operation control part 1013, and a user profile acquisition part 1021. The document profile acquisition part 1011 acquires a document profile from a paper document 60 or the read image data 61, and imparts the document profile to the operation requirement selection part 1012.

On the other hand, the user profile acquisition part 1021 acquires user information input by a user, and imparts the user information to the operation requirement selection part 1012. The operation requirement selection part 1012 selects a requirement for allowance according to the DSP 2000, and imparts a result thereof to the operation control part 1013. The operation control part 1013 orders a data processing to image data of the read paper document 60.

Regarding the policy execution part 1001, a portion indicated by a dashed line 1002 may be omitted.

The reading part 71 is a processing part reading (scanning) the paper document 60 according to a reading condition input by a user which is imparted from the reading condition acquisition part 72, and read image data is stored in the read image data 61. Besides, the reading part 71 imparts a document profile acquired from the image data 61 to the document profile acquisition part 1011.

The reading condition acquisition part 72 is a processing part acquiring the reading condition input by the user, and imparting the reading condition to the reading part 71 and the data processing part 74.

The data transmission destination acquisition part 73 acquires data transmission destination input by a user, and imparts the data transmission destination to the data transmission part 75.

The data processing part 74 performs a data processing to the read image data according to the reading condition input by the user which is imparted from the reading condition acquisition part 72 so that the requirement imparted from the operation control part 1013 is satisfied, and stores the processed image data in the stored data 62.

The data transmission part 75 transmits subject image data extracted from the stored data 62 to the transmission destination imparted from the data transmission destination acquisition part 73 so that the requirement imparted from the operation control part 1013 is satisfied.

When image data does not need to be transmitted to outside, the data transmission part 75 may be omitted. Besides, image data may be store in the storage medium 37.

In FIG. 28, the image forming device 1000 as the reading device is configured by a dedicated-purpose hardware; however, the image forming device 1000 as the reading device may be configured by a general-purpose computer and programs executed on the computer.

Besides, hereinbelow-described programs realizing the embodiment of the present invention on a computer is recorded on a computer-readable storage medium, and is read by the computer prior to executing the programs. Besides, such a program can also be delivered via a computer network.

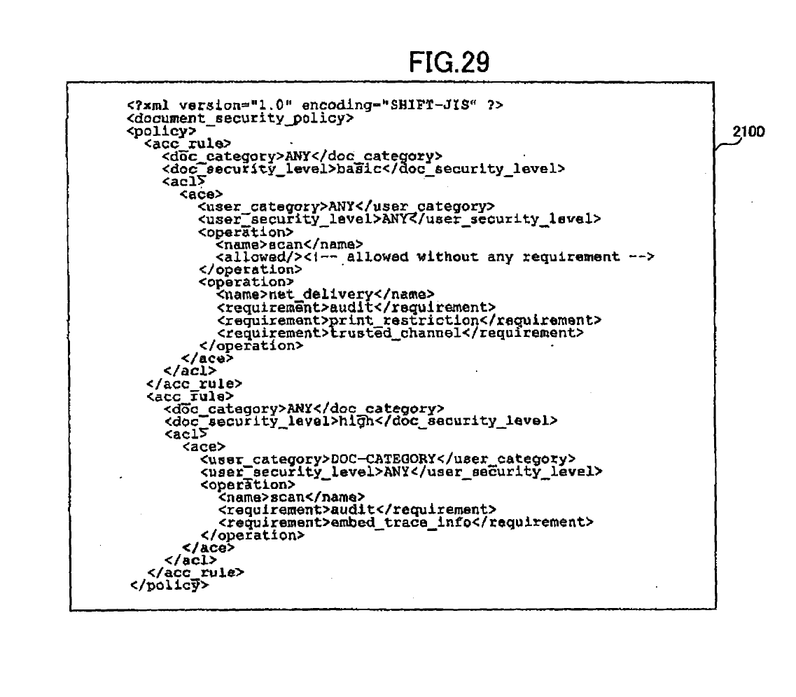

FIG. 29 shows a simplified example of the DSP. The simplified example of the DSP 2000 is used for its convenience in explanation. A DSP 2100 shown in FIG. 29 sets forth a rule 1, a rule 2 and a rule 3, as follows.

The rule 1 is described by a part from <acc_rule> at a fourth line in FIG. 29 to <user_security_level>ANY</user_security_level> at a 10th line, and a part from <operation> at an 11th line to </operation> at a 14th line.

<doc_category>ANY</doc_category> at a fifth line indicates that the rule 1 is applied regardless of the document category.

<doc_security level>basic</doc_security_level> at a sixth line indicates that the security level of the document is basic.

<user_category>ANY</user_category> at a ninth line indicates irrelevance to the category of the user.

<user-security_level>ANY</user-security_level> at the 10th line indicates irrelevance to the security level of the user.

Further, <name>scan</name> and <allowed/> at a 12th line and a 13th line indicate that reading (scanning) is allowed without any requirement.

Therefore, according to the rule 1, by the fifth line, the sixth line, the ninth line, the 10th line, the 12th line and the 13th line, the reading (scanning) is allowed without any requirement, when the security level of the document is basic, regardless of the document category, regardless of the category of the user, and regardless of the security level of the user.

Next, the rule 2 is described by the part from <acc_rule> at the fourth line in FIG. 29 to <user_security_level>ANY</user_security_level> at the 10th line, and a part from <operation> at a 15th line to </operation> at a 20th line.

<doc_category>ANY</doc_category> at the fifth line indicates that the rule 2 is applied regardless of the document category.

<doc_security_level>basic</doc_security_level> at the sixth line indicates that the security level of the document is basic.

<user_category>ANY</user_category> at the ninth line indicates irrelevance to the category of the user.

<user_security_level>ANY</user_security_level> at the 10th line indicates irrelevance to the security level of the user.

Further, <name>net_delivery</name>, <requirement>audit</requirement>, <requirement>print_restriction</requirement> and <requirement>trusted_channel</requirement> from a 16th line to a 19th line indicate that a network delivery is allowed when requirements of “recording a log”, “applying a print restriction” and “using a trusted channel” are satisfied.

Therefore, according to the rule 2, by the fifth line, the sixth line, the ninth line, the 10th line, and the 16th line to the 19th line, the network delivery is allowed upon satisfying the requirements of recording a log, applying a print restriction and using a trusted channel, when the security level of the document is basic, regardless of the document category, regardless of the category of the user, and regardless of the security level of the user.

The rule 3 is described by a part from <acc_rule> at a 24th line in FIG. 29 to <user_security_level>ANY</user_security_level> at a 30th line, and a part from <operation> at a 31st line to </operation> at a 35th line.

<doc_category>ANY</doc_category> at a 25th line indicates that the rule 3 is applied regardless of the document category.

<doc_security_level>high</doc_security_level>at a 26th line indicates that the security level of the document is high.

<user_category> DOC-CATEGORY</user_category> at a 29th line indicates that the category of the user is identical to the category of the document.

<user_security_level>ANY</user_security_level> at the 30th line indicates irrelevance to the security level of the user.

Further, <name>scan</name>, <requirement>audit</requirement> and <requirement>embed_trace info</requirement> from a 32nd line to a 34th line indicate that reading (scanning) is allowed when requirements of “recording a log” and “embedding traceable information” are satisfied.

Therefore, according to the rule 3, by the 25th line, the 26th line, the 29th line, the 30th line, and the 32nd line to the 34th line, the reading (scanning) is allowed upon satisfying the requirements of recording a log and embedding traceable information, when the security level of the document is high, and when the category of the user is identical to the category of the document, regardless of the document category, and regardless of the security level of the user.

Besides, “embedding traceable information” in the rule 3 may include embedding an electronic watermark, embedding a displayable label, and adding document profile information, and so forth, for example. The displayable label may contain authentication data of a user directing the reading, and a timestamp upon directing the reading. Further, as for “recording a log”, authentication data of a user directing the reading, document data to be read, and a timestamp upon directing the reading may be recorded on a log. Besides, as for “recording a log” in the rule 2, authentication data of a user directing the network delivery, information of a network delivery destination, document data to be delivered, and a timestamp upon directing the network delivery may be recorded on a log.

A more detailed description will be given with reference to FIG. 2B and FIG. 29.

According to the DSP 2100 shown in FIG. 29, for example, upon reading a document having the security level of “basic”, there are no requirements to be extracted (selected).

Besides, according to the DSP 2100 shown in FIG. 29, for example, upon reading a document having the security level of “high”, requirements on the reading become “recording a log” and “embedding traceable information”, as described above.

Then, when there are no requirements to be extracted (selected) as when the security level of the document is “basic”, the operation control part 1013 directs the data processing part 74 to read the document so that the user obtains the document data, and the operation ends.

On the other hand, when there are requirements to be extracted (selected) as when the security level of the document is “high”, the operation requirement selection part 1012 judges whether all of the requirements can be satisfied, and imparts a result of the judgment to the operation control part 1013.

When the result of the judgment indicates that all of the requirements cannot be satisfied, the operation control part 1013 directs the data processing part 74 to prohibit a data processing so that the data processing part 74 abandons the read data, and the operation ends. The operation control part 1013 informs the user that the data processing cannot be performed.

On the other hand, when the result of the judgment indicates that all of the requirements can be satisfied, the operation control part 1013 directs the data processing part 74 to perform a data processing so that the requirements be satisfied. The user obtains the document data, and the operation ends.

In this case, the following process is performed.

The user profile acquisition part 1021 issues a request for inputting a user ID to the user who provides a reading command from the operation panel 36. The user inputs the user ID from the operation panel 36. According to the input user ID, the user profile acquisition part 1021 acquires a category and a security level corresponding to the user ID which are registered in a database, and imparts the category and the security level to the operation requirement selection part 1012.

When recording a log, traceable information is embedded in the read document data (e.g., embedding an electronic watermark, embedding a displayable label, and adding document profile information, and so forth). The displayable label may contain authentication data of the user directing the reading, and a timestamp upon directing the reading.

Finally, the user obtains the image data of the paper document 60 in the stored data 62, and the process ends.

Thus, the paper document 60 can be read according to the security policy shown in FIG. 29.

Next, a description will be given of a case where the image forming device 1000 reads the paper document 60, and delivers the read document to a network.

First, a user sets the paper document 60 in the image forming device 1000, then the user inputs a reading condition, specifies a delivery destination of read data, and provides a command for reading the paper document 60, from the operation panel 36.

The reading part 71 reads the paper document. The document profile acquisition part 1011 extracts a document ID from image information, such as a bar code or an electronic watermark, of image data of the read paper document 60, acquires a category and a security level (document profiles) corresponding to the document ID, and imparts the category and the security level to the operation requirement selection part 1012.

According to the document profiles imparted from the document profile acquisition part 1011, the operation requirement selection part 1012 searches the DSP 2100 for an entry corresponding to the document profiles so as to extract requirements.

According to the DSP 2100 shown in FIG. 29, for example, upon reading a document having the security level of “basic”, there are no requirements on the reading. However, as mentioned above with respect to the rule 2, upon delivering the read document to a network, requirements on the network delivery become “recording a log”, “applying a print restriction” and “using a trusted channel”.

Besides, according to the DSP 2100 shown in FIG. 29, for example, upon reading a document having the security level of “high”, requirements on the reading become “recording a log” and “embedding traceable information (e.g., embedding an electronic watermark, embedding a displayable label, and adding document profile information, as mentioned above)”, as described above with respect to the rule 3. However, since the rule 3 does not allow delivering the read document to a network, the network delivery is not allowed.

For example, when there are no requirements on delivering the document to a network in the DSP 2100, the operation control part 1013 directs the data transmission part 75 to deliver the document to a network so that the data transmission part 75 delivers the document to the network, and the operation ends.

On the other hand, for example, when there are requirements on delivering the document to a network in the DSP 2100, the operation requirement selection part 1012 judges whether all of the requirements can be satisfied.

When there is no rule in the DSP 2100 which allows delivering the document to a network, the operation control part 1013 informs the user that “there is no rule which allows delivering the document to a network”, and abandons the image data of the paper document 60, and the operation ends. For example, this is the above-mentioned case where the security level of the document is “high”.

When the operation requirement selection part 1012 judges that all of the requirements cannot be satisfied, the operation control part 1013 informs the user thereof, the operation control part 1013 directs the data processing part 74 to abandon the image data of the paper document 60, and the operation ends.

When all of the requirements can be satisfied, for example as in the above-mentioned case where the security level of the document is “basic”, the operation control part 1013 directs the data processing part 74 to read the document so that the requirements be satisfied, and directs the data transmission part 75 to deliver the document to the network, and the operation ends.

Then, the user profile acquisition part 1021 issues a request for inputting a user ID to the user who provides a reading command from the operation panel 36.

When the user inputs the user ID from the operation panel 36, the user profile acquisition part 1021 acquires a category and a security level corresponding to the user ID, and imparts the category and the security level to the operation requirement selection part 1012. The operation control part 1013 records a log according to the requirements imparted from the operation requirement selection part 1012.

Further, the operation control part 1013 directs the data processing part 74 to convert the image data of the read paper document 60 into unprintable data (for example, a PDF of ADOBE (registered trademark) having a print-prohibited profile, etc.).

Finally, the operation control part 1013 directs the data transmission part 75 to deliver the document to the network so that the data transmission part 75 delivers the document to the network via a trusted communication channel (for example, IPsec, VPN, etc.), and the operation ends

Thus, by using the DSP 2100 shown in FIG. 29, the image forming device 1000 as the reading device shown in FIG. 28 can read a document, and deliver the read document to a network.

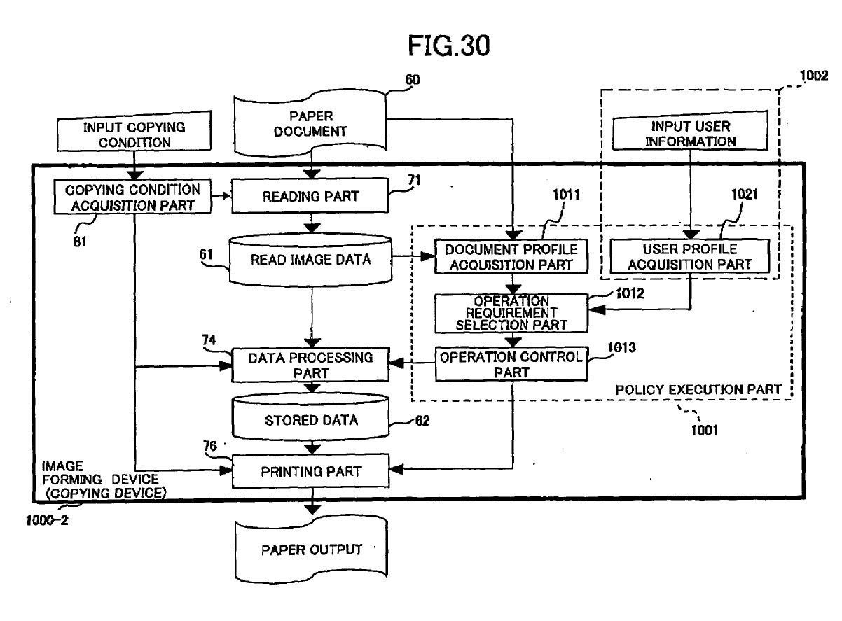

Next, a description will be given, with reference to FIG. 30, of the image forming device as a copying device operating according to the security policy. FIG. 30 is a diagram showing a functional structure of the image forming device as the copying device operating according to the security policy. Processing parts in FIG. 30 that are identical or equivalent to the processing parts shown in FIG. 28 are referenced by the same reference marks, and will not be described in detail.

In FIG. 30, an image forming device 1000-2 as the copying device differs from the image forming device 1000 shown in FIG. 28 in comprising a copying condition acquisition part 81 instead of the reading condition acquisition part 72 and the data transmission destination acquisition part 73 of the image forming device 1000 shown in FIG. 28, and comprising a printing part 76 instead of the data transmission part 75 of the image forming device 1000 shown in FIG. 28.

However, the image forming device 1000 may further comprise the copying condition acquisition part 81 and the printing part 76 of the image forming device 1000-2. The portion indicated by the dashed line 1002 may be omitted.

The copying condition acquisition part 81 acquires a copying condition input from the operation panel 36 by a user, and imparts the copying condition to the reading part 71 and the data processing part 74, and also imparts the copying condition to the printing part 76.

The printing part 76 acquires image data of the paper document 60 from the stored data 62 according to a direction from the operation control part 1013, performs a printing according to the copying condition imparted from the copying condition acquisition part 81 so that a requirement imparted from the operation control part 1013 is satisfied, and outputs a copy document 60b on which the image data is formed.

Hereinbelow, a detailed description will be given of the document profile acquisition part 1011 and the user profile acquisition part 1021.

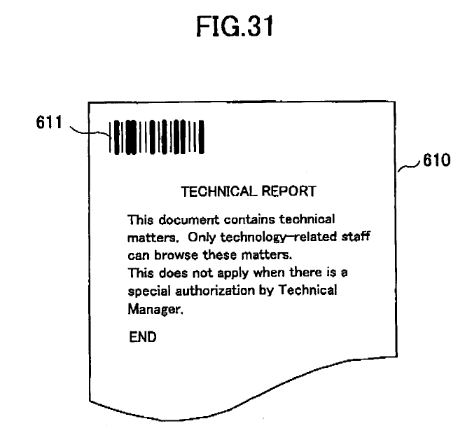

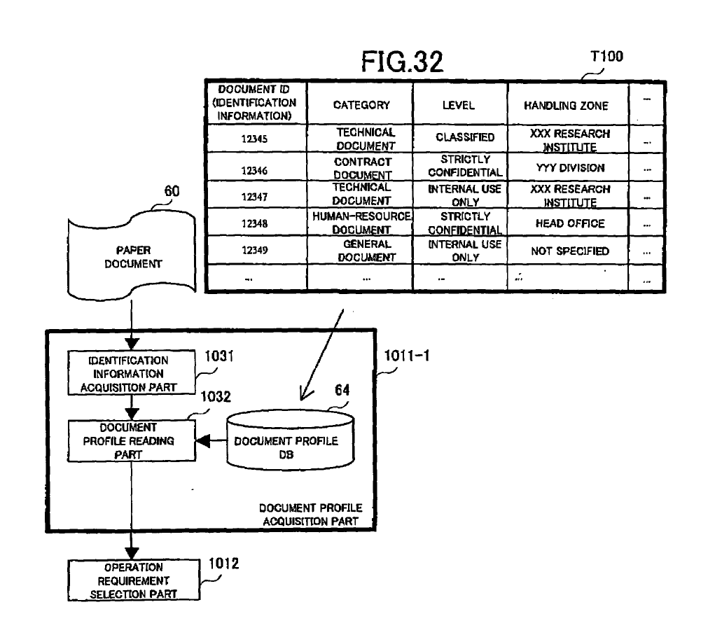

FIG. 31 shows a case where identification information of a document is printed as a bar code. In a document 610 shown in FIG. 31, identification information is printed as a bar code 611 at a predetermined position. In this case, the document profile acquisition part 1011 acquires the identification information directly from the document 610 as the paper document 60, and acquires document profiles from the identification information, as shown in FIG. 32.

FIG. 32 is a diagram showing a first functional structure of the document profile acquisition part. In FIG. 32, a document profile acquisition part 1011-1 comprises an identification information acquisition part 1031, a document profile reading part 1032, and a document profile DB 64.

The identification information acquisition part 1031 reads the bar code 611 of the document 610 shown in FIG. 31 from the paper document 60 as identification information, and imparts the identification information to the document profile reading part 1032.

According to the identification information imparted from the identification information acquisition part 1031, the document profile reading part 1032 acquires document profiles by referring to a table T100, and imparts the document profiles to the operation requirement selection part 1012.

The document profile DB 64 manages document profiles by the table T100. The table T100 includes items, such as a document ID as identification information, a category, a level and a handling tone. The document profile reading part 1032 is able to acquire information, such as the category, the level and the handling zone, as document profiles.

The first functional structure is suitable when a dedicated-purpose reading device, such as for a bar code, RFID or MCR, is already used.

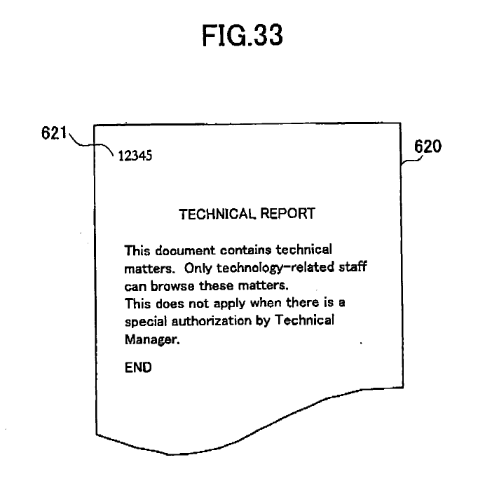

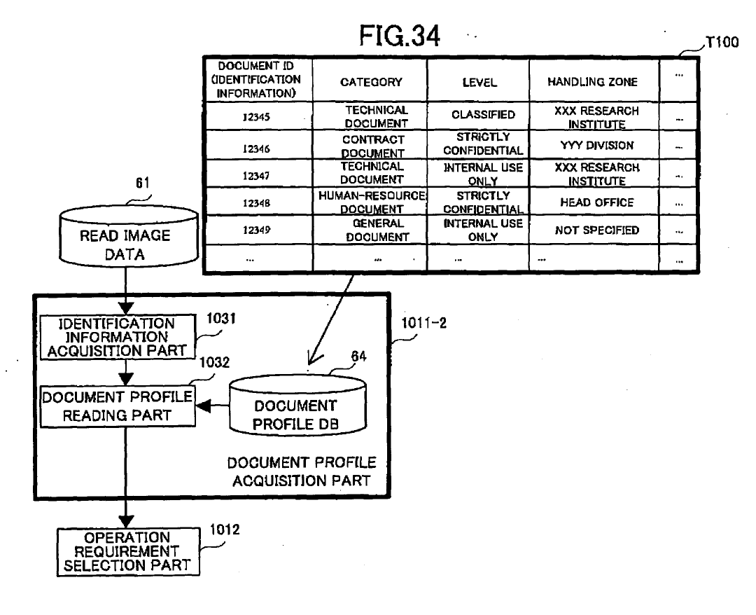

FIG. 33 shows a case where identification information of a document is printed as a number. In a document 620 shown in FIG. 33, identification information is printed as a number 621 at a predetermined position. In this case, the document profile acquisition part 1011 acquires the identification information from the read image data 61 in which image data of the document 620 as the paper document 60 is stored, and acquires document profiles from the identification information, as shown in FIG. 34.

FIG. 34 is a diagram showing a second functional structure of the document profile acquisition part. Parts in FIG. 34 that are identical or equivalent to the parts shown in FIG. 32 are referenced by the same reference marks, and will not be described in detail.

In FIG. 34, a document profile acquisition part 1011-2 is similar to the document profile acquisition part 1011-1 shown in FIG. 32 in comprising the identification information acquisition part 1031, the document profile reading part 1032 and the document profile DB 64, but is different therefrom in that image data of the paper document 60 is extracted from the read image data 61 in which the image data of the paper document 60 once read by the reading part 71 is stored, and is identified by using a character recognition function, such as of OCR, so as to acquire document profiles. The table T100 shown in FIG. 34 also has the same data structure as in the document profile acquisition part 1011-1 shown in FIG. 32.

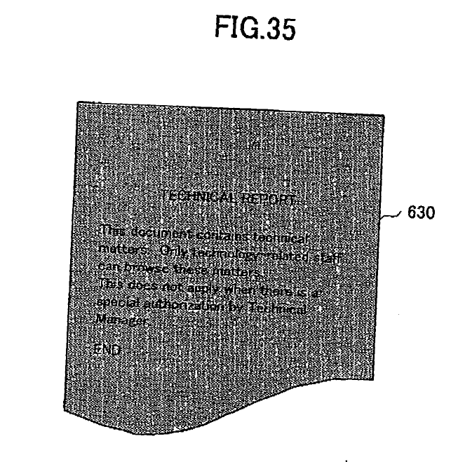

FIG. 35 shows a case where identification information of a document is printed all over a surface of the document. In a document 630 shown in FIG. 3b, a dot pattern indicating identification information is printed all over a surface of the document 630.

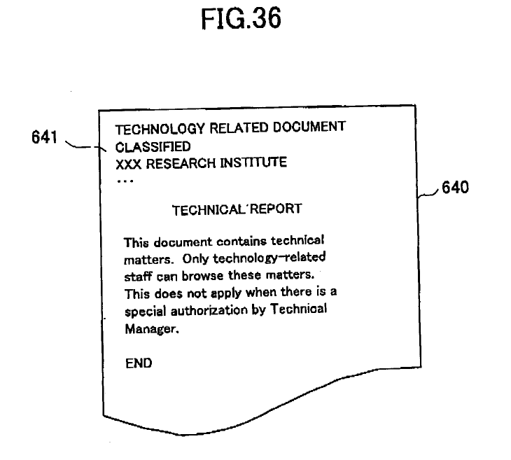

FIG. 36 shows a case where a document profile of a document is printed as a text. In a document 640 shown in FIG. 36, a text 641 of “CLASSIFIED” indicating a security profile, for example, is printed directly at a predetermined position.

In this case, image data obtained by the reading part 71 is subjected to a character recognition by OCR, etc., so as to acquire a document profile printed at the predetermined position.

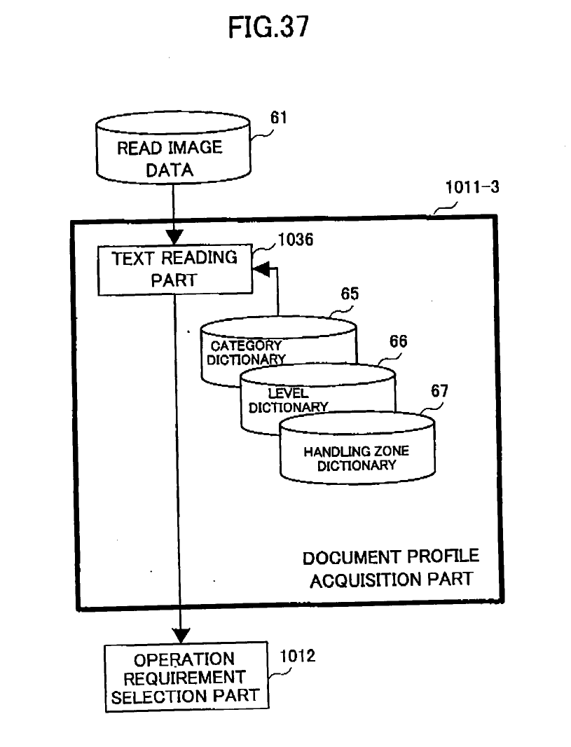

FIG. 37 is a diagram showing a third functional structure of the document profile acquisition part. In FIG. 37, a document profile acquisition part 1011-3 comprises a text reading part 1036, and a database managing a category dictionary 65, a level dictionary 66, and a handling zone dictionary 67. The text reading part 1036 performs a character recognition to the text 641, and acquires the document profile by referring to the category dictionary 65, the level dictionary 66 or The handling zone dictionary 67. Then, text reading part 1036 imparts the document profile to the operation requirement selection part 1012.

Next, a detailed description will be given of the user profile acquisition part 1021.

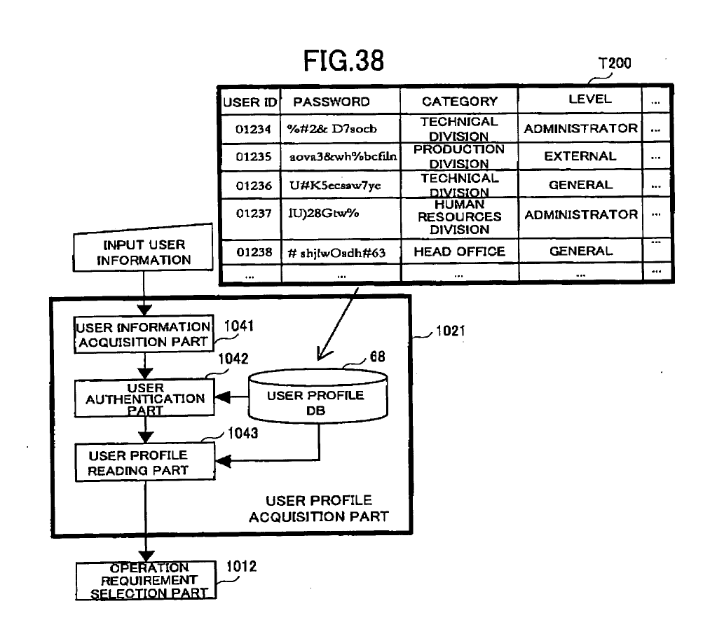

FIG. 38 is a diagram showing a functional structure of the user profile acquisition part 1021. In FIG. 38, the user profile acquisition part 1021 comprises a user information acquisition part 1041, a user authentication part 1042, a user profile reading part 1043, and a user profile DB 68.

The user information acquisition part 1041 acquires user information input from the operation panel 36 by a user, and imparts the user information to the user authentication part 1042.

According to the user information imparted from the user information acquisition part 1041, the user authentication part 1042 performs a user authentication by referring to the user profile DB 68. When the user authentication is successful, the user authentication part 1042 acquires user profiles, and imparts the user profiles to the user profile reading part 1043.

The user profile DB 68 manages user profiles by a table T200. The table T200 includes items of a user ID and a password as user information, and includes items, such as a category and a level, as user profiles.

The user profile reading part 1043 imparts the user profiles to the operation requirement selection part 1012.

Besides, user profiles, as well as document profiles, may be managed by an external server. Using an external server facilitates cooperation with a user using Windows (registered trademark), Lotus Notes and so forth.

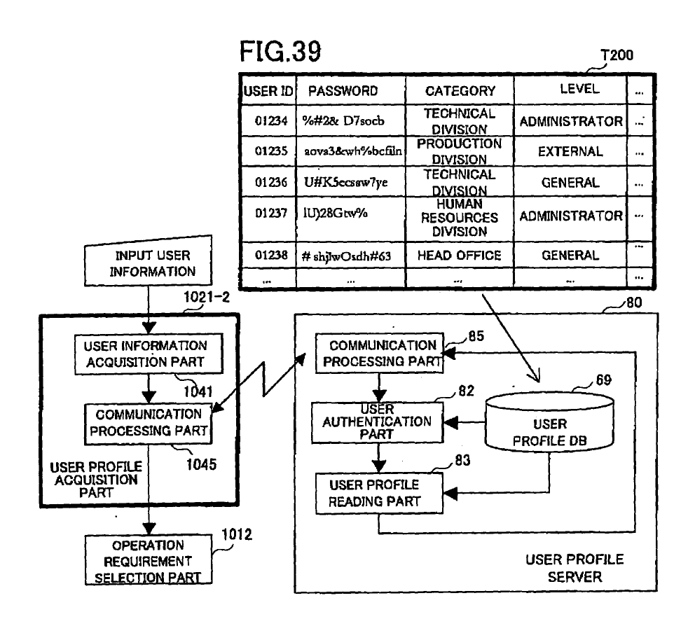

FIG. 39 is a diagram showing a functional structure when user profiles are acquired from an external server.

Parts in FIG. 39 that are identical or equivalent to the parts shown in FIG. 38 are referenced by the same reference marks, and will not be described in detail. In FIG. 39, a user profile acquisition part 1021-2 comprises the user information acquisition part 1041 and a communication processing part 1045.

The communication processing part 1045 transmits the user information to a user profile server 80 as an external server so as to request user profiles. Thereafter, the communication processing part 1045 imparts the user profiles acquired from the user profile server 80 to the operation requirement selection part 1012.

The user profile server 80 as the external server comprises a communication processing part 85, a user authentication part 82, a user profile reading part 83, and a user profile DB 69.

In response to the request from the user profile acquisition part 1021-2, the communication processing part 85 imparts the user information to the user authentication part 82.

According to the user information imparted from the communication processing part 85, the user authentication part 82 performs a user authentication by referring to the user profile DB 69. When the user authentication is successful, the user authentication part 82 acquires the user profiles, and imparts the user profiles to the user profile reading part 83. The user profile reading part 83 imparts the user profiles to the communication processing part 85.

The communication processing part 85 imparts the user profiles to the user profile acquisition part 1021-2.

Hereinbelow, a description will be given of a functional structure for acquiring document profiles from an external server. The external server and the image forming device 1000 or 1000-2 communicate with each other according to SOAP (simple Object Access Protocol).

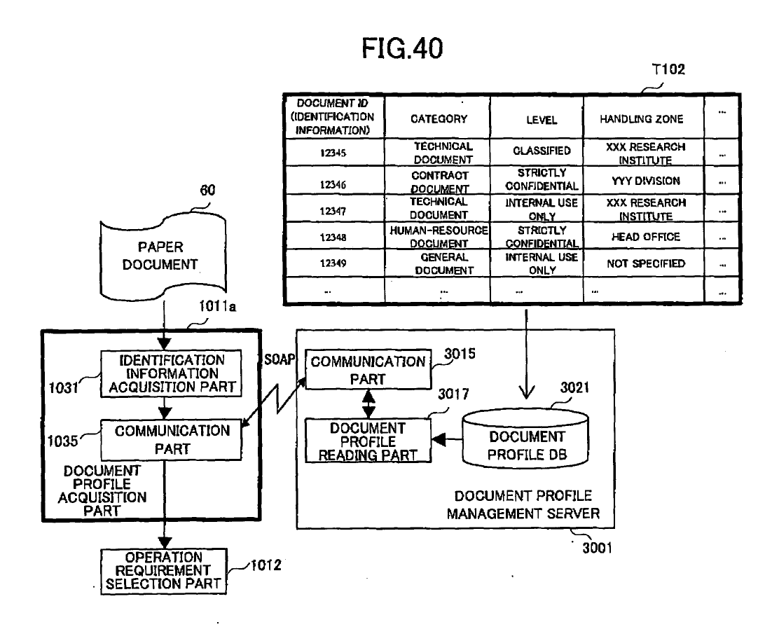

As described above, FIG. 31 shows the case where identification information of a document is printed as a bar code. In the document 610 shown in FIG. 31, identification information is printed as the bar code 611 at the predetermined position. In this case, the document profile acquisition part 1011 acquires the identification information directly from the document 610 as the paper document 60, and acquires document profiles from the identification information, as shown in FIG. 40.

FIG. 40 is a diagram showing a first functional structure for acquiring document profiles from an external server. In FIG. 40, a document profile acquisition part 1011a comprises the identification information acquisition part 1031 and a communication part 1035.

The identification information acquisition part 1031 reads the bar code 611 of the document 610 shown in FIG. 31 from the paper document 60 as identification information, and imparts the identification information to the communication part 1035.

The communication part 1035 transmits the identification information as a document profile request according to the SOAP, for example, to a document profile management server 3001 as an external server, and receives a document profile response according to the SOAP from the document profile management server 3001. Thereafter, the communication part 1035 imparts the document profiles acquired from the document profile management server 3001 to the operation requirement selection part 1012.

The document profile management server 3001 comprises a communication part 3015, a document profile reading part 3017, and a document profile DB 3021.

The communication part 3015 performs a communication control with the document profile acquisition part 1011a according to the SOAP. Upon receiving the document profile request from the document profile acquisition part 1011a, the communication part 3015 imparts the identification information of the document indicated by the document profile request to the document profile reading part 3017. Besides, upon receiving the document profiles from the document profile reading part 3017, the communication part 3015 transmits the document profile response to the document profile acquisition part 1011a.

According to the identification information received from the communication part 3015, the document profile reading part 3017 acquires the document profiles corresponding to the identification information by referring to a table T102 managed by the document profile DB 3021, and imparts the document profiles to the communication part 3015.

The document profile DB 3021 manages document profiles by the table T102. The table T102 includes items, such as a document ID as identification information, a category, a level and a handling zone. The document profile reading part 3017 is able to acquire information, such as the category, the level and the handling zone, as document profiles.

The above-described functional structure is suitable when a dedicated-purpose reading device, such as for a bar code, RFID or MCR, is already used.

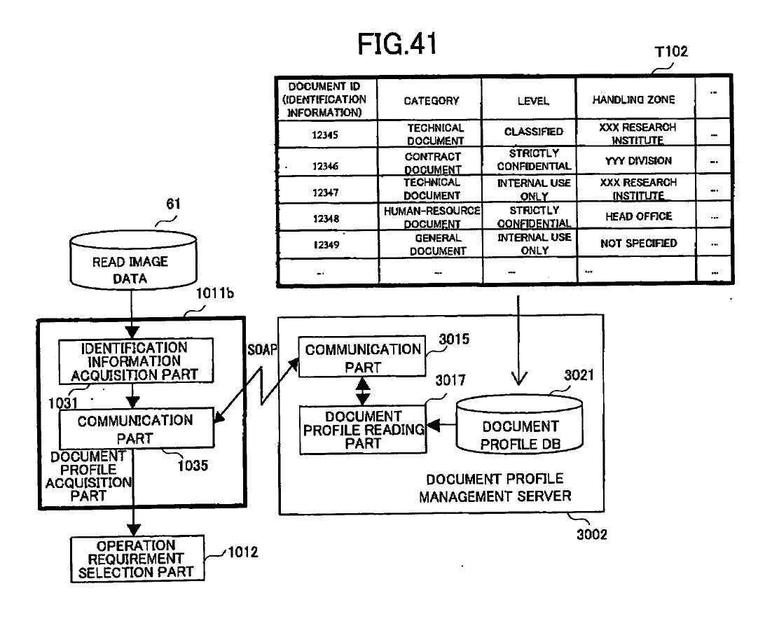

As described above, FIG. 33 shows the case where identification information of a document is printed as a number. In the document 620 shown in FIG. 33, identification information is printed as the number 621 at the predetermined position. In this case, the document profile acquisition part 1011 acquires the identification information from the read image data 61 in which image data of the document 620 as the paper document 60 is stored, and acquires document profiles from the identification information, as shown in FIG. 41.

FIG. 41 is a diagram showing a second functional structure for acquiring document profiles from an external server. Parts in FIG. 41 that are identical or equivalent to the parts shown in FIG. 40 are referenced by the same reference marks, and will not be described in detail. In FIG. 41, a document profile acquisition part 1011b is similar to the document profile acquisition part 111a shown in FIG. 40 in comprising the identification information acquisition part 1031 and the communication part 1035, but is different therefrom in that image data of the paper document 60 is extracted from the read image data 61 in which the image data of the paper document 60 once read by the reading part 71 is stored, and is identified by using a character recognition function, such as of OCR, so as to acquire document profiles. A document profile management server 3002 as an external server has the same functional structure as the document profile management server 3001 shown in FIG. 40.

As described above, FIG. 35 shows the case where identification information of a document is printed all over a surface of the document. In the document 630 shown in FIG. 35, the dot pattern indicating identification information is printed all over the surface of the document 630.

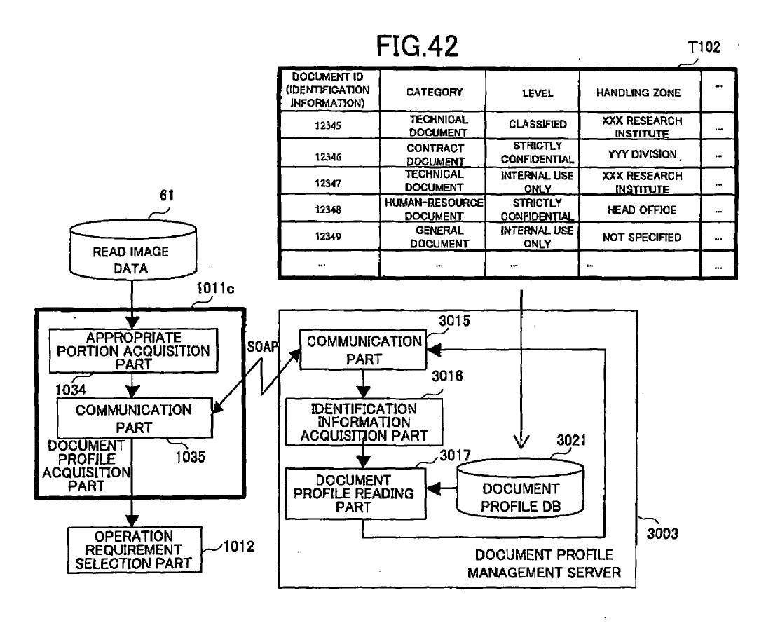

FIG. 42 is a diagram showing a third functional structure for acquiring document profiles from an external server. Parts in FIG. 42 that are identical or equivalent to the parts shown in FIG. 40 are referenced by the same reference marks, and will not be described in detail. In FIG. 42, a document profile acquisition part 1011c comprises an appropriate portion acquisition part 1034 and the communication part 1035.

The appropriate portion acquisition part 1034 extracts image data of the paper document 60 from the read image data 61 in which the image data of the paper document 60 once read by the reading part 71 is stored, and acquires an appropriate portion, such as a portion or all of the image data, and imparts the appropriate portion to the communication part 1035.

The communication part 1035 transmits a document profile acquisition request to a document profile management server 3003 as an external server according to the SOAP, and thereby receives a document profile response according to the SOAP from the document profile management server 3003. The document profile acquisition request specifies data of the appropriate portion.

The document profile management server 3003 comprises the communication part 3015, an identification information acquisition part 3016, the document profile reading part 3017, and the document profile DB 3021.

Upon acquiring the data of the appropriate portion from the communication part 3015, the identification information acquisition part 3016 acquires identification information from the data of the appropriate portion, and imparts the identification information to the document profile reading part 3017.

The document profile reading part 3017 acquires the document profiles corresponding to the identification information by referring to the table T102 managed by the document profile DB 3021, and imparts the document profiles to the document profile acquisition part 1011c via the communication part 3015.

As mentioned above, by using the document profile management server, document profiles can be acquired from identification information added to the paper document 60, and can be used in the image forming device 1000 or 1000-2 having at least one of various image functions, such as of the reading device and the copying device.

Next, a description will be given of cases of printing identification information on a document. In the following cases, either a bar code, a number, a text or a dot pattern is printed, all of which is possible.

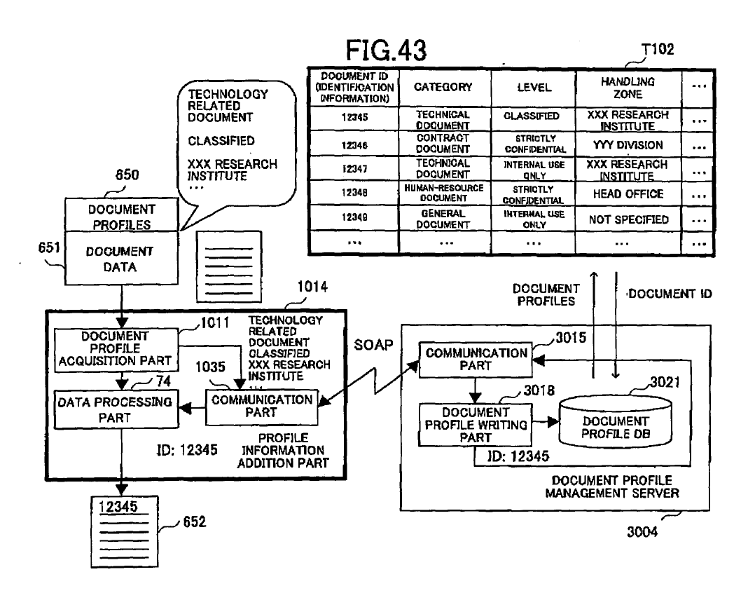

FIG. 43 is a diagram showing a fourth functional structure for acquiring identification information from an external server. A profile information addition part 1014 shown in FIG. 43 is included in the image forming device 1000 or 1000-2. The profile information addition part 1014 comprises the document profile acquisition part 1011, the data processing part 74, and the communication part 1035.

In this case, upon inputting document data 651 on which document profiles 650 indicating “TECHNOLOGY RELATED DOCUMENT”, “CLASSIFIED” and “XXX RESEARCH INSTITUTE” are added at a predetermined position, the document profile acquisition part 1011 acquires the document profiles 650, and imparts the document profiles 650 to the data processing part 74 and the communication part 1035.

The communication part 1035 transmits an identification information acquisition request specifying the document profiles 650 indicating “TECHNOLOGY RELATED DOCUMENT”, “CLASSIFIED” and “XXX RESEARCH INSTITUTE” to a document profile management server 3004 as an external server according to the SOAP. Thereafter, upon receiving an identification information response according to the SOAP from the document profile management server 3004, the communication part 1035 imparts a document ID “12345”, for example, as the identification information to the data processing part 74.

The data processing part 74 outputs processed data 652 subjected to a data processing based on the document data 651 so that the document ID “12345” is printed as the identification information at a predetermined position.

The document profile management server 3004 comprises the communication part 3015, a document profile writing part 3018, and the document profile DB 3021.

The communication part 3015 imparts the document profiles received from the profile information addition part 1014 to the document profile writing part 3018. The document profile writing part 3018 writes the document profiles in the table T102 managed by the document profile DB 3021, and acquires the document ID as the identification information. The document ID is unique for each document, and is transmitted to the profile information addition part 1014 by the communication part 3015.

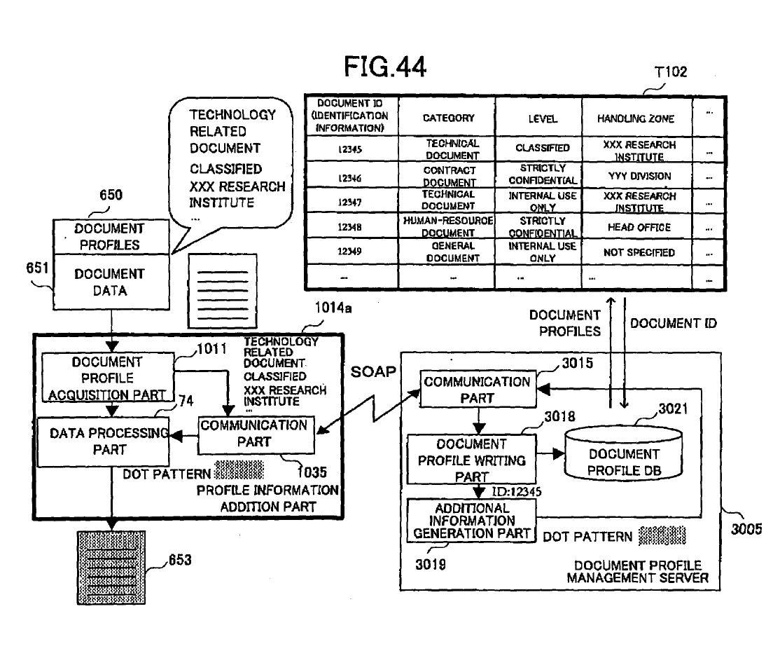

FIG. 44 is a diagram showing a fifth functional structure for acquiring identification information from an external server. Parts in FIG. 44 that are identical or equivalent to the parts shown in FIG. 43 are referenced by the same reference marks, and will not be described in detail. In FIG. 44, a profile information addition part 1014a is similar to the profile information addition part 1014 shown in FIG. 43 in comprising the document profile acquisition part 1011, the data processing part 74 and the communication part 1035, but is different therefrom in that the communication part 1035 receives a dot pattern from a document profile management server 3005 as an external server, and that the data processing part 74 outputs processed data 653 generated based on the document data 651 so that the dot pattern is printed.

The document profile management server 3005 comprises the communication part 3015, the document profile writing part 3018, an additional information generation part 3019, and the document profile DS 3021.

Upon receiving the identification information acquisition request specifying the document profiles 650 from the profile information addition part 1014a according to the SOAP, the communication part 3015 imparts the document profiles to the document profile writing part 3018.

The document profile writing part 3018 writes the document profiles in the table T102, and thereby acquires the document ID uniquely identifying the document, as described with reference to FIG. 43, and imparts the document ID to the additional information generation part 3019.

The additional information generation part 3019 generates a unique dot pattern, for example, according to the document ID. For example, when the document ID is “12345”, the additional information generation part 3019 generates the dot pattern corresponding uniquely to the document ID is “12345”. The additional information generation part 3019 transmits the generated dot pattern to the profile information addition part 1014a via the communication part 3015.

As described above, in the document profile management server 3005, a pattern to be printed on a document is generated according to the document ID acquired from the table T102. In a case of printing a bar code on a document, the additional information generation part 3019 generates the bar code according to the document ID. In cases of printing a number, a text and so forth on a document, the document profile writing part 3018 may transmit the document ID per se to the profile information addition part 1014 via the communication part 3015.

The processed data 653, being processed so that the dot pattern as identification information generated by the additional information generation part 3019 is printed, is generated according to a data format used in subsequent processing. For example, generating the processed data 653 as image data, such as a bitmap, or generating the processed data 653 as a device context according to a printer makes the processed data 653 printable. Alternatively, when an image synthesis is performable by a printer driver, generating the processed data 653 as data for the image synthesis makes the processed data 653 printable.

Further, a description will be given of an external server managing document profiles for various image forming devices providing various image forming functions, such as printing, reading, and copying.

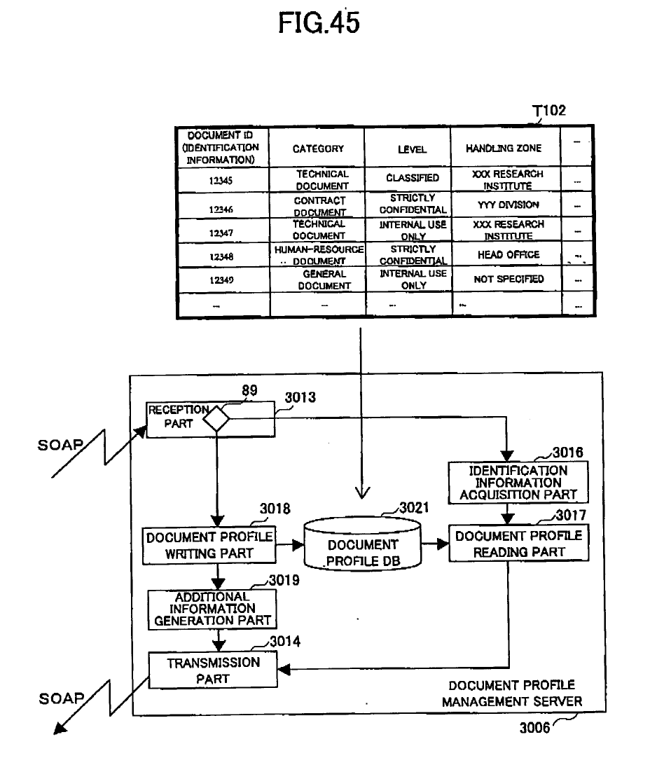

FIG. 45 is a diagram showing a sixth functional structure for acquiring document profiles or identification information from an external server. Parts in FIG. 45 that are identical or equivalent to the parts shown in FIG. 40 to FIG. 44 are referenced by the same reference marks, and will not be described in detail.

In FIG. 45, a document profile management server 3006 comprises a reception part 3013, a transmission part 3014, the identification information acquisition part 3016, the document profile reading part 3017, the document profile writing part 3018, the additional information generation part 3019, and the document profile DB 3021. The reception part 3013 and the transmission part 3014 correspond to the communication part 3015 shown in FIG. 40 to FIG. 44.

The reception part 3013 includes a judgment part 89 judging whether a request received from outside via a network according to the SOAP requests document profiles or requests identification information. According to a result of the judgment by the judgment part 89, when the request requests document profiles, the reception part 3013 imparts the request to the identification information acquisition part 3016. On the other hand, when the request requests identification information, the reception part 3013 imparts the request to the document profile writing part 3018.

The identification information acquisition part 3016 acquires identification information specified in the request, and imparts the identification information to the document profile reading part 3017.

The document profile reading part 3017 acquires document profiles corresponding to the identification information by referring to the table T102 managed by the document profile DB 3021, and imparts the document profiles to the transmission part 3014.

On the other hand, the document profile writing part 3018 writes document profiles in the table T102 managed by the document profile DB 3021, acquires identification information, and imparts the identification information to the additional information generation part 3019. The additional information generation part 3019 generates predetermined data according to the identification information, and imparts the generated predetermined data to the transmission part 3014. The predetermined data is, for example, a dot pattern, a bar code, a two-dimensional code, and so forth.

Thus, the processed data 652 or 653 is generated so that the predetermined data is printed for the document data 651 having the document profiles 650 added; therefore, a paper document or document data printed or copied electronically according to the processed data 652 or 653 has identification information on itself thereafter, thereby being controlled according to the security policy.

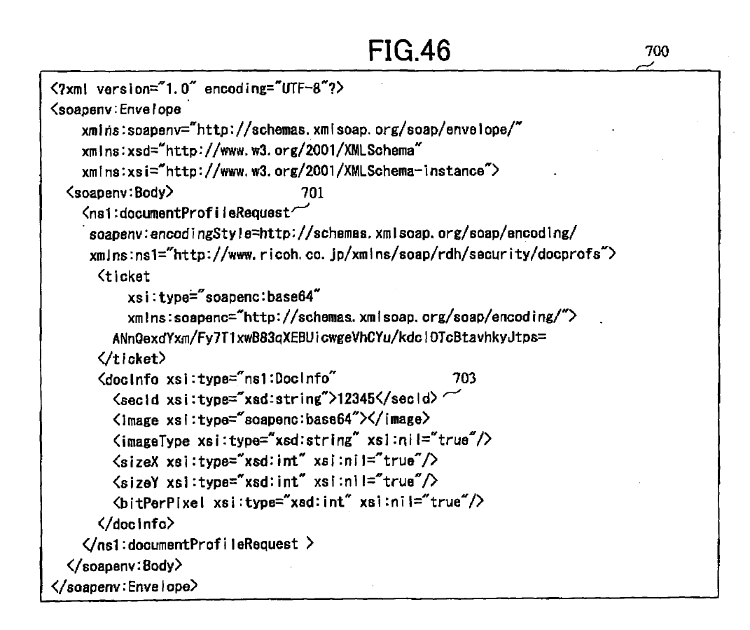

FIG. 46 shows an example of XML data representing a document profile request using identification information of a document which is transmitted according to the SOAP. In XML data 700 shown in FIG. 46, a description 701 reading <ns1:documentProfileRequest . . . > indicates a document profile request. Besides, a description 703 reading <secId xsi:type=“xsd:string”>12345</secId> specifies identification information of a document. That is, this document profile request requests a document profile corresponding to this identification information.

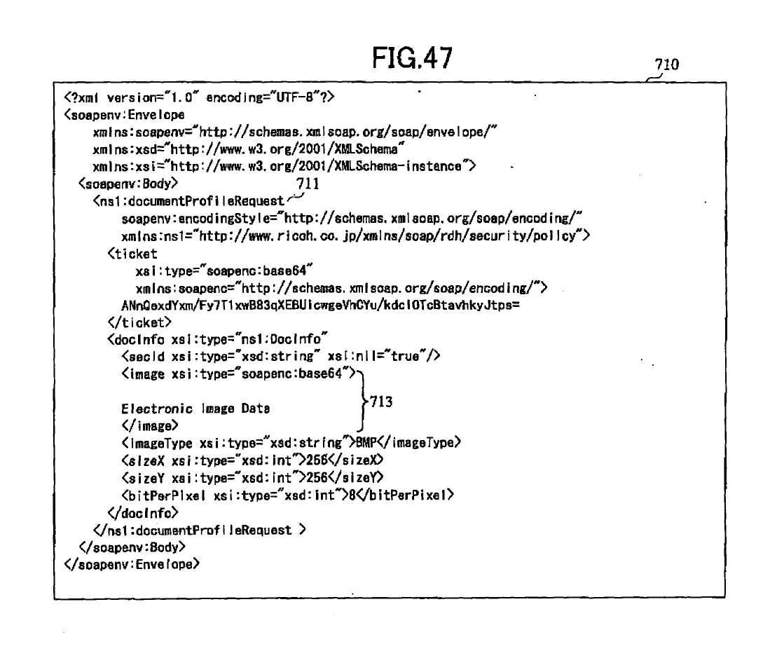

FIG. 47 shows an example of XML data representing a document profile request using electronic image data which is transmitted according to the SOAP. In XML data 710 shown in FIG. 47, a description 711 reading <ns1:documentProfileRequest . . . > indicates a document profile request. Besides, a description 713 reading <image xsi:type=“soapenc:base64”>Electronic Image Data</image> sets electronic image data indicating identification information of a document. That is, this document profile request requests a document profile corresponding to the identification information indicated by this electronic image data.

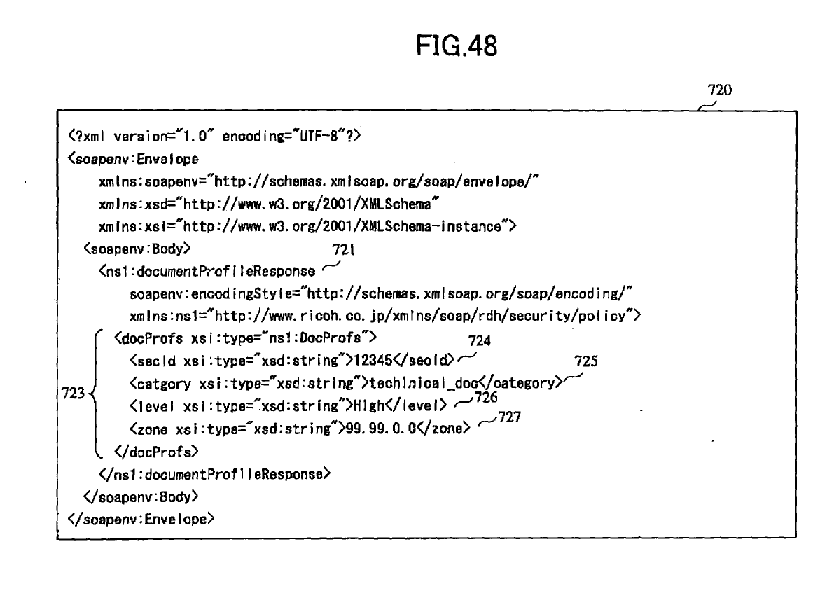

FIG. 48 shows an example of XML data representing a document profile response transmitted according to the SOAP. In XML data 720 shown in FIG. 48, a description 721 reading <ns1:documentProfileResponse . . . > indicates a document profile response. Besides, a description 723 from <docProfs xsi:type=“ns1:DocProfs”>to </docProfs> indicates document profiles. In this case, as the document profiles, a description 724 reading <secId xsi:type=“xsd:string”>12345</secId> indicates a document ID of “12345”, a description 725 reading <catgory xsi:type-“xsd:string”> technical_doc</category> indicates a document category of “technical_doc (Technology Related Document)”, a description 726 reading <level xsi:type=“xsd:string”>High</level> indicates a document level of “high (high level)”, and a description 727 reading <zone xsi:type=“xsd:string”>99.99.0.0</zone> indicates a zone of “99.99.0.0”.

As described above, since embedded information is at least one among bar code information, watermark information and design information which identifies a document uniquely, document contents and document profiles can be identified by using the embedded information, and processes regarding the document are performed accordingly; thus, security of the document can be ensured.

The image forming device according to the embodiment of the present invention is a device having at least one of various image forming functions, such as of a printer, a facsimile, and a copier.

According to the present invention, regardless of whether a document is a paper document or electronic data (document data), a control according to a security policy can be performed based on identification information or a document profile indicated in the document.

Besides, the image forming device 1000 or 1000-2 is arranged to acquire document profiles corresponding to identification information from a document profile management server as an external server; therefore, the image forming device according to the present invention does not need to manage all document profiles regarding identification information. Similarly, since the image forming device is arranged to acquire identification information corresponding to document profiles from a document profile management server as an external server, the image forming device according to the present invention does not need to generate identification information from document profiles.

Besides, thus providing the document profile management server as an external server enables a unified management of identification information and document profiles for a plurality of image forming devices.

Hereinbelow, a description will be given of a method for setting a policy from outside to the image forming device 1000 or 1000-2. For example, the DSP 2000 shown in FIG. 14 to FIG. 22 is distributed as the policy. The DSP 2000 is distributed as the policy from an external server to the image forming device 1000 or 1000-2 by a communication according to the SOAP (Simple Object Access Protocol).

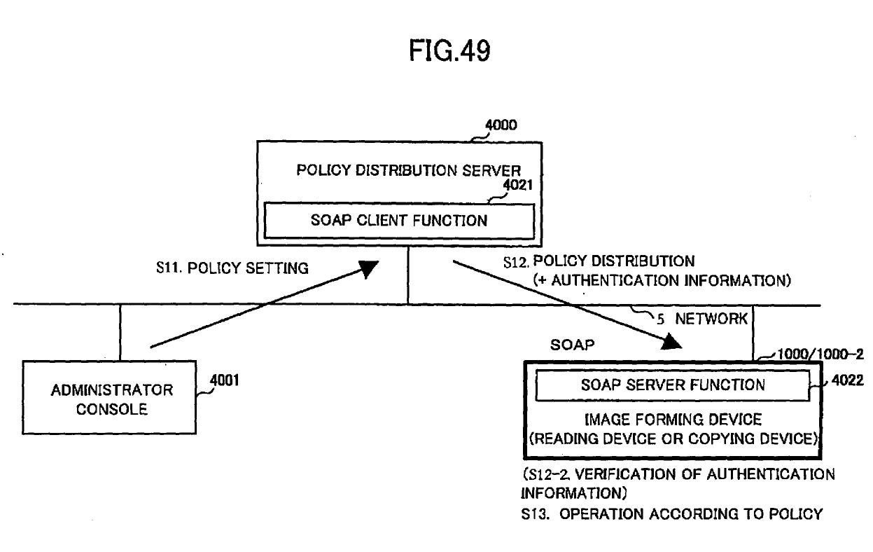

The image forming device 1000 or 1000-2 shown in FIG. 49 to FIG. 62 is not limited to an image forming device as a reading device or a copying device, but may be an image forming device having a reading function and a copy function, or further enabling various image forming processes (such as of a scanner, a copier, a facsimile and a printer).

First, a description will be given, with reference to FIG. 49, of a first policy setting method in which the image forming device 1000 or 1000-2 receives a policy sent unilaterally.

FIG. 49 is a diagram showing the first policy setting method in which a policy is distributed from an external server. In FIG. 49, an administrator console 4001 used by an administrator who intends to set the policy, a policy distribution server 4000 distributing the policy as the external server, and the image forming device 1000 or 1000-2 are connected via a network 5. The policy distribution server 4000 is a server computer, and includes an SOAP client function 4021. The image forming device 1000 includes an SOAP server function 4022. Herein, the image forming device 1000 or 1000-2 is represented by the image forming device 1000.

In the first policy setting method shown in FIG. 49, the administrator transmits the DSP 2000 as the policy from the administrator console 4001 to the policy distribution server 4000 (step S11). Then, the policy distribution server 4000 distributes the DSP 2000 as the policy by using the SOAP client function 4021 (step S12), and the image forming device 1000 receives the DSP 2000 as the policy by the SOAP server function 4022, and returns a result of the reception.

Then, the image forming device 1000 selects an operation requirement according to the distributed DSP 2000, and operates so that the operation requirement is satisfied (step S13).

In the above-described configuration, the image forming device 1000 can avoid a reception of an incorrect policy, a setting of a malicious policy and so forth by confirming whether or not the policy distribution server 4000 that transmits the policy can be trusted. Specifically, when the policy distribution server 4000 distributes the policy, the following operation is performed.

In the above-mentioned step S12, the policy distribution server 4000 transmits its own authentication information and the DSP 2000 as the policy to the image forming device 1000.

Then, the image forming device 1000 verifies the transmitted authentication information of the policy distribution server 4000 (step S12-2).

Then, when the authentication information of the policy distribution server 4000 is confirmed to be correct, the image forming device 1000 regards the DSP 2000 transmitted as the policy to be authentic, and selects an operation requirement according to the distributed DSP 2000, and operates so that the operation requirement is satisfied (step S13).

By thus authenticating the policy distribution server 4000, the image forming device 1000 can avoid a reception of an incorrect policy, a setting of a malicious policy and so forth.

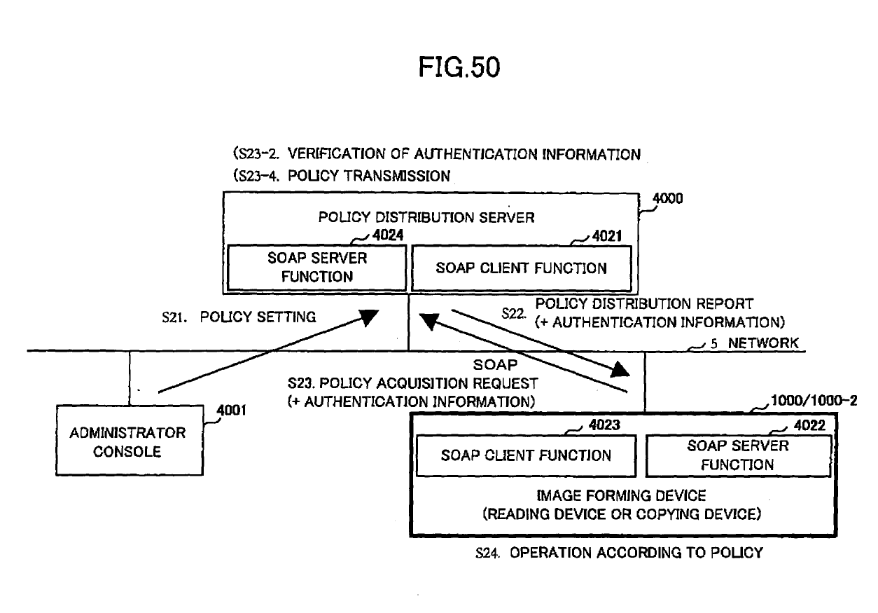

Next, a description will be given, with reference to FIG. 50, of a second policy setting method in which the image forming device 1000 or 1000-2 receives a report of distribution of a policy, and accesses the policy distribution server 4000 to acquire the policy.

FIG. 50 is a diagram showing the second policy setting method in which a policy is acquired from an external server. In FIG. 50, the administrator console 4001, the policy distribution server 4000, and the image forming device 1000 or 1000-2 are connected via the network 5, as in FIG. 49. The policy distribution server 4000 includes the SOAP client function 4021 and an SOAP server function 4024. The image forming device 1000 includes the SOAP server function 4022 and an SOAP client function 4023. Herein, the image forming device 1000 or 1000-2 is represented by the image forming device 1000.

In the second policy setting method shown in FIG. 50, the administrator transmits the DSP 2000 as the policy from the administrator console 4001 to the policy distribution server 4000 (step 521). Then, the policy distribution server 4000 provides a report of the DSP 2000 distributed as the policy, by using the SOAP client function 4021 (step S22), and the image forming device 1000 receives the report of the distribution by the SOAP server function 4022, and returns a result of the reception.

Thereafter, when the image forming device 1000 transmits a policy acquisition request by using the SOAP client function 4023, the policy distribution server 4000 receives the policy acquisition request by the SOAP server function 4024, and transmits the policy (the DSP 2000 received from the administrator console 4001) as a result of the reception (step S23).

Then, the image forming device 1000 selects an operation requirement according to the distributed DSP 2000, and operates so that the operation requirement is satisfied (step S24).

In step S22, the policy distribution server 4000 may perform the report of the distribution of the policy by transmitting identification information identifying the DSP 2000 to the image forming device 1000. In this case, in step S23, the image forming device 1000 may perform the policy acquisition request by transmitting the identification information received from the policy distribution server 4000.

Further, in this case, a leakage of information (i.e., the policy) can be prevented by confirming whether or not the image forming device 1000 that receives the policy can be trusted. Specifically, when the image forming device 1000 acquires the policy from the policy distribution server 4000, the following operation is performed.

First, in the above-mentioned step S23, the image forming device 1000 adds its own authentication information to the policy acquisition request, and transmits the policy acquisition request to the policy distribution server 4000.

Next, the policy distribution server 4000 verifies the authentication information received from the image forming device 1000 (step S23-2). Then, when the policy distribution server 4000 confirms that the authentication information of the image forming device 1000 is correct, the policy distribution server 4000 transmits the DSP 2000 as the policy to the image forming device 1000 (step S23-4).

By thus authenticating the image forming device 1000, the policy distribution server 4000 can avoid a leakage of information (i.e., the policy).

The second policy setting method is effective in that the image forming device 1000 can acquire a policy when necessary, in a case where the image forming device 1000 runs short of storage area if successively receiving comparatively large-size policies.

In this second policy setting method, the image forming device 1000 may perform the policy acquisition request immediately in response to the report of the distribution; alternatively, the image forming device 1000 may store the reception of the report of the distribution inside the device, and may perform the policy acquisition request at a predetermined timing.

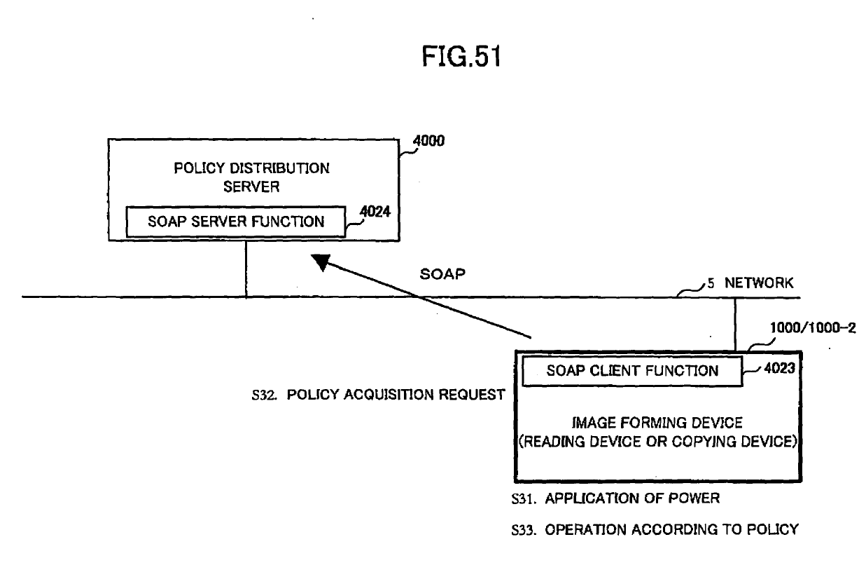

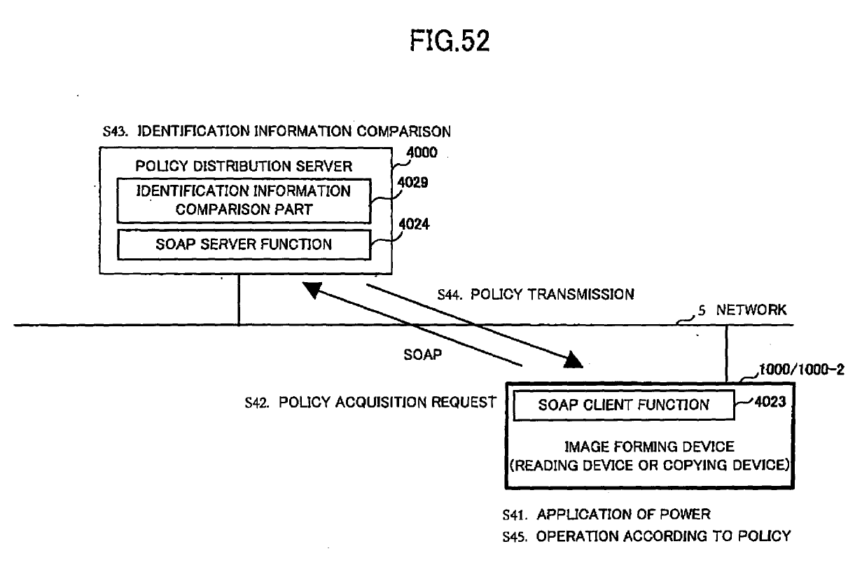

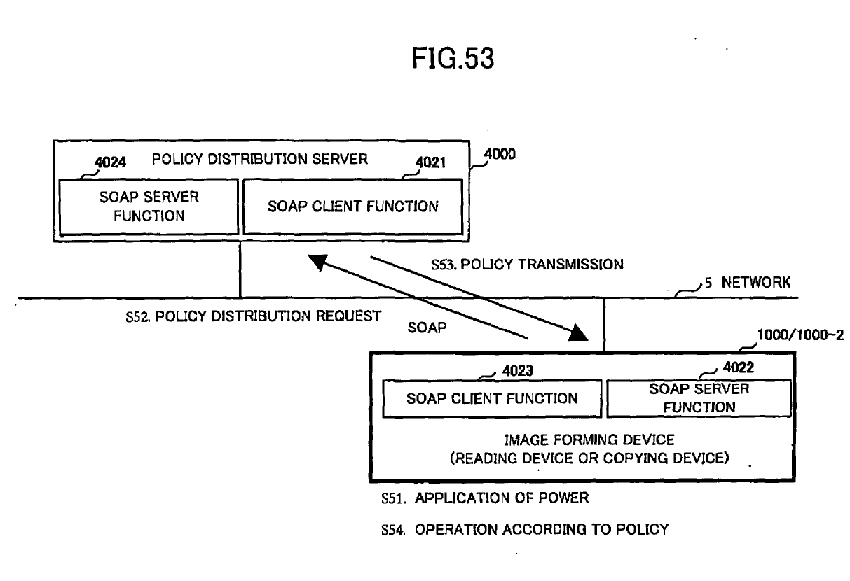

Next, a description will be given, with reference to FIG. 51, FIG. 52 and FIG. 53, of variations of policy setting methods in which the policy acquisition request is performed at a predetermined timing.

FIG. 51 is a diagram showing a third policy setting method as a first variation in which a policy is acquired upon application of power. Herein, the image forming device 1000 or 1000-2 is represented by the image forming device 1000. The third policy setting method shown in FIG. 51 is used for a case where the image forming device 1000 does not have a security policy yet as when the image forming device 1000 first connects to the network 5.

In FIG. 51, when power is applied to the image forming device 1000 (step S31), the image forming device 1000 performs a policy acquisition request to the policy distribution server 4000 via the network 5 by using the SOAP client function 4023 (step S32). The policy distribution server 4000 receives the policy acquisition request by using the SOAP server function 4024, and transmits a policy (the DSP 2000 received from the administrator console 4001) as a result of the reception.

Upon receiving the policy from the policy distribution server 4000, the image forming device 1000 operates so that an operation requirement according to the distributed DSP 2000 is satisfied (step S33).

FIG. 52 is a diagram showing a fourth policy setting method as a second variation in which a policy is acquired upon application of power. Parts in FIG. 52 that are identical or equivalent to the parts shown in FIG. 51 are referenced by the same reference marks, and will not be described in detail. Herein, the image forming device 1000 or 1000-2 is represented by the image forming device 1000. In FIG. 52, the policy distribution server 4000 further includes an identification information comparison part 4029.

When power is applied to the image forming device 1000 (step S41), the image forming device 1000 performs a policy acquisition request to the policy distribution server 4000 via the network 5 by using the SOAP client function 4023, and simultaneously transmits identification information of the present DSP 2000 (for example, “RDSP2023” contained in the description 211 shown in FIG. 23) (step S42).

When upon receiving the policy acquisition request by using the SOAP server function 4024, the policy distribution server 4000 compares the received identification information (e.g., “RDSP2023”) with identification information of a policy to be distributed by using the identification information comparison part 4029 (step S43). When the received identification information (e.g., “RDSP2023”) and the identification information of the policy to be distributed are identical, the policy distribution server 4000 transmits only a result of the reception which indicates that the received identification information (e.g., “RDSP2023”) and the identification information of the policy to be distributed are identical. When the received identification information (e.g., “RDSP2023”) and the identification information of the policy to be distributed are not identical, the policy distribution server 4000 transmits the policy (the DSP 2000 received from the administrator console 4001) as a result of the reception to the image forming device 1000 (step S44).

Upon receiving the policy from the policy distribution server 4000, the image forming device 1000 rewrites the present policy with the received policy, selects an operation requirement according to the policy, and operates so that the operation requirement is satisfied (step 545).

In this second variation, since a policy is not distributed when identification information is identical, unnecessary traffic can be reduced.

FIG. 53 is a diagram showing a fifth policy setting method as a third variation in which a policy is acquired upon application of power. Parts in FIG. 53 that are identical or equivalent to the parts shown in FIG. 51 are referenced by the same reference marks, and will not be described in detail. Herein, the image forming device 1000 or 1000-2 is represented by the image forming device 1000.

When power is applied to the image forming device 1000 (step S51), the image forming device 1000 performs a policy distribution request to the policy distribution server 4000 via the network 5 by using the SOAP client function 4023 (step S52). Upon receiving the policy distribution request by using the SOAP server function 4024, the policy distribution server 4000 transmits a result of the reception to the image forming device 1000.

Thereafter, the policy distribution server 4000 transmits a policy by the SOAP client function 4021, and the image forming device 1000 receives the policy, and returns a result of the reception to the policy distribution server 4000 (step S53).

Upon receiving the policy from the policy distribution server 4000, the image forming device 1000 selects an operation requirement according to the policy, and operates so that the operation requirement is satisfied (step S54).

In this fifth policy setting method, the policy distribution server 4000 may distribute the policy immediately after receiving the policy distribution request from the image forming device 1000; alternatively, the policy distribution server 4000 may store the reception of the policy distribution request inside the policy distribution server 4000, and may distribute the policy at a predetermined timing.

Besides, in this fifth policy setting method, the policy distribution server 4000 may be arranged to include the identification information comparison part 4029, as in the fourth policy setting method shown in FIG. 52. This arrangement enables a reduction of unnecessary traffic.

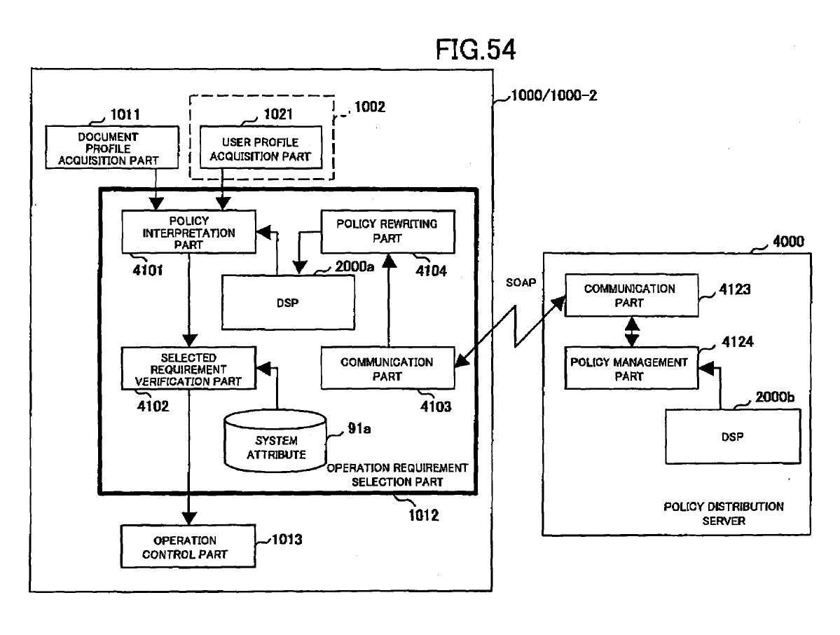

Next, a description will be given, with reference to FIG. 54, of a functional structure for realizing the first to fifth policy setting methods described with reference to FIG. 49 to FIG. 53. FIG. 54 is a diagram showing an example of the functional structure for realizing the first to fifth policy setting methods. Herein, the image forming device 1000 or 1000-2 is represented by the image forming device 1000, because the image forming device 1000 and the image forming device 1000-2 have the same operation requirement selection part 1012. Besides, the portion indicated by the dashed line 1002 may be omitted.

In FIG. 54, the operation requirement selection part 1012 of the image forming device 1000 includes a policy interpretation part 4101, a selected requirement verification part 4102, a communication part 4103, a policy rewriting part 4104, a DSP 2000a, and a system attribute 91a.

The policy interpretation part 4101 interprets a policy regarding a document profile acquired by the document profile acquisition part 1011 and a user profile acquired by the user profile acquisition part 1021 according to the DSP 2000a. Then, the policy interpretation part 4101 imparts an operation requirement to the selected requirement verification part 4102 as a result of the interpretation. That is, the operation requirement that must be satisfied upon performing an operation specified by a user is imparted.

The selected requirement verification part 4102 judges whether or not the operation requirement imparted from the policy interpretation part 4101 can be satisfied by referring to the system attribute 91a. Then, the selected requirement verification part 4102 imparts a result of the judgment to the operation control part 1013.

The communication part 4103 is a processing part controlling a communication with the policy distribution server 4000 according to the SOAP, and includes at least one of the SOAP server function 4022 and the SOAP client function 4023 shown in FIG. 49 to FIG. 53. Upon receiving a DSP 2000b as a policy from the policy distribution server 4000, the communication part 4103 imparts the DSP 2000b to the policy rewriting part 4104. Besides, when performing a policy acquisition request to the policy distribution server 4000 as shown in FIG. 50, the communication part 4103 simultaneously transmits the authentication information for authenticating the image forming device 1000.

The policy rewriting part 4104 rewrites the DSP 2000a with the received DSP 2000b. Besides, when the authentication information for authenticating the policy distribution server 4000 is distributed simultaneously with the DSP 2000b as shown in FIG. 49, the policy rewriting part 4104 authenticates the policy distribution server 4000 according to the authentication information; then, only when the policy distribution server 4000 is authenticated, the policy rewriting part 4104 rewrites the DSP 2000a with the received DSP 2000b.

The policy distribution server 4000 includes a communication part 4123, a policy management part 4124 and the DSP 2000b.

The communication part 4123 is a processing part controlling a communication with the image forming device 1000 according to the SOAP, and includes at least one of the SOAP client function 4021 and the SOAP server function 4024 shown in FIG. 49 to FIG. 53. The communication part 4123 distributes the DSP 2000b.

The policy management part 4124 manages the DSP 2000b to be distributed. Upon the communication part 4123 distributing the DSP 2000b, the policy management part 4124 causes the communication part 4123 to simultaneously transmit the authentication information for authenticating the policy distribution server 4000, as shown in FIG. 49. Besides, when the authentication information for authenticating the image forming device 1000 is transmitted simultaneously with the policy acquisition request, the policy management part 4124 authenticates the image forming device 1000 according to the authentication information; then, only when the image forming device 1000 is authenticated, the policy management part 4124 causes the communication part 4123 to transmit the DSP 2000b as the policy.

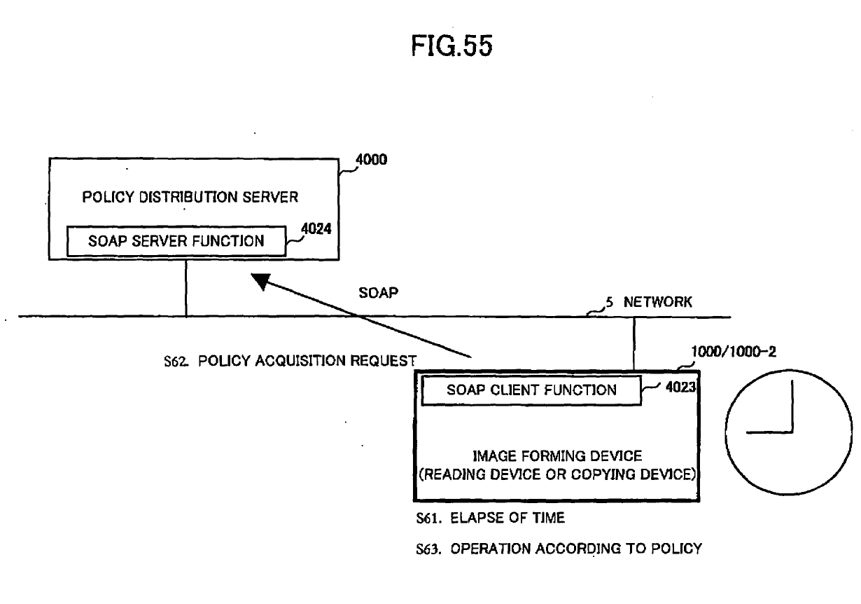

Next, a description will be given, with reference to FIG. 55, of a sixth policy setting method in which a policy is acquired according to a timer.

FIG. 55 is a diagram showing the sixth policy setting method in which a policy is acquired according to a timer. Parts in FIG. 55 that are identical or equivalent to the parts shown in FIG. 51 are referenced by the same reference marks, and will not be described in detail. Herein, the image forming device 1000 or 1000-2 is represented by the image forming device 1000.

In FIG. 55, when a processing time managed by a timer elapses (step S61), the image forming device 1000 transmits a policy acquisition request to the policy distribution server 4000 by using the SOAP client function 4023, and the policy distribution server 4000 transmits a policy (the DSP 2000 received from the administrator console 4001) as a result of the reception by the SOAP server function 4024 (step S62).

Upon receiving the policy from the policy distribution server 4000, the image forming device 1000 selects an operation requirement according to the policy, and operates so that the operation requirement is satisfied (step S63).

In this sixth policy setting method, the policy distribution server 4000 may include the SOAP client function 4021 and the SOAP server function 4024, and the image forming device 1000 may include the SOAP server function 4022 and the SOAP client function 4023 so that the policy distribution server 4000 may distribute the policy after the image forming device 1000 performs the policy acquisition request.

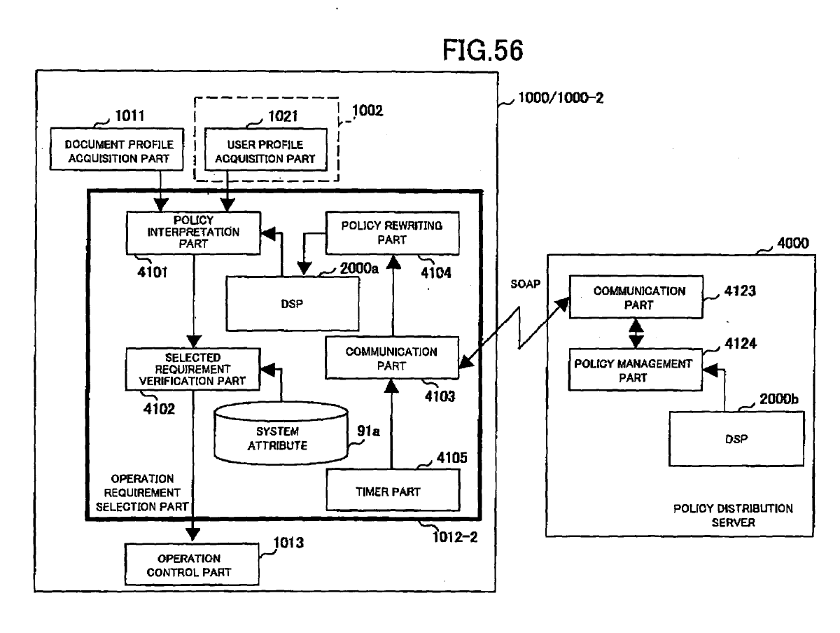

Next, a description will be given, with reference to FIG. 56, of a functional structure for realizing the sixth policy setting method described with reference to FIG. 55. FIG. 56 is a diagram showing an example of the functional structure for realizing the sixth policy setting method. Parts in FIG. 56 that are identical or equivalent to the parts shown in FIG. 54 are referenced by the same reference marks, and will not be described in detail. Herein, the image forming device 1000 or 1000-2 is represented by the image forming device 1000, because the image forming device 1000 and the image forming device 1000-2 have an identical operation requirement selection part 1012-2. Besides, the portion indicated by the dashed line 1002 may be omitted.

The operation requirement selection part 1012-2 shown in FIG. 56 differs from differs from the operation requirement selection part 1012 shown in FIG. 54 in further including a timer part 4105.

When a predetermined time elapses, the timer part 4105 notifies the communication part 4103 that the predetermined time has elapsed. According to this notification, the communication part 4103 acquires the DSP 2000b from the policy distribution server 4000 according to the SOAP, and the policy rewriting part 4104 rewrites the DSP 2000a with the DSP 2000b.

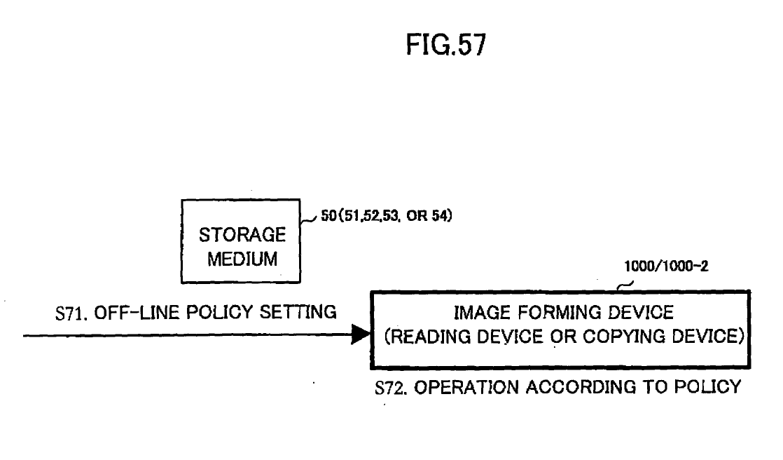

Next, a description will be given, with reference to FIG. 57, of a seventh policy setting method for setting a policy off-line. FIG. 57 is a diagram showing the seventh policy setting method for setting a policy off-line. Parts in FIG. 57 that are identical or equivalent to the parts shown in FIG. 49 are referenced by the same reference marks, and will not be described in detail. Herein, the image forming device 1000 or 1000-2 is represented by the image forming device 1000.

In FIG. 57, a policy is set off-line by storing the DSP 2000 in a storage medium 50, such as the hard disk 51, the magneto-optical disc 52, the flexible disk 53 or the optical disc 54, as shown in FIG. 26, setting the storage medium 50 to the image forming device 1000, and storing the DSP 2000 in a predetermined storage area in the image forming device 1000 (step S71).

Thereafter, the image forming device 1000 operates according to the DSP 2000 stored as the policy in the predetermined storage area (step S72).

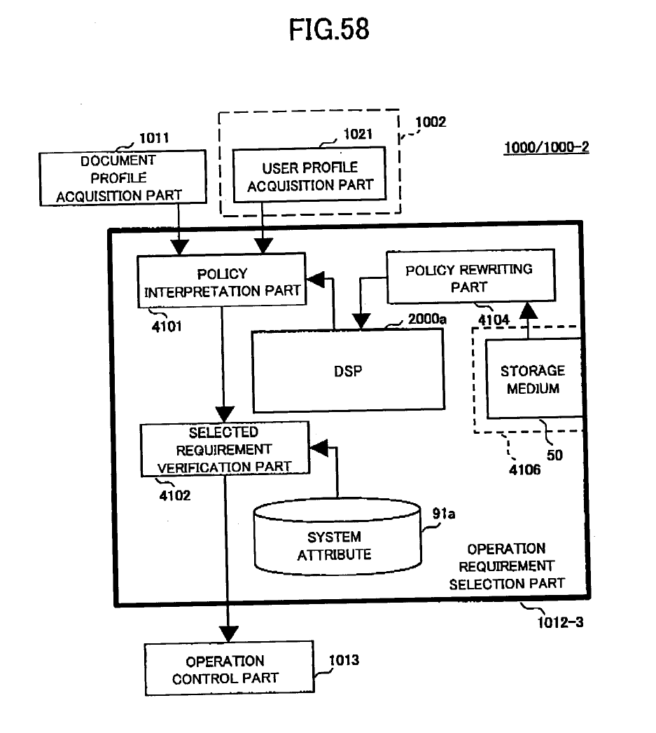

Next, a description will be given, with reference to FIG. 58, of a functional structure for realizing the seventh policy setting method described with reference to FIG. 57. FIG. 58 is a diagram showing an example of the functional structure for realizing the seventh policy setting method. Parts in FIG. 58 that are identical or equivalent to the parts shown in FIG. 54 are referenced by the same reference marks, and will not be described in detail. Herein, the image forming device 1000 or 1000-2 is represented by the image forming device 1000, because the image forming device 1000 and the image forming device 1000-2 have an identical operation requirement selection part 1012-3. Besides, the portion indicated by the dashed line 1002 may be omitted.

The operation requirement selection part 10123 includes an interface 4106 for reading the DSP 2000 stored in the storage medium 50 from the storage medium 50, but does not include the communication part 4103.

The policy rewriting part 4104 rewrites the present DSP 2000a held by the operation requirement selection part 1012-3 with the DSP 2000 read by the interface 4106. Thus, the policy is set off-line. Besides, in this case of setting a policy off-line by using the storage medium 50 in which the DSP 2000 is stored, adding an alteration detection code, for example, can increase a reliability of the policy.

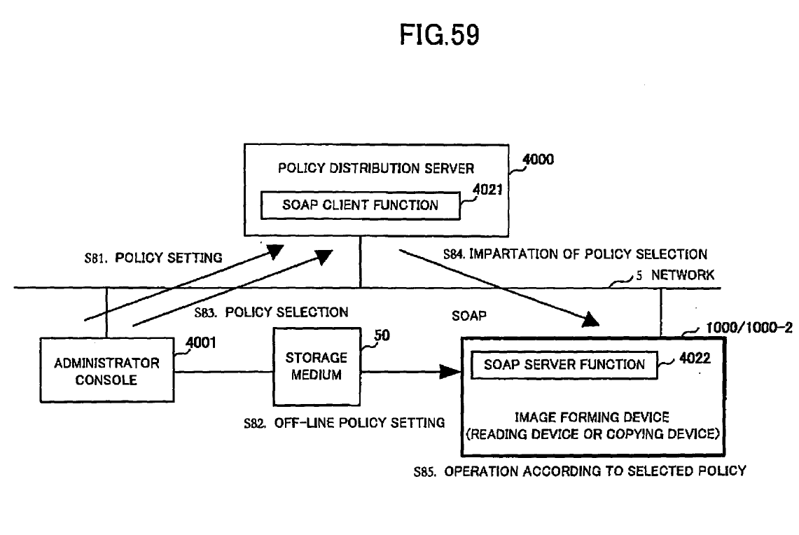

Next, a description will be given, with reference to FIG. 59, of an eighth policy setting method in which a policy is set off-line and selected on-line. FIG. 59 is a diagram showing the eighth policy setting method in which a policy is set off-line and selected on-line. Parts in FIG. 59 that are identical or equivalent to the parts shown in FIG. 49 are referenced by the same reference marks, and will not be described in detail. Herein, the image forming device 1000 or 1000-2 is represented by the image forming device 1000.

In FIG. 59, the DSP 2000, for example, is set as a policy from the administrator console 4001 via the network 5 to the policy distribution server 4000 (step S81).

Besides, the storage medium 50 (the hard disk 51, the magneto-optical disc 52, the flexible disk 53 or the optical disc 54, as shown in FIG. 26) in which the DSP 2000 is stored is set off-line to a security policy database in the image forming device 1000 (step S82).

Thereafter, a selection of a policy is specified from the administrator console 4001 via the network 5 to the policy distribution server 4000 (step S83). The selection of the policy includes identification information of the policy for selecting one of policies.

According to the selection of the policy from the administrator console 4001, the policy distribution server 4000 imparts the selection of the policy to the image forming device 1000 by using the SOAP client function 4021 (step S84). The image forming device 1000 receives the imparted selection of the policy by using the SOAP server function 4022, and returns a result of the reception to the policy distribution server 4000. That is, the identification information of the policy to be enforced is imparted to the image forming device 1000.

According to the selection of the policy, the image forming device 1000 selects the policy specified by the identification information, and operates according to the selected policy (step S85).

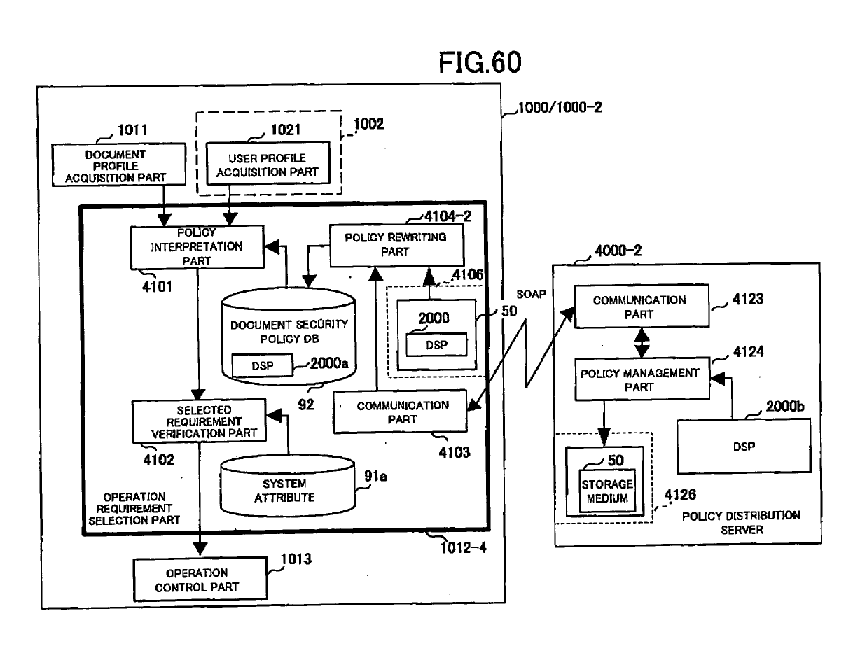

Next, a description will be given, with reference to FIG. 60, of a functional structure for realizing the eighth policy setting method described with reference to FIG. 59. FIG. 60 is a diagram showing an example of the functional structure for realizing the eighth policy setting method. Parts in FIG. 60 that are identical or equivalent to the parts shown in FIG. 54 and FIG. 58 are referenced by the same reference marks, and will not be described in detail. Herein, the image forming device 1000 or 1000-2 is represented by the image forming device 1000, because the image forming device 1000 and the image forming device 1000-2 have an identical operation requirement selection part 1012-4. Besides, the portion indicated by the dashed line 1002 may be omitted.

The operation requirement selection part 1012-4 includes the communication part 4103, and also includes the interface 4106 for reading the DSP 2000 stored in the storage medium 50 from the storage medium 50.

The communication part 4103 imparts the selection of the policy received from a policy distribution server 4000-2 to a policy rewriting part 4104-2 according to the SOAP.

According to the off-line policy setting, for example, the policy rewriting part 4104-2 reads the DSP 2000 stored in the storage medium 50 by the interface 4106, and stores the DSP 2000 in a document security policy DB 92. The policy rewriting part 4104-2 substitutes the policy to be enforced according to the selection of the policy imparted from the communication part 4103. Specifically, when a former policy to be enforced is the DSP 2000a, and the DSP 2000 is specified by the identification information included in the selection of the policy, the policy rewriting part 41042 rewrites the DSP 2000a with the DSP 2000 as the policy to be enforced.

Besides, the policy distribution server 4000-2 may comprise an interface 4126 for writing the DSP 2000b in the storage medium 50. By this configuration, for setting a policy off-line, the policy management part 4124 writes the DSP 2000b of the policy distribution server 4000-2 in the storage medium 50 as the policy (the DSP 2000) to be distributed. In this case, the storage medium 50 is a medium, such as the hard disk 51, the magneto-optical disc 52, the flexible disk 53 or the optical disc 54, as shown in FIG. 26.

In the policy distribution server 4000-2, the communication part 4123 transmits the selection of the policy to the image forming device 1000 according to the SOAP.

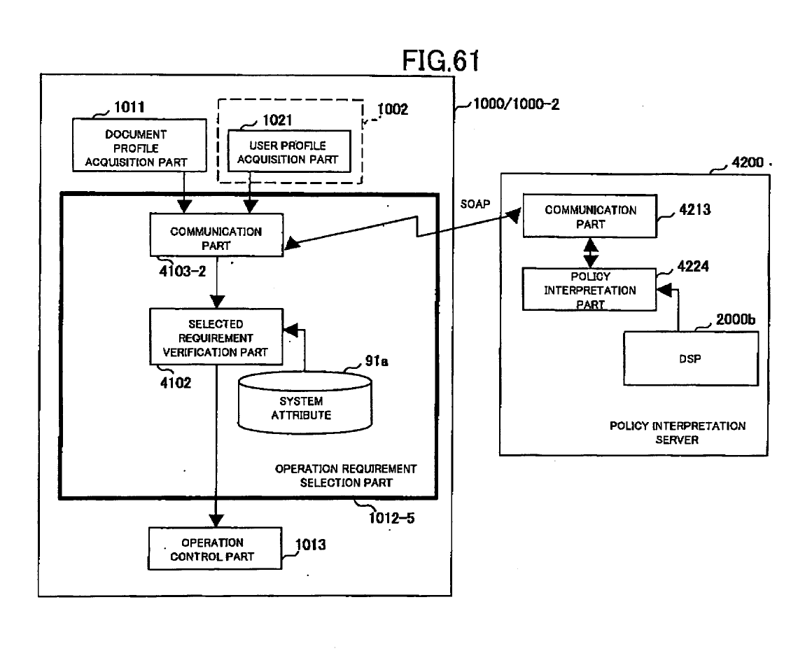

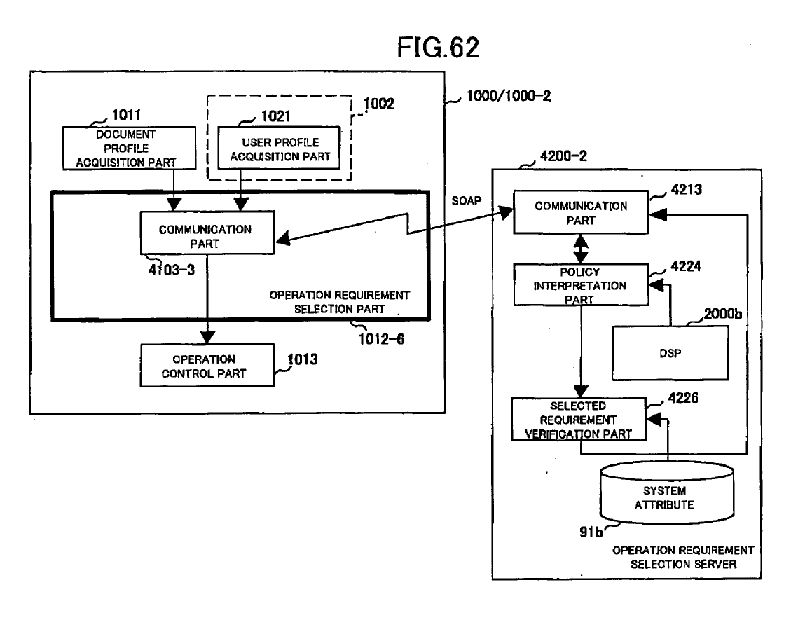

Next, a description will be given, with reference to FIG. 61 and FIG. 62, of functional structures in which an interpretation of a policy according to a document profile and a user profile is inquired at an external server.

FIG. 61 is a diagram showing an example of a functional structure in which an external server interprets a policy. Parts in FIG. 61 that are identical or equivalent to the parts shown in FIG. 54 are referenced by the same reference marks, and will not be described in detail. Herein, the image forming device 1000 or 1000-2 is represented by the image forming device 1000, because the image forming device 1000 and the image forming device 1000-2 have an identical operation requirement selection part 1012-5. Besides, the portion indicated by the dashed line 1002 may be omitted.

In the image forming device 1000, the operation requirement selection part 1012-5 includes only a communication part 4103-2, the selected requirement verification part 4102 and the system attribute 91a.

The communication part 4103-2 is a processing part controlling a communication with a policy interpretation server 4200 according to the SOAP. The communication part 4103-2 transmits a document profile imparted from the document profile acquisition part 1011, and a user profile imparted from the user profile acquisition part 1021 to the policy interpretation server 4200 according to the SOAP. Besides, upon receiving a rule according to the document profile and the user profile from the policy interpretation server 4200, the communication part 4103-2 imparts the rule to the selected requirement verification part 4102. The rule sets forth an operation requirement that must be satisfied upon allowing an operation.

The selected requirement verification part 4102 judges whether or not the operation requirement can be satisfied with referring to the system attribute 91a, and imparts a result of the judgment to the operation control part 1013.

The policy interpretation server 4200 as the external server is a server computer, and includes a communication part 4213, a policy interpretation part 4224 and the DSP 2000b.

The communication part 4213 is a processing part controlling a communication with the image forming device 1000 according to the SOAP, and imparts the document profile and the user profile received from the image forming device 1000 to the policy interpretation part 4224, and transmits the rule corresponding to the document profile and the user profile imparted from the policy interpretation part 4224 to the image forming device 1000. The rule includes the operation requirement upon allowing an operation.

The policy interpretation part 4224 acquires the rule including the operation requirement upon allowing an operation by referring to the DSP 2000b according to the document profile and the user profile acquired from the communication part 4213, and imparts the rule to the communication part 4213.

The above-described functional structure enables a security policy to be enforced to an operation in the image forming device 1000 even though the image forming device 1000 does not hold a policy.

Next, a description will be given, with reference to FIG. 62, of a functional structure in which an external server interprets a policy, and further verifies a selected requirement.

FIG. 62 is a diagram showing an example of a functional structure in which an external server interprets a policy, and further verifies a selected requirement. Parts in FIG. 62 that are identical or equivalent to the parts shown in FIG. 61 are referenced by the same reference marks, and will not be described in detail. Herein, the image forming device 1000 or 1000-2 is represented by the image forming device 1000, because the image forming device 1000 and the image forming device 1000-2 have an identical operation requirement selection part 1012-6. Besides, the portion indicated by the dashed line 1002 may be omitted.

In the image forming device 1000, the operation requirement selection part 1012-6 includes only a communication part 4103-3.

The communication part 4103-3 is a processing part controlling a communication with a policy interpretation server (an operation requirement selection server) 4200-2 according to the SOAP. The communication part 4103-3 transmits a document profile imparted from the document profile acquisition part 1011, and a user profile imparted from the user profile acquisition part 1021 to the policy interpretation server 4200 according to the SOAP. Besides, the communication part 4103-3 receives-allowance or denial with respect to an operation, and an operation requirement upon allowing the operation from the policy interpretation server 4200-2, and imparts the allowance or denial, and the operation requirement upon allowing the operation to the operation control part 1013.

The policy interpretation server 4200-2 as the external server includes the communication part 4213, the policy interpretation part 4224 and the DSP 2000b, as in the policy interpretation server 4200 shown in FIG. 61, and further includes a selected requirement verification part 4226 and a system attribute 91b.

The policy interpretation part 4224 acquires the rule including the operation requirement upon allowing an operation by referring to the DSP 2000b according to the document profile and the user profile acquired from the communication part 4213, and imparts the rule to the selected requirement verification part 4226.

The selected requirement verification part 4226 judges whether or not the image forming device 1000 can satisfy the operation requirement by referring to the system attribute 91b, and transmits a result of the judgment to the image forming device 1000 by the communication part 4213. When the selected requirement verification part 4226 judges that the image forming device 1000 cannot satisfy the operation requirement, the result of the judgment indicates the denial. On the other hand, when the selected requirement verification part 4226 judges that the image forming device 1000 satisfies the operation requirement, the result of the judgment indicates the allowance, and specifies the operation requirement.

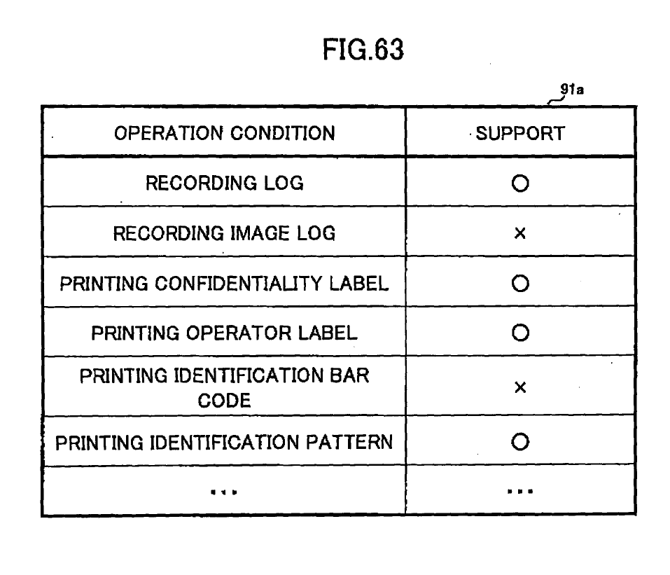

Next, a description will be given, with reference to FIG. 63, of the system attribute 91a referred to by the selected requirement verification part 4102 of the image forming device 1000 which is included in the image forming device 1000. FIG. 63 shows an example of the system attribute 91a included in the image forming device 1000.

In FIG. 63, the system attribute 91a is usually a table managing items of operation conditions executable by a user's selection, and includes items, such as an “operation condition” and a “support” indicating that the operation condition is supportable or not. As the operation conditions, the system attribute 91a sets forth recording a log, recording an image log, printing a confidentiality label, printing an operator label, printing an identification bar code, printing an identification pattern, and so forth.

Usually, the operation conditions are included in the image forming device 1000 as selectable functions upon operation. When such operation conditions are specified by the policy as requirements upon allowing the operation, the operation conditions become the operation requirements.

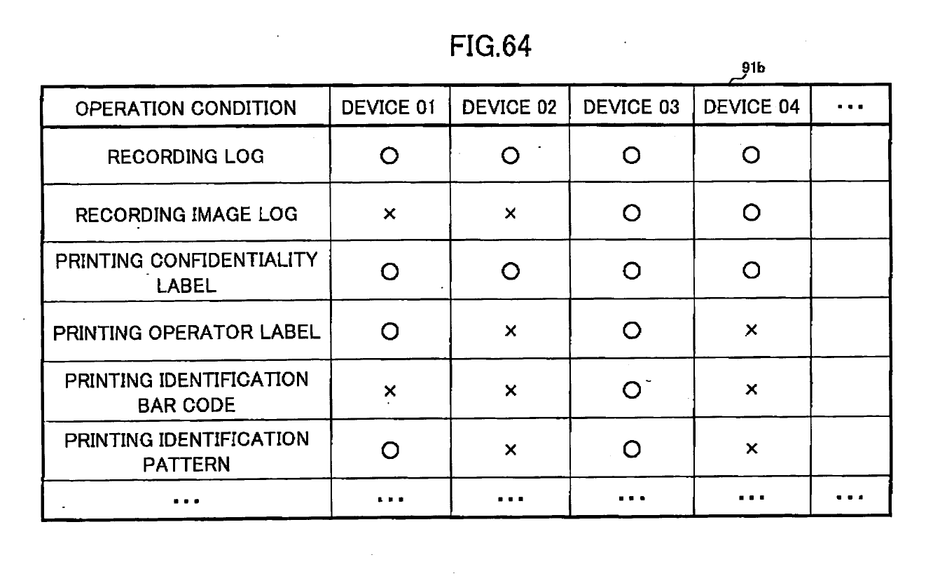

FIG. 64 shows an example of the system attribute 91b included in an external server. In FIG. 64, the system attribute 91b is a table managing each of operation conditions supportable or not in a plurality of image forming devices in association with identification information of the image forming devices (device 01, device 02, device 03, device 04, . . . ). As the operation conditions, the system attribute 91b sets forth recording a log, recording an image log, printing a confidentiality label, printing an operator label, printing an identification bar code, printing an identification pattern, and so forth.

Usually, the operation conditions are selectable functions upon operation. When such operation conditions are specified by the policy as requirements upon allowing the operation, the operation conditions become the operation requirements.

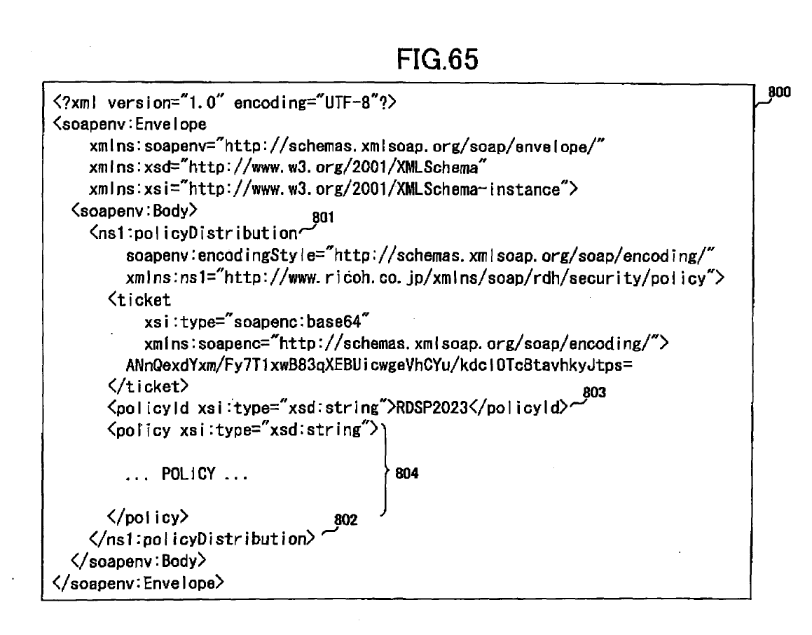

Next, a description will be given, with reference to FIG. 65 to FIG. 74, of examples of the SOAP used for setting of a policy performed by the image forming device 1000 or 1000-2 and the policy distribution server 4000. In this description, the image forming device 1000 or 1000-2 is represented by the image forming device 1000, because the image forming device 1000 as the reading device and the image forming device 1000-2 as the copying device are not different in this description.

First, a description will be given, with reference to FIG. 65, of the SOAP in a case where the policy distribution server 4000 distributes a policy to the image forming device 1000 by using the SOAP client function 4021, as shown in FIG. 49. FIG. 65 shows an example of XML data representing distribution of a policy transmitted according to the SOAP.

In FIG. 65, XML data 800 is a description by XML according to the SOAP for distributing a policy. In the XML data 800, a description 801 reading <ns1:policyDistribution> to a description 802 reading </ns1:policyDistribution> set forth information concerning a policy to be distributed and the policy per se.

In the description 801, “policyDistribution” indicates that this XML data 800 distributes a policy.

A description 803 reading <policyId xsi:type=“xsd:string”>RDSP2023</policyId> sets identification information “RDSP2023” for identifying the policy. A description 804 from <policy xsi:type=“xsd:string”> to </policy> describes the policy. For example, the DSP 2000 (shown in FIG. 14 to FIG. 22) per se identified by the identification information “RDSP2023” is described.

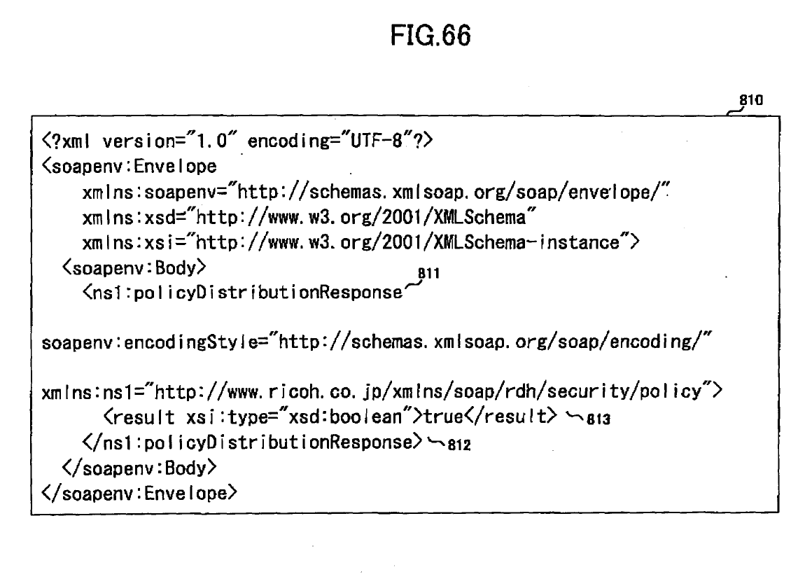

Then, the image forming device 1000 receives the above-described XML data 800 representing the distribution of the policy, and transmits a result of the reception as shown in FIG. 66 by using the SOAP server function 4022. FIG. 66 shows an example of XML data representing the result of the reception for the distribution of the policy transmitted according to the SOAP.

In FIG. 66, XML data 810 is a description by XML which represents the result of the reception for the distribution of the policy. In the XML data 810, a description 811 reading <ns1:policyDistributionResponse> to a description 812 reading </ns1:policyDistributionResponse> set forth information concerning the result of the reception for the distribution of the policy.

In the description 811, “policyDistributionResponse” indicates that this XML data 810 is a response to the distribution of the policy.

A description 813 reading <result xsi:type=“xsd:boolean”>true</result> indicates whether or not the distribution of the policy is received normally. In this case, “true” indicates that the distribution of the policy is received normally.

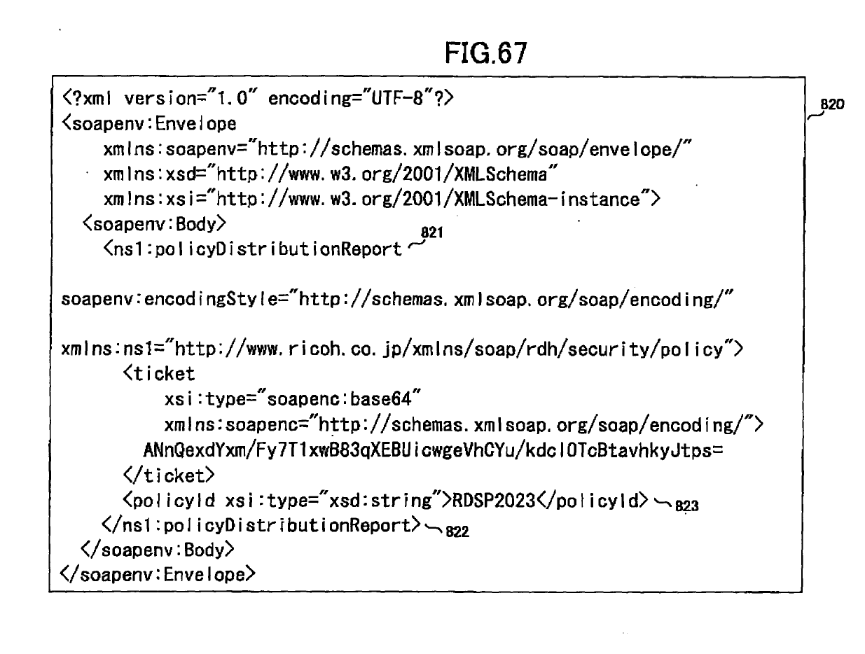

Next, a description will be given, with reference to FIG. 67, of the SOAP in a case where the policy distribution server 4000 provides a report of distribution of a policy to the image forming device 1000 by using the SOAP client function 4021, as shown in FIG. 50. FIG. 67 shows an example of XML data representing the report of distribution of the policy transmitted according to the SOAP.

In FIG. 67, XML data 820 is a description by XML according to the SOAP for providing a report of distribution of a policy. In the XML data 820, a description 821 reading <ns1:policyDistributionReport> to a description 822 reading </ns1:policyDistributionReport> set forth information concerning a report of distribution of a policy.

In the description 821, “policyDistributionReport” indicates that this XML data 820 provides a report of distribution of a policy.

A description 823 reading <policyId xsi:type=“xsd:string”>RDSP2023</policyId> sets identification information “RDSP2023” for identifying the policy.

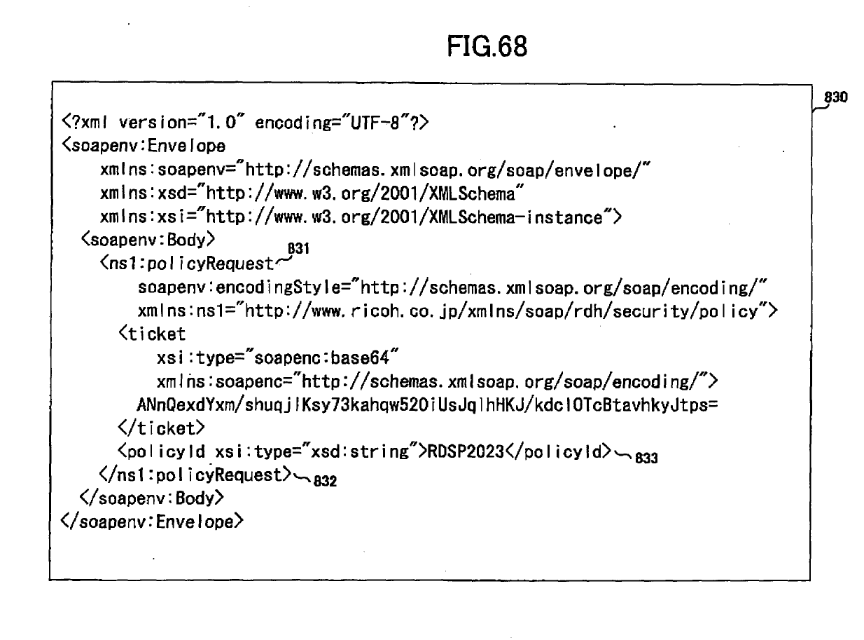

Then, the image forming device 1000 receives the above-described XML data 820 representing the report of the distribution of the policy, and transmits a result of the reception by using the SOAP server function 4022, and thereafter transmits a policy acquisition request as shown in FIG. 68 to the policy distribution server 4000 by using the SOAP client function 4023. FIG. 68 shows an example of XML data representing the policy acquisition request transmitted according to the SOAP.

In FIG. 68, XML data 830 is a description by XML according to the SOAP for transmitting the policy acquisition request. In the XML data 830, a description 831 reading <ns1:policyRequest> to a description 832 reading </ns1:policyRequest> set forth information concerning the policy acquisition request.

In the description 831, “policyRequest” indicates that this XML data 830 requests an acquisition of the policy.

A description 833 reading <policyId xsi:type=“xsd:string”>RDSP2023</policyId> sets the identification information “RDSP2023” for identifying the policy reported by the XML data 820 representing the report of the distribution of the policy shown in FIG. 67.

The above-described XML data 830 representing the policy acquisition request is transmitted to the policy distribution server 4000 after receiving the report of the distribution of the policy, or at a predetermined timing.

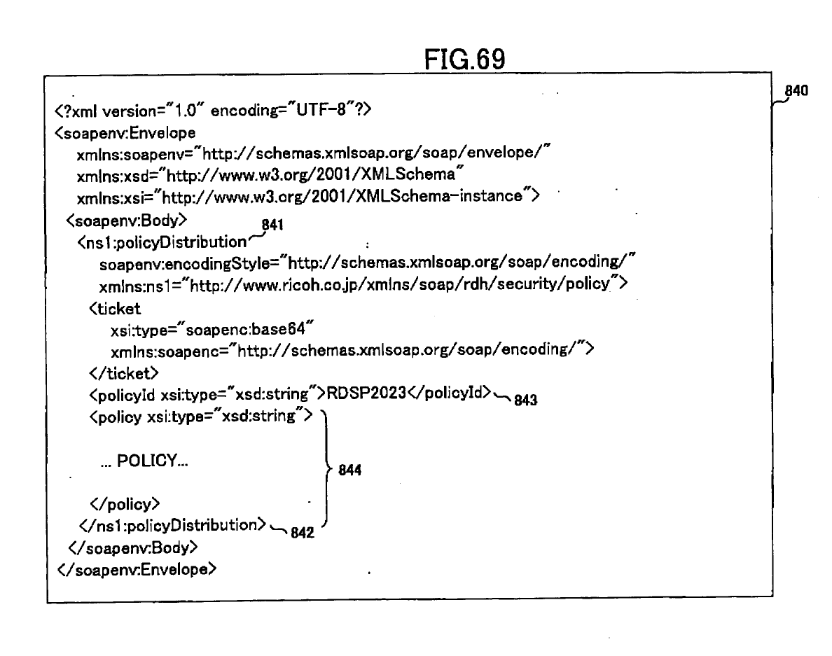

Then, the policy distribution server 4000 receives the above-described XML data 830 representing the policy acquisition request, and transmits a result of the reception as shown in FIG. 69 by using the SOAP server function 4024. FIG. 69 shows an example of XML data representing the result of the reception for the policy acquisition request transmitted according to the SOAP.

In FIG. 69, XML data 840 is a description by XML which represents the result of the reception for the policy acquisition request. In the XML data 840, a description 841 reading <ns1:policyDistribution> to a description 842 reading </ns1:policyDistribution> set forth information concerning the policy to be distributed and the policy per se.

In the description 841, “policyDistribution” indicates that this XML data 840 distributes a policy.

A description 843 reading <policyId xsi:type=“xsd:string”>RDSP2023</policyId> sets the identification information “RDSP2023” for identifying the policy. A description 844 from <policy xsi:type=“xsd:string”> to </policy> describes the policy. For example, the DSP 2000 (shown in FIG. 14 to FIG. 22) per se identified by the identification information “RDSP2023” is described.

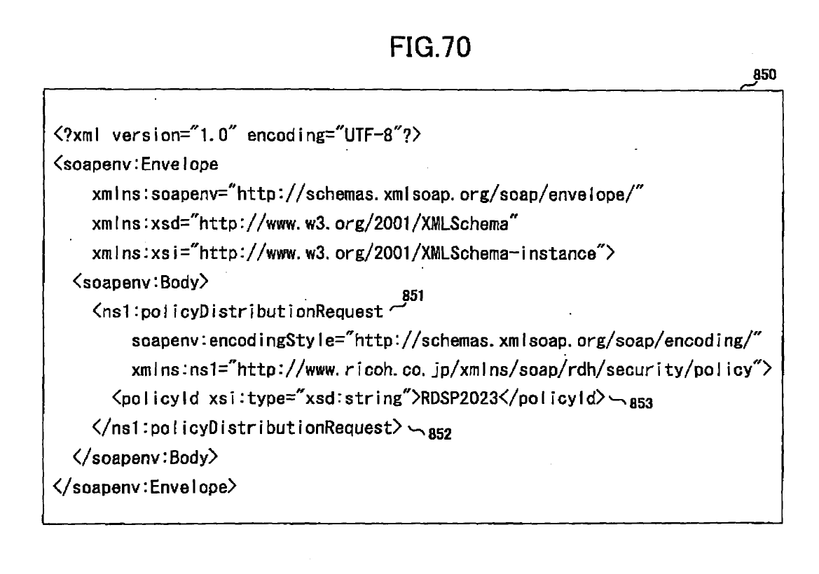

Next, a description will be given, with reference to FIG. 70, of the SOAP in a case where the image forming device 1000 performs a policy distribution request to the policy distribution server 4000 by using the SOAP client function 4023, as shown in FIG. 53. FIG. 70 shows an example of XML data representing the policy distribution request transmitted according to the SOAP.

In FIG. 70, XML data 850 is a description by XML according to the SOAP for requesting a distribution of a policy. In the XML data 850, a description 851 reading <ns1:policyDistributionRequest> to a description 852 reading </ns1:policyDistributionRequest> set forth information concerning the policy distribution request.

In the description 851, “policyDistributionRequest” indicates that this XML data 830 requests a distribution of a policy.

A description 853 reading <policyId xsi:type=“xsd:string”>RDSP2023</policyId> sets the identification information “RDSP2023” for identifying the policy.

Then, the policy distribution server 4000 receives the above-described XML data 850 representing the policy distribution request, and immediately after the reception or at a predetermined timing, distributes the policy by the XML data 800 shown in FIG. 65.

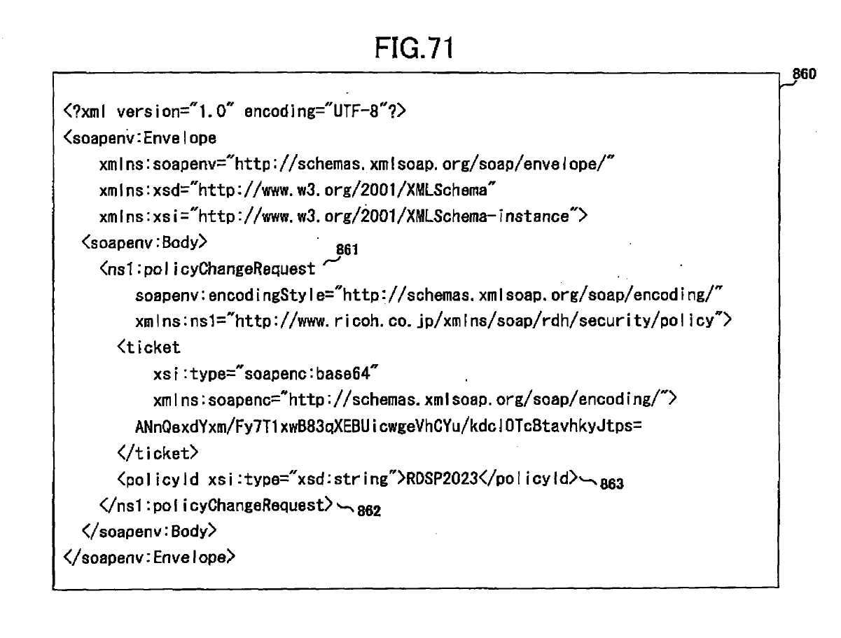

Next, a description will be given, with reference to FIG. 71, of the SOAP in a case where the policy distribution server 4000 imparts a selection of a policy to the image forming device 1000 by using the SOAP client function 4021, as shown in FIG. 59. FIG. 71 shows an example of XML data representing an impartation of a selection of a policy transmitted according to the SOAP.

In FIG. 71, XML data 860 is a description by XML according to the SOAP for imparting a selection of a policy. In the XMI, data 860, a description 861 reading <ns1:policyChangeRequest> to a description 862 reading </ns1:policyChangeRequest> set forth information concerning the policy to be selected.

In the description 861, “policyChangeRequest” indicates that this XML data 860 imparts a selection of a policy.

A description 863 reading <policyId xsi:type=“xsd:string”>RDSP2023</policyId> sets identification information “RDSP2023” for identifying the policy. The image forming device 1000 sets the policy identified by the identification information “RDSP2023” as a policy to be enforced.

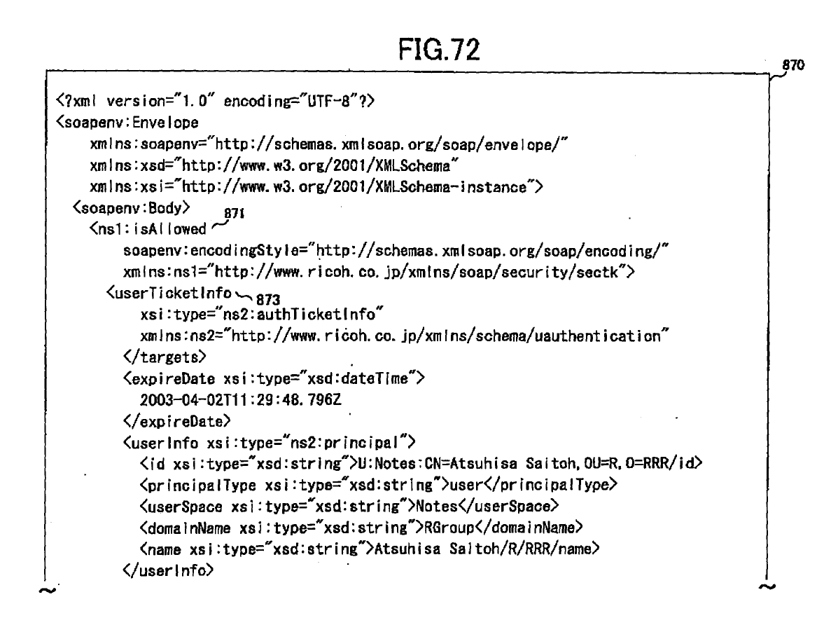

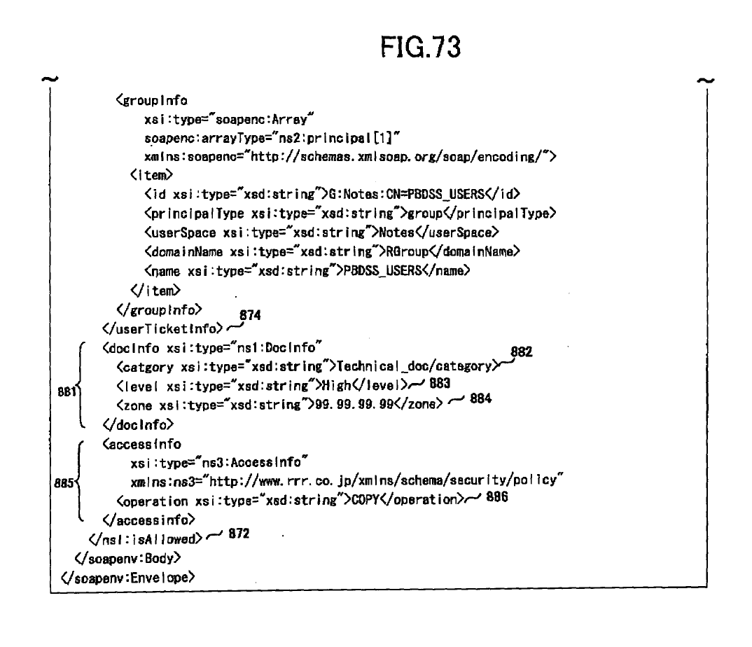

Next, a description will be given, with reference to FIG. 72 and FIG. 73, of the SOAP in a case where the image forming device 1000 performs an operation requirement acquisition request to an external server interpreting a policy, as shown in FIG. 61 and FIG. 62. FIG. 72 and FIG. 73 show an example of XML data representing the operation requirement acquisition request transmitted according to the SOAP. FIG. 72 and FIG. 73 together show one XML data 870.

In the XML data 870, a description 871 reading <ns1:isAllowed> shown in FIG. 72 to a description 872 reading </ns1:isAllowed> shown in FIG. 73 set forth a user profile, a document profile, and information of an operation.

A description 873 reading <userTicketInfo> to a description 874 reading </userTicketInfo> specify a user ticket when a user profile is required. For example, in FIG. 61, when it is judged that a user profile is required for the policy interpretation server 4200 as an external server to interpret a policy, a user profile is acquired by using the specified user ticket.

A description 881 from <docinfo xsi:type-“ns1:DocInfo”> to </docInfo> indicates information concerning a document profile. In the description 881, a description 882 reading <catgory xsi:type=“xsd:string”>Technical-doc</category> indicates a document category of “Technical_doc (Technology Related Document)”, a description 883 reading <level xsi:type=“xsd:string”>High</level> indicates a document level of “High (high level)”, and a description 884 reading <zone xsi:type=“xsd:string”>99.99.99.99</zone>indicates a zone of “99.99.99.99”.

Besides, a description 885 from <accessinfo> to </accessinfo> indicates information of an operation. In the description 885, a description 886 reading <operation xsi:type=“xsd:string”> COPY</operation> indicates that the operation is a copying operation.

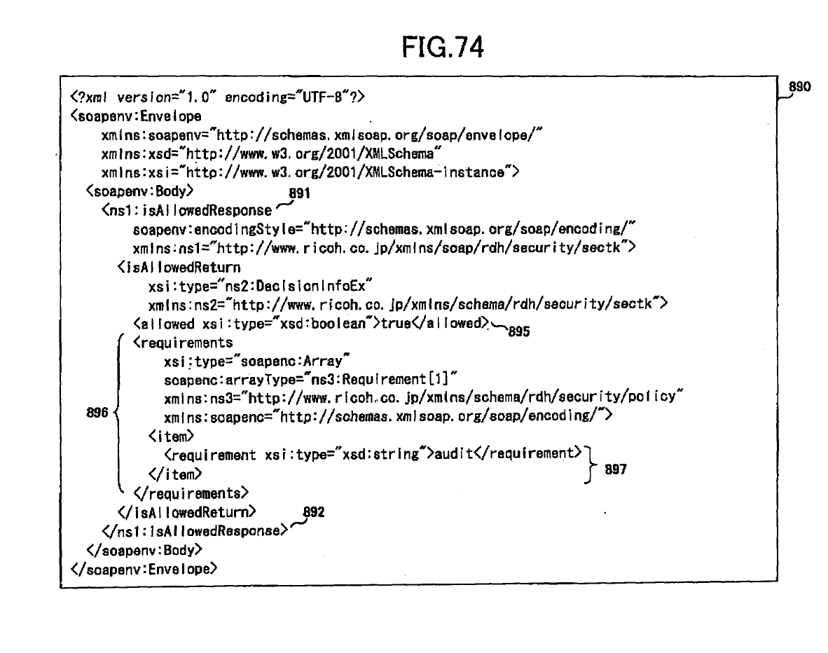

When the policy interpretation server 4200 as the external server show in FIG. 61 receives the above-described XML data 870, the policy interpretation server 4200 transmits a result of a policy interpretation by the policy interpretation part 4224 as shown in FIG. 74 to the image forming device 1000. FIG. 74 shows an example of XML data representing the result of the policy interpretation transmitted according to the SOAP.

In FIG. 74, XML data 890 is a description by XML according to the SOAP for imparting a result of a policy interpretation. In the XML data 890, a description 891 reading <ns1:isAllowedResponse> to a description 892 reading </ns1:isAllowedResponse> set forth information concerning the result of the policy interpretation.

In the description 891, “isAllowedResponse” indicates that this XML data 890 imparts the result of the policy interpretation.

A description 895 reading <allowed xsi:type=“xsd:Boolean”>true</allowed> indicates that the operation is allowed.

Besides, a description 896 from <requirements> to </requirements> indicates an operation requirement for allowing the operation. In the description 896, a description 897 from <item> to </item> indicates the operation requirement. A description reading <requirement xsi:type=“xsd:string”>audit</requirement> specifies a recording of an audit trail as the operation requirement.

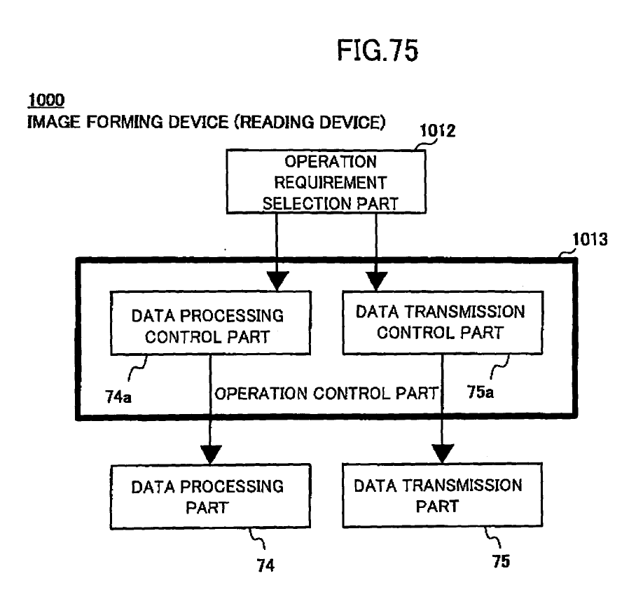

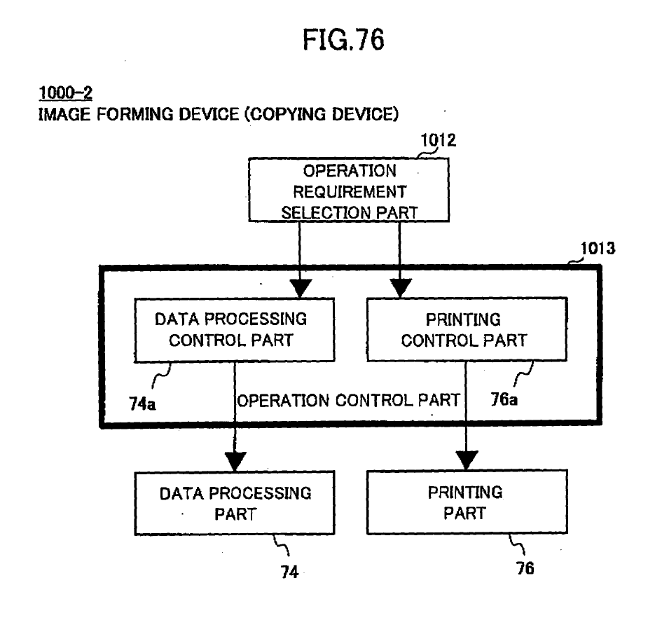

Next, a description will be given, with reference to FIG. 75 and FIG. 76, of functional structures of the operation control part 1013.

First, a description will be given, with reference to FIG. 75, of a functional structure of the operation control part 1013 of the image forming device 1000 as the reading device shown in FIG. 28. FIG. 75 is a diagram showing an example of the functional structure of the operation control part 1013 of the image forming device 1000 as the reading device.

As shown in FIG. 75, in the image forming device 1000 as the reading device, the operation control part 1013 includes a data processing control part 74a controlling the data processing part 74, and a data transmission control part 75a controlling the data transmission part 75.

In the image forming device 1000 as the reading device, according to an operation requirement imparted from the operation requirement selection part 1012, the data processing control part 74a controls the data processing part 74 to stop a reading process and erase all of read data when necessary, to blacken or whitening a part of read data, to erase a page such as by deletion, to erase color information, to reduce an amount of information, to add a confidentiality label by printing a “CLASSIFIED” stamp, and to add identification information by printing a bar code, a number, a text, a pattern or a security profile, for example.

In the image forming device 1000 as the reading device, according to an operation requirement imparted from the operation requirement selection part 1012, the data transmission control part 75a controls the data transmission part 75 to stop a transmission, to transmit only to a destination specified by the operation requirement, and to transmit also to a destination specified by the operation requirement, for example.

Next, a description will be given, with reference to FIG. 76, of a functional structure of the operation control part 1013 of the image forming device 1000-2 as the copying device shown in FIG. 30. FIG. 76 is a diagram showing an example of the functional structure of the operation control part 1013 of the image forming device 1000-2 as the copying device.

As shown in FIG. 76, in the image forming device 1000-2 as the copying device, the operation control part 1013 includes the data processing control part 74a controlling the data processing part 74, and a printing control part 76a controlling the printing part 76.

In the image forming device 1000-2 as the copying device, according to an operation requirement imparted from the operation requirement selection part 1012, the data processing control part 74a controls the data processing part 74 to stop a reading process and erase all of read data when necessary, to blacken or whitening a part of read data, to erase a page such as by deletion, to erase color information, to reduce an amount of information, to add a confidentiality label by printing a “CLASSIFIED” stamp, and to add identification information by printing a bar code, a number, a text, a pattern or a security profile, for example, as does the data processing control part 74a in the image forming device 1000 as the reading device shown in FIG. 75.

In the image forming device 1000-2 as the copying device, the printing control part 76a controls the printing part 76 to stop a printing, and to print on a paper from a tray specified by an operation requirement, for example.

The above-described embodiment sets forth the image forming device 1000 as the reading device and the image forming device 1000-2 as the copying device; however, not limited thereto, the image forming device according to the present invention may be a device having at least one of various image forming functions, such as of a printer, a facsimile, and a copier, or may be a device having such various image forming functions.

According to the present invention, since a security policy inside a company concerning documents can be set from outside, handling of documents can be controlled according to the consistent security policy inside the company. Besides, regardless of whether a document is a paper document or electronic data (document data) a control according to the security policy can be performed.

The present invention is not limited to the specifically disclosed embodiments, and variations and modifications may be made without departing from the scope of the present invention.

The present application is based on Japanese priority applications No. 2002-273985 filed on Sep. 19, 2002, No. 2002-297888 filed on Oct. 10, 2002, No. 2002-341222 filed on Nov. 25, 2002, No. 2003-314463 filed on Sep. 5, 2003, No. 2003-314464 filed on Sep. 5, 2003, No. 2003-314465 filed on Sep. 5, 2003, and No. 2002-275973 filed on Sep. 20, 2002, the entire contents of which are hereby incorporated by reference.

What is claimed is:

1. An image forming device comprising:
an identification information reading part reading identification information of a document;
an operation requirement selection part selecting at least one operation requirement specified according to said identification information; and
an operation control part controlling an execution of a predetermined operation according to the operation requirement selected by said operation requirement selection part.

2. The image forming device as claimed in claim 1, wherein said operation requirement is a requirement regarding security for said document.

3. The image forming device as claimed in claim 1, wherein said predetermined operation is forming an image by electronic data.

4. The image forming device as claimed in claim 1, wherein said predetermined operation is printing said document on a paper.

5. The image forming device as claimed in claim 1, wherein said identification information reading part includes:
an identification information recognition part recognizing data acquired by performing a predetermined reading operation with respect to said document, as said identification information;
a document profile management part relating and managing said identification information and a document profile; and
a document profile acquisition part acquiring said document profile related to said identification information recognized by said identification information recognition part by referring to said document profile management part.

6. The image forming device as claimed in claim 5, wherein said predetermined reading operation reads either a bar code, a two-dimensional code or a magnetic code printed on said document, or an RFID provided on said document so as to recognize the read data as said identification information when said document is a paper.

7. The image forming device as claimed in claim 5, wherein said predetermined reading operation recognizes either a bar code, a two-dimensional code, numerical information, text information or a dot pattern from electronic image data generated by reading said document, as said identification information.

8. The image forming device as claimed in claim 1, further comprising a user profile acquisition part acquiring a user profile regarding a user requesting said predetermined operation.

9. The image forming device as claimed in claim 8, wherein said user profile acquisition part includes:
a user identification information acquisition part acquiring user identification information identifying said user from said user;
a user profile management part relating and managing said user identification information and said user profile;
a user authentication part authenticating said user according to said user identification information; and
a user profile reading part acquiring said user profile related to said user identification information acquired by said user identification information acquisition part by referring to said user profile management part according to a result of the authentication by said user authentication part.

10. The image forming device as claimed in claim 8, wherein said user profile acquisition part includes:
a user identification information acquisition part acquiring user identification information identifying said user from said user; and
a user profile request part requesting said user profile from an external server authenticating said user and providing said user profile.

11. The image forming device as claimed in claim 1, further comprising;
an operation requirement judgment part judging whether or not said operation requirement is feasible; and
an operation prohibition part prohibiting said predetermined operation when a result of the judgment by said operation requirement judgment part indicates that said operation requirement is not feasible.

12. The image forming device as claimed in claim 1, wherein said operation requirement requires embedding an electronic watermark upon executing said predetermined operation with respect to said document.

13. The image forming device as claimed in claim 1, wherein said operation requirement requires embedding a displayable label upon executing said predetermined operation with respect to said document.

14. The image forming device as claimed in claim 9, wherein said operation requirement requires embedding a displayable label upon executing said predetermined operation with respect to said document, and
said displayable label contains at least authentication data of said user requesting said predetermined operation, and a timestamp upon requesting said predetermined operation.

15. The image forming device as claimed in claim 9, wherein said operation requirement requires recording at least authentication data of said user requesting said predetermined operation, document data of said document generated by said predetermined operation, and a timestamp upon requesting said predetermined operation.

16. The image forming device as claimed in claim 1, further comprising a delivery part delivering document data via a network, the document data being generated by executing said predetermined operation with satisfying said operation requirement enabling a network delivery of said document.

17. An image forming device comprising:
a document profile acquisition part transmitting identification information read from a document to an external server providing a document profile, and thereby receiving said document profile from said external server;
an operation requirement selection part selecting at least one operation requirement according to said document profile; and
an operation control part controlling an execution of a predetermined operation according to the operation requirement selected by said operation requirement selection part.

18. The image forming device as claimed in claim 17, wherein said operation requirement is a requirement regarding security for said document.

19. The image forming device as claimed in claim 17, wherein said predetermined operation is forming an image by electronic data.

20. The image forming device as claimed in claim 17, wherein said predetermined operation is printing said document on a paper.

21. The image forming device as claimed in claim 17, wherein said document profile acquisition part includes:
an identification information recognition part recognizing data acquired by performing a predetermined reading operation with respect to said document, as said identification information; and
a communication part transmitting said identification information recognized by said identification information recognition part to said external server, and receiving said document profile transmitted from said external server.

22. The image forming device as claimed in claim 21, wherein said identification information recognition part reads either a bar code, a two-dimensional code or a magnetic code printed on said document, or an RFID provided on said document by performing said predetermined reading operation so as to recognize the read data as said identification information when said document is a paper.

23. The image forming device as claimed in claim 21, wherein said identification information recognition part recognizes either a bar code, a two-dimensional code, numerical information, text information or a dot pattern from electronic image data generated by reading said document by performing said predetermined reading operation, as said identification information.

24. The image forming device as claimed in claim 23, wherein said document profile acquisition part includes a portion acquisition part acquiring a predetermined portion representing a portion or all of said electronic image data,
wherein said communication part transmits said predetermined portion of said electronic image data to said external server, and receives said document profile from said external server.

25. The image forming device as claimed in claim 17, further comprising a user profile acquisition part acquiring a user profile regarding a user requesting said predetermined operation.

26. The image forming device as claimed in claim 25, wherein said user profile acquisition part includes:
a user identification information acquisition part acquiring user identification information identifying said user from said user;
a user profile management part relating and managing said user identification information and said user profile;
a user authentication part authenticating said user according to said user identification information; and
a user profile reading part acquiring said user profile related to said user identification information acquired by said user identification information acquisition part by referring to said user profile management part according to a result of the authentication by said user authentication part.

27. The image forming device as claimed in claim 25, wherein said user profile acquisition part includes:
a user identification information acquisition part acquiring user identification information identifying said user from said user; and
a user profile request part requesting said user profile from an external server authenticating said user and providing said user profile.

28. The image forming device as claimed in claim 17, further comprising:
an operation requirement judgment part judging whether or not said operation requirement is feasible; and
an operation prohibition part prohibiting said predetermined operation when a result of the judgment by said operation requirement judgment part indicates that said operation requirement is not feasible.

29. The image forming device as claimed in claim 17, wherein said operation requirement requires embedding an electronic watermark upon executing said predetermined operation with respect to said document.

30. The image forming device as claimed in claim 17, wherein said operation requirement requires embedding a displayable label upon executing said predetermined operation with respect to said document.

31. The image forming device as claimed in claim 26, wherein said operation requirement requires embedding a displayable label upon executing said predetermined operation with respect to said document, and
said displayable label contains at least authentication data of said user requesting said predetermined operation, and a timestamp upon requesting said predetermined operation.

32. The image forming device as claimed in claim 26, wherein said operation requirement requires recording at least authentication data of said user requesting said predetermined operation, document data of said document generated by said predetermined operation, and a timestamp upon requesting said predetermined operation.

33. The image forming device as claimed in claim 17, further comprising a delivery part delivering document data via a network, the document data being generated by executing said predetermined operation with satisfying said operation requirement enabling a network delivery of said document.

34. A document profile management server comprising:
a communication part receiving document identification information transmitted from a device connected via a network, the document identification information identifying a document, and transmitting a document profile related to said document identification information to said device;
a document profile management part managing said document profile in relation to said document identification information; and
a document profile acquisition part acquiring said document profile related to said document identification information received from said device from said document profile management part.

35. A document profile management server comprising:
a communication part receiving electronic image data transmitted from a device connected via a network, the electronic image data being generated by reading a document, and transmitting a document profile corresponding to said electronic image data to said device;
an identification information acquisition part reading either a bar code, a two-dimensional code, numerical information, text information or a dot pattern from said electronic image data so as to acquire a document identification information identifying said document;
a document profile management part managing said document profile in relation to said document identification information; and
a document profile acquisition part acquiring said document profile related to said document identification information acquired from said electronic image data from said document profile management part.

36. A document processing device comprising a profile information addition part for performing a predetermined processing with respect to document data including a document profile added thereto by adding document identification information related to said document profile,
wherein said profile information addition part includes:
a document profile acquisition part acquiring said document profile from said document data;
a communication part transmitting said document profile to an external server, and receiving said document identification information from said external server; and
a data processing part performing said predetermined processing by adding said document identification information to said document data.

37. A document processing device comprising a profile information addition part for performing a predetermined processing with respect to document data including a document profile added thereto by adding electronic image data corresponding to said document profile, wherein said profile information addition part includes:
a document profile acquisition part acquiring said document profile from said document data;
a communication part transmitting said document profile to an external server, and receiving said electronic image data from said external server; and
a data processing part performing said predetermined processing by adding said electronic image data to said document data.

38. A document profile management server comprising:
a communication part receiving a document profile transmitted from a device connected via a network, and transmitting document identification information related to said document profile to said device;
a document profile management part managing said document identification information in relation to said document profile; and
an identification information generation part writing said document profile received from said device in said document profile management part, generating said document identification information, and causing said document profile management part to manage said document identification information in relation to said document profile.

39. The document profile management server as claimed in claim 38, further comprising an electronic image data generation part generating either a bar code, a two-dimensional code, numerical information, text information or a dot pattern as electronic image data according to said document identification information generated by said identification information generation part.

40. A document profile management server comprising:
a communication part receiving and transmitting at least one of a document profile, document identification information and electronic image data to and from a device connected via a network;
a document profile management part managing said document identification information in relation to said document profile;
an identification information acquisition part reading either a bar code, a two-dimensional code, numerical information, text information or a dot pattern from said electronic image data so as to acquire the document identification information;
a profile acquisition part acquiring said document profile from said document profile management part according to said document identification information;
an identification information generation part writing said document profile in said document profile management part, generating said document identification information, and causing said document profile management part to manage said document identification information in relation to said document profile; and
an electronic image data generation part generating either a bar code, a two-dimensional code, numerical information, text information or a dot pattern as the electronic image data according to said document identification information.

41. An image forming device comprising:
a policy hold part holding a security policy describing a handling rule concerning a document;
a policy rewriting part rewriting said security policy held by said policy hold part with a security policy from outside; and
an operation control part controlling an operation with respect to said document according to said security policy held by said policy hold part.

42. The image forming device as claimed in claim 41, further comprising a communication part performing a communication control via a network,
wherein said policy rewriting part rewrites said security policy held by said policy hold part with a security policy received by said communication part.

43. The image forming device as claimed in claim 42, wherein said policy rewriting part writes a security policy acquired from outside by said communication part in said policy hold part upon application of power.

44. The image forming device as claimed in claim 42, further comprising a timer part notifying said communication part of a timing for rewriting said security policy held by said policy hold part,
wherein said communication part acquires said security policy from a policy distribution server distributing said security policy via said network.

45. The image forming device as claimed in claim 41, further comprising an interface part reading a security policy from a storage medium storing said security policy,
wherein said policy rewriting part rewrites said security policy held by said policy hold part with said security policy read by said interface part.

46. The image forming device as claimed in claim 45, further comprising a communication part performing a communication control via a network,
wherein said communication part imparts selection information indicating a selection of a security policy to said policy rewriting part upon receiving said selection information, and
said policy rewriting part rewrites said security policy held by said policy hold part with said security policy read by said interface part according to said selection information.

47. The image forming device as claimed in claim 46, wherein said policy hold part holds a plurality of the security policies, and
said policy rewriting part sets one of said security policies held by said policy hold part as a security policy to be enforced according to said selection information.

48. The image forming device as claimed in claim 42, wherein said communication part acquires said security policy via said network according to Simple Object Access Protocol.

49. The image forming device as claimed in claim 46, wherein said communication part acquires said security policy via said network according to Simple Object Access Protocol.

50. A policy distribution server comprising:
a communication part performing a communication control via a network; and
a policy management part managing a security policy describing a handling rule concerning a document,
wherein said communication part distributes said security policy managed by said policy management part to a device connected via said network.

51. The policy distribution server as claimed in claim 50, wherein said communication part transmits authentication information simultaneously upon distributing said security policy.

52. The policy distribution server as claimed in claim 50, wherein said communication part receives a acquisition request for said security policy managed by said policy management part from said device connected via said network, and authentication information of said device, and transmits said security policy to said device according to a result of authentication based on said authentication information.

53. The image forming device as claimed in claim 50, further comprising an interface writing said security policy in a storage medium,
wherein said policy management part writes said security policy to said storage medium by said interface.

54. An image forming device comprising:
a rule acquisition part transmitting a document profile regarding a document to an external server providing a handling rule concerning said document according to said document profile, and thereby acquiring said handling rule from said external server; and
an operation control part controlling an operation with respect to said document according to said handling rule acquired by said rule acquisition part.

55. The image forming device as claimed in claim 54, wherein said rule acquisition part includes a communication part controlling a communication with said external server according to Simple Object Access Protocol.

56. The image forming device as claimed in claim 54, wherein said rule acquisition part includes:
a communication part controlling a communication with said external server:
a select function hold part holding feasibility information indicating whether or not a selectable function is executable; and
an operation requirement judgment part judging whether or not an operation requirement specified by said handling rule to be satisfied for allowing said operation is feasible by referring to said feasibility information held by said select function hold part,
wherein said operation control part controls said operation with respect to said document according a result of the judgment by said operation requirement judgment part.

57. A policy interpretation server comprising:
a communication part performing a communication control via a network;
a policy hold part holding a security policy describing a handling rule concerning a document; and
a policy acquisition part acquiring said handling rule concerning an operation performed with respect to said document by referring to said security policy held by said policy hold part according to a document profile regarding said document and said operation performed with respect to said document,
wherein said communication part imparts said document profile and said operation received via said network to said policy acquisition part, and transmits said handling rule acquired by said policy acquisition part.

58. The policy interpretation server as claimed in claim 57, further comprising:
a select function hold part holding feasibility information indicating whether or not a selectable function is executable in each of devices connected via said network; and
an operation requirement judgment part judging whether or not an operation requirement specified by said handling rule acquired by said policy acquisition part to be satisfied for allowing said operation is feasible by referring to said feasibility information held by said select function hold part.

59. An image forming method comprising:
an identification information reading step of reading identification information of a document;
an operation requirement selection step of selecting at least one operation requirement specified according to said identification information; and
an operation control step of controlling an execution of a predetermined operation according to the operation requirement selected by said operation requirement selection step.

60. The image forming method as claimed in claim 59, further comprising:
an operation requirement judgment step of judging whether or not said operation requirement is feasible; and
an operation prohibition step of prohibiting said predetermined operation when a result of the judgment by said operation requirement judgment step indicates that said operation requirement is not feasible.

61. An image forming method comprising:
a document profile acquisition step of transmitting identification information read from a document to an external server providing a document profile, and thereby receiving said document profile from said external server;
an operation requirement selection step of selecting at least one operation requirement according to said document profile; and
an operation control step of controlling an execution of a predetermined operation according to the operation requirement selected by said operation requirement selection step.

62. The image forming method as claimed in claim 61, wherein said document profile acquisition step includes:
an identification information recognition step of recognizing data acquired by performing a predetermined reading operation with respect to said document, as said identification information; and
a communication step of transmitting said identification information recognized by said identification information recognition step to said external server, and receiving said document profile transmitted from said external server.

63. A method for a computer to perform:
a policy hold step of holding a security policy describing a handling rule concerning a document;
a policy rewriting step of rewriting said security policy held by said policy hold step with a security policy from outside; and
an operation control step of controlling an operation with respect to said document according to said security policy held by said policy hold step.

64. A computer executable program causing a computer to perform:
an identification information reading step of reading identification information of a document;
an operation requirement selection step of selecting at least one operation requirement specified according to said identification information;
an operation control step of controlling an execution of a predetermined operation according to the operation requirement selected by said operation requirement selection step;
an operation requirement judgment step of judging whether or not said operation requirement is feasible; and
an operation prohibition step of prohibiting said predetermined operation when a result of the judgment by said operation requirement judgment step indicates that said operation requirement is not feasible.

65. A computer executable program causing a computer to perform:
a document profile acquisition step of transmitting identification information read from a document to an external server providing a document profile, and thereby receiving said document profile from said external server;
an operation requirement selection step of selecting at least one operation requirement according to said document profile; and
an operation control step of controlling an execution of a predetermined operation according to the operation requirement selected by said operation requirement selection step.

66. A computer executable program causing a computer to perform:
a policy hold step of holding a security policy describing a handling rule concerning a document;
a policy rewriting step of rewriting said security policy held by said policy hold step with a security policy from outside; and
an operation control step of controlling an operation with respect to said document according to said security policy held by said policy hold step.

67. A computer readable storage medium storing a program causing a computer to perform:
an identification information reading step of reading identification information of a document;
an operation requirement selection step of selecting at least one operation requirement specified according to said identification information;
an operation control step of controlling an execution of a predetermined operation according to the operation requirement selected by said operation requirement selection step;
an operation requirement judgment step of judging whether or not said operation requirement is feasible; and
an operation prohibition step of prohibiting said predetermined operation when a result of the judgment by said operation requirement judgment step indicates that said operation requirement is not feasible.

68. A computer readable storage medium storing a program causing a computer to perform;
a document profile acquisition step of transmitting identification information read from a document to an external server providing a document profile, and thereby receiving said document profile from said external server;
an operation requirement selection step of selecting at least one operation requirement according to said document profile;
an operation control step of controlling an execution of a predetermined operation according to the operation requirement selected by said operation requirement selection step;
an operation requirement judgment step of judging whether or not said operation requirement is feasible; and
an operation prohibition step of prohibiting said predetermined operation when a result of the judgment by said operation requirement judgment step indicates that said operation requirement is not feasible.

69. A computer readable storage medium storing a program causing a computer to perform:
a policy hold step of holding a security policy describing a handling rule concerning a document;
a policy rewriting step of rewriting said security policy held by said policy hold step with a security policy from outside; and
an operation control step of controlling an operation with respect to said document according to said security policy held by said policy hold step.
